(19) United States
(12) Patent Application Publication
(10) Pub. No.: US 2022/0348227 A1
(43) Pub. Date: Nov. 3, 2022

(54) SYSTEMS AND METHODS FOR OPERATING AN AUTONOMOUS VEHICLE

(71) Applicant: TUSIMPLE, INC., San Diego, CA (US)

(72) Inventors: Scott Douglas FOSTER, San Diego, CA (US); Joyce TAM, Pleasanton, CA (US); Dishi LI, Ann Arbor, MI (US)

(21) Appl. No.: 17/661,273

(22) Filed: Apr. 28, 2022

Related U.S. Application Data
(60) Provisional application No. 63/255,839, filed on Oct. 14, 2021.
(60) Provisional application No. 63/250,212, filed on Sep. 29, 2021.
(60) Provisional application No. 63/216,358, filed on Jun. 29, 2021.
(60) Provisional application No. 63/216,357, filed on Jun. 29, 2021.
(60) Provisional application No. 63/181,786, filed on Apr. 29, 2021.
(60) Provisional application No. 63/181,782, filed on Apr. 29, 2021.
(60) Provisional application No. 63/181,779, filed on Apr. 29, 2021.

(51) Int. Cl. B60W 60/00; B60W 30/18

(52) U.S. Cl. CPC B60W 60/0015; B60W 30/18163; B60W 2552/53; B60W 2554/402; B60W 2554/802; B60W 2710/18; B60W 2720/10; B60W 2520/10; B60W 2555/60; B60W 2552/10; B60W 2420/52; B60W 2556/45; B60W 2710/20; B60W 2554/4045

(57) ABSTRACT

An autonomous vehicle (AV) includes features that allows the AV to comply with applicable regulations and statues for performing safe driving operation. An example system for an AV includes obtaining, by a computer located in the AV, an image from a camera located on the AV, where the image characterizes an area towards which the AV is driven on a lane on a road or a highway; determining, from the image, that a pedestrian or a cyclist is located next to the lane on the road or the highway; and in response to the determining, performing driving operations on the AV such as steering from a center of the lane to a first side of the lane that is away from the center of the lane and away from a location of the pedestrian or the cyclist, and/or slowing down the AV in response to certain conditions.

### PRIORITY CLAIMS AND RELATED PATENT APPLICATIONS

This patent document claims the priority to and the benefits of U.S. Provisional Application No. 63/181,779 entitled “System and Method For An Autonomous Vehicle” filed on Apr. 29, 2021, U.S. Provisional Application No. 63/181,782 entitled “System and Method For An Autonomous Vehicle” filed on Apr. 29, 2021, U.S. Provisional Application No. 63/181,786 entitled “System and Method For An Autonomous Vehicle” filed on Apr. 29, 2021, U.S. Provisional Application No. 63/216,357 entitled “System and Method For An Autonomous Vehicle” filed on Jun. 29, 2021, U.S. Provisional Application No. 63/216,358 entitled “System and Method For An Autonomous Vehicle” filed on Jun. 29, 2021, U.S. Provisional Application No. 63/250,212 entitled “System and Method For An Autonomous Vehicle” filed on Sep. 29, 2021, and U.S. Provisional Application No. 63/255,839 entitled “System and Method For An Autonomous Vehicle” filed on Oct. 14, 2021. The entire disclosures of the aforementioned applications are hereby incorporated by reference as part of the disclosure of this application.

### TECHNICAL FIELD

The present disclosure relates generally to autonomous vehicles. More particularly, the present disclosure is related to operating an autonomous vehicle (AV) appropriately on public roads, highways, and locations with other vehicles or pedestrians.

### BACKGROUND

Autonomous vehicle technologies can provide vehicles that can safely navigate towards a destination with limited or no driver assistance. The safe navigation of an autonomous vehicle (AV) from one point to another may include the ability to signal other vehicles, navigating around other vehicles in shoulders or emergency lanes, changing lanes, biasing appropriately in a lane, and navigate all portions or types of highway lanes. Autonomous vehicle technologies may enable an AV to operate without requiring extensive learning or training by surrounding drivers, by ensuring that the AV can operate safely, in a way that is evident, logical, or familiar to surrounding drivers and pedestrians.

### SUMMARY

Systems and methods are described herein that can allow an autonomous vehicle (AV) to navigate from a first point to a second point. In some embodiments, the AV can navigate from the first point to the second point without a human driver present in the AV and to comply with instructions for safe and lawful operation.

A first example method of operating an autonomous vehicle, comprises: obtaining, by a computer located in the autonomous vehicle, an image from a camera located on the autonomous vehicle, where the image characterizes an area towards which the autonomous vehicle is driven on a lane on a road or a highway; determining, from the image, that a pedestrian or a cyclist is located next to the lane on the road or the highway; operating, in response to the determining, the autonomous vehicle to steer from a center of the lane to a first side of the lane that is away from the center of the lane and away from a location of the pedestrian or the cyclist; and operating, in response to the determining, the autonomous vehicle to lower a speed of the autonomous vehicle to below a first threshold speed value in response to determining that a lateral distance from the autonomous vehicle to the pedestrian or the cyclist is within a first set of distances, and that a current speed of the autonomous vehicle is greater than the first threshold speed value.

In some embodiments, the autonomous vehicle is caused to lower the speed of the autonomous vehicle by comparing the lateral distance from the autonomous vehicle to the pedestrian or the cyclist and the current speed of the autonomous vehicle to a table comprising a plurality of sets of distances and a plurality of threshold speed values, where the plurality of sets of distances include the first set of distances and a second set of distances that are greater than or equal to the first set of distances, where the plurality of threshold speed values include the first threshold speed value and a second threshold speed value that is greater than the first threshold value, and where the first set of distances and the second set of distances respectively correspond to the first threshold speed value and the second threshold speed value. In some embodiments, the first threshold speed value is a minimum of a first pre-determined speed value and a first speed value, the first speed value is obtained by subtracting a certain speed less from a speed limit, and the second threshold speed value is a minimum of a second pre-determined speed value and the first speed value.

In some embodiments, the method further comprises operating the autonomous vehicle to maintain the speed of the autonomous vehicle in response to determining that the lateral distance from the autonomous vehicle to the pedestrian or the cyclist is greater than a third set of distances that is greater than or equal to the second set of distances. In some embodiments, the method further comprises in response to determining, from the image, a presence of an emergency vehicle on the road or the highway: operating the autonomous vehicle to lower a speed of the autonomous vehicle to below a third threshold speed value in response to determining that the lateral distance from the autonomous vehicle to the pedestrian or the cyclist is within the first set of distances, and that the current speed of the autonomous vehicle is greater than the third threshold speed value, where the third threshold speed value is a minimum of the first threshold speed value and a maximum passing speed value.

In some embodiments, the maximum passing speed value is a certain speed less than a speed value, and where the speed value is based on at least a speed limit of the road or the highway and whether the autonomous vehicle is operating on either the road or the highway. In some embodiments, the method further comprises operating the autonomous vehicle to pass the pedestrian or the cyclist by maintaining a minimum lateral distance between the autonomous vehicle and the pedestrian or the cyclist, where the minimum lateral distance is a pre-determined distance from one side of the autonomous vehicle that is farthest from the pedestrian or the cyclist to the location of the pedestrian or the cyclist. In some embodiments, the pedestrian or the cyclist is determined from an image when a first distance from a first position of the autonomous vehicle to a second position of the pedestrian or the cyclist is greater than or equal to a stopping distance of the autonomous vehicle, and where the stopping distance is a second distance needed by the autonomous vehicle to come to a complete stop.

A second example method of operating an autonomous vehicle, comprises: determining, by a computer located in the autonomous vehicle, that the autonomous vehicle is decelerating when the autonomous vehicle is located on a road at a first location which is within a pre-determined distance of a second location where the autonomous vehicle is to perform a turning maneuver; and operating a turn signal to turn on at a first time in response to the determining and in response to determining that the turn signal is not engaged.

In some embodiment, the method further comprises sending instructions that cause the autonomous vehicle to steer along a trajectory to a side of the road and to apply brakes in response to determining that the turn signal is not working or operating. In some embodiment, the turn signal is caused to turn on at the first time for a first length of time, and where the method further comprises: performing a first determination that first length of time overlaps with a second length of time associated with a second turning maneuver that comes after the turning maneuver; performing a second determination that the second turning maneuver is in a same direction as the turning maneuver; and operating, in response to the first determination and the second determination, the turn signal stay turned on during the first length of time and the second length of time. In some embodiment, the pre-determined distance is based on a law or regulation of an area or state in which the autonomous vehicle is operating.

In some embodiment, the method further comprises performing a determination that the second location where the autonomous vehicle is to perform the turning maneuver is adjacent to an intersection, within a certain distance of the intersection, or past the intersection; and where the turn signal is caused to turn on in response to the determining, in response to determining that the turn signal is not engaged, and in response to determining that a rear of the autonomous vehicle is past a middle of the intersection.

A third example method of operating an autonomous vehicle, comprises: determining, by a computer located in the autonomous vehicle, that a lane of a road on which the autonomous vehicle is operating includes a curved portion that has a minimum radius that is greater than or equal to a pre-determined threshold value; and operating the autonomous vehicle traveling on the curved portion to move towards one side of the lane and away from a center of the lane as the autonomous vehicle is driven through the curved portion of the road, where the one side of the lane is a side that curves outwards, and where the autonomous vehicle is caused to move towards the one side of the lane up to a pre-determined threshold distance from the center of the lane.

In some embodiments, the method further comprises operating the autonomous vehicle to avoid traveling on another curved portion on the road in response to determining that the another curved portion has a superelevation that is greater than a pre-determined threshold amount, where the superelevation describes an upward angle that is formed by the another curved portion that is angled upwards relative to a flat surface. In some embodiments, the pre-determined threshold amount is a value between 5 percent and 15 percent. In some embodiments, the method further comprises operating the autonomous vehicle to accelerate or to decelerate less than or equal to a pre-determined rate in the curved portion of the road. In some embodiments, the method further comprises operating the autonomous vehicle to reduce speed of the autonomous vehicle in response to determining that a time to collision (TTC) value when the autonomous vehicle is operating in the curved portion is greater than a pre-determined amount of time, where the TTC value indicates an amount of time of a visibility provided by one or more cameras on the autonomous vehicle.

A fourth example method of operating an autonomous vehicle, comprises: determining, by a computer located in the autonomous vehicle, that an emergency vehicle is located within a pre-determined distance of a first location of the autonomous vehicle that is operating on a lane on a road; and operating, in response to the determining, the autonomous vehicle to steer from a center of the lane towards a first side of the lane away from the center of the lane and away from a second location of the emergency vehicle, where the autonomous vehicle is caused to steer towards the first side until a lateral distance between the emergency vehicle and the autonomous vehicle is greater than or equal to the pre-determined distance.

In some embodiments, the autonomous vehicle is caused to steer towards the first side of the lane and onto a second lane immediately adjacent to the lane in response to determining that a line that separates the lane and the second lane includes dotted white lines, dotted yellow lines, or solid white lines. In some embodiments, the method further comprises in response to determining that the emergency vehicle is located within the pre-determined distance of the first location of the autonomous vehicle and in response to determining that a lane change operation by the autonomous vehicle is not possible: sending instructions that causes the autonomous vehicle to apply brakes or slow down the autonomous vehicle to a speed that is less than a threshold speed value.

In some embodiments, the threshold speed value is based on a rule of an area or a state or a region in which the autonomous vehicle is located. In some embodiments, the threshold speed value is based on a speed limit of the first location where the autonomous vehicle is operating and the lateral distance between the emergency vehicle and the autonomous vehicle. In some embodiments, the threshold value is based on a speed limit of the first location where the autonomous vehicle is operating and the lateral distance between the emergency vehicle and the autonomous vehicle. In some embodiments, the autonomous vehicle operates to steer from the center of the lane towards the first side of the lane, and the autonomous vehicle is caused to apply brakes or slow down the autonomous vehicle to a speed that is less than a threshold speed value in response to: determining that the emergency vehicle is operating on another lane that is immediately adjacent to the lane on which the autonomous vehicle is operating; and determining that a lane change operation by the autonomous vehicle is not possible. In some embodiments, the method further comprises operating the autonomous vehicle to accelerate only for changing lanes or for performing an evasive maneuver in response to determining that the emergency vehicle is approaching the autonomous vehicle and that the emergency vehicle is operating on another lane that is immediately adjacent to the lane on which the autonomous vehicle is operating.

In some embodiments, a system further comprises sensor subsystems comprising cameras, a temperature sensor, an inertial sensor (IMU), a global positioning system, a light sensor, a LIDAR system, a radar system, and wireless communications, and wherein the computer located in the autonomous vehicle is configured to utilize data from any of the sensor subsystems to perform the determining and the operating. In some embodiments, a system further comprises a vehicle control subsystem in operable communication with the computer located in the autonomous vehicle, wherein the processor is configured to communicate with the vehicle control subsystem to perform the method that causes the autonomous vehicle to steer from the center of the lane towards the first side of the lane, and that causes the autonomous vehicle to apply brakes or slow down the autonomous vehicle to a speed that is less than a threshold speed value in response to: determining that the emergency vehicle is operating on another lane that is immediately adjacent to the lane on which the autonomous vehicle is operating; and determining that a lane change operation by the autonomous vehicle is not possible. In some embodiments, a system further comprises a vehicle control subsystem operably connected to the computer located in the autonomous vehicle, wherein the processor is configured to perform the method that further comprises: operating the autonomous vehicle via the vehicle control system to accelerate only for changing lanes or for performing an evasive maneuver in response to determining that the emergency vehicle is approaching the autonomous vehicle and that the emergency vehicle is operating on another lane that is immediately adjacent to the lane on which the autonomous vehicle is operating.

In some embodiments, the threshold speed value is based on: a rule of an area or a state or a region in which the autonomous vehicle is located; and on a speed limit of the first location where the autonomous vehicle is operating and the lateral distance between the emergency vehicle and the autonomous vehicle. In some embodiments, the method further comprises for an emergency vehicle that is transitioning into an emergency lane vehicle, the autonomous vehicle changes lanes away from a lane adjacent to the emergency lane; and slowing and matching, by the autonomous vehicle, the speed of an emergency vehicle that is transitioning into an emergency lane vehicle until the emergency vehicle pulls out of a current lane of travel of the autonomous vehicle. In some embodiments, the autonomous vehicle identifies an emergency vehicle as transitioning to an emergency lane vehicle using on-board sensors to detect any of: use of a turn signal by an emergency vehicle indicating a direction toward a shoulder; a change in bias or trajectory of the emergency vehicle; activation of flashing lights indicative of an emergency vehicle, a rescue vehicle, or a law enforcement vehicle; a change in velocity of the emergency vehicle; and a direct communication from the emergency vehicle to the autonomous vehicle indicating an intent of the emergency vehicle to move to the emergency lane or shoulder.

A fifth example method of operating an autonomous vehicle, comprises: obtaining, by a computer located in the autonomous vehicle, images from a camera located on the autonomous vehicle, where the image characterizes an area towards which the autonomous vehicle is being driven on a road; performing a first determination, from the images, that a vehicle is stopped in the area for a reason unrelated to traffic congestion, a traffic signal, or a traffic sign; performing a second determination that the autonomous vehicle is expected to drive within a pre-determined lateral distance from the vehicle; and operating, in response to the first determination and the second determination, the autonomous vehicle to operate at a speed less a maximum speed allowed for the autonomous vehicle to pass or overtake the vehicle.

In some embodiments, the method further comprises operating the autonomous vehicle to steer from a first lane to a second lane adjacent to the first lane at a distance from the vehicle that is greater than or equal to the pre-determined lateral distance from the vehicle. In some embodiments, the method further comprises performing a third determination that the vehicle is stopped in a lane that is same as that of the autonomous vehicle; performing a fourth determination that the autonomous vehicle is unable to change lanes; and operating, in response to the third determination and the fourth determination, the autonomous vehicle to apply brakes to stop the autonomous vehicle. In some embodiments, the maximum speed is based on whether the autonomous vehicle is operating on a local road or a highway.

A sixth example method of operating an autonomous vehicle, comprises: obtaining, by a computer located in the autonomous vehicle, an image from a camera located on the autonomous vehicle, where the image characterizes an area towards which the autonomous vehicle is driven on an on-ramp of a highway; determining, from the image, that the area includes a merge section on a lane on the highway where the autonomous vehicle is expected to merge onto the highway; operating a turn signal to turn on in response to the determining, where the turn signal indicates that the autonomous vehicle is expected to merge from the on-ramp to the lane on the highway; and operating, in response to the determining and in response to the turn signal being turned on, the autonomous vehicle to steer from the on-ramp of the highway to the merge section on the lane of the highway.

In some embodiments, a total length of the merge section includes a length of the autonomous section, a first minimum distance allowed between the autonomous vehicle and a first vehicle expected to be located in front of the autonomous vehicle, and a second minimum distance allowed between the autonomous vehicle and a second vehicle expected to be located behind the autonomous vehicle. In some embodiments, the method further comprises performing a first determination that a length of the merge section is decreasing; and operating, in response to the first determination, the autonomous vehicle to apply brakes to stop the autonomous vehicle. In some embodiments, the method further comprises performing a second determination, in response to the determining, of a trajectory for the autonomous vehicle to follow from the on-ramp to the merge section, where the trajectory avoids having the autonomous vehicle enter a gore area. In some embodiments, the image is obtained by the autonomous vehicle upon determining an absence of another merge section from a prior image from the camera of another area towards which the autonomous vehicle is driven, and upon operating the autonomous vehicle to creep forward on the highway, where the prior image is obtained in time before a time when the image is obtained from the camera. In some embodiments, the autonomous vehicle operates to creep forward at a speed less than a pre-determined speed.

A seventh example method of operating an autonomous vehicle, comprises: obtaining, by a computer located in the autonomous vehicle, a set of images over time from a first camera located on the autonomous vehicle, where the set of images characterize an area adjacent to a lane on which the autonomous vehicle is being driven on a road; obtaining, by the computer, an image from a second camera located on the autonomous vehicle, where the image characterizes another area that includes the lane on which the autonomous vehicle is being driven; performing a first determination, from the set of images, that a vehicle is being driven adjacent to the autonomous vehicle for a length of time; performing a second determination, from the image or the set of images, of a level of risk associated with the autonomous vehicle driving parallel to the vehicle; performing, in response to the first determination and the second determination, a third determination that the length of time is greater than a pre-determined time period; and operating the autonomous vehicle to accelerate or decelerate in response to the third determination.

In some embodiments, the performing the second determination includes: determining that the level of risk is low in response to determining from the image that that the lane has a width that is within a range of a pre-defined standard width of a standard lane and in response to determining that a trajectory is available for the autonomous vehicle to steer away from a center of the lane to one side of the lane, where the pre-determined time period is associated with the level of risk that is low. In some embodiments, the performing the second determination includes: determining that the level of risk is medium in response to: determining from the image that that the lane has a width that is less than a range of a pre-defined standard width of a standard lane, or determining that a trajectory is unavailable for the autonomous vehicle to steer away from a center of the lane to one side of the lane, or determining that the lane includes a curved portion; where the pre-determined time period is associated with the level of risk that is medium.

In some embodiments, the performing the second determination includes determining that the level of risk is high in response to determining from the set of images that the autonomous vehicle is parallel to or within a certain distance of being parallel to the vehicle that is swerving; and where the method further comprises operating, in response to the determining, the autonomous vehicle to accelerate or decelerate or change lanes in response. In some embodiments, the method further comprises determining, from at least one image from the set of images, that the vehicle has a length that is greater than a pre-determined length; and operating, in response to the determining, the autonomous vehicle to steer away from a center of the lane to one side of the lane.

In yet another exemplary aspect, a system for operating an autonomous vehicle, comprising a computer that includes a processor configured to perform the above-described methods and the method described in this patent document.

In yet another exemplary aspect, the above-described methods and the methods described in this patent document are embodied in a non-transitory computer readable storage medium. The non-transitory computer readable storage medium includes code that when executed by a processor, causes the processor to perform the methods described in this patent document.

In another exemplary embodiment, a device that is configured or operable to perform the above-described methods is disclosed. In yet another exemplary embodiment, a system comprises a computer located in a vehicle, the computer comprises a processor configured to implement the above-described methods is disclosed.

The above and other aspects and their implementations are described in greater detail in the drawings, the descriptions, and the claims.

### BRIEF DESCRIPTION OF THE DRAWINGS

For a more complete understanding of this disclosure, reference is now made to the following brief description, taken in connection with the accompanying drawings and detailed description, where like reference numerals represent like parts.

FIG. 1 illustrates a block diagram of an example vehicle ecosystem of an autonomous vehicle.

FIG. 2 shows a flow diagram for safe operation of an autonomous vehicle safely in light of the health and/or surroundings of the autonomous vehicle.

FIG. 3 illustrates a system that includes one or more autonomous vehicles, a control center or oversight system with a human operator (e.g., a remote center operator (RCO)), and an interface for third-party interaction.

FIGS. 4A to 4C show three example scenarios where an emergency vehicle approaches an autonomous vehicle on a road.

FIGS. 5A to 5C show example scenarios where an emergency vehicle approaches from a left side of an autonomous vehicle on a road.

FIGS. 5D to 5E show example scenarios where an emergency vehicle approaches an autonomous vehicle where both the emergency vehicle and the autonomous vehicle are not the right-most lane on the road.

FIG. 6 shows a recommended following distance between an autonomous vehicle and a non-player characteristic (NPC) vehicle.

FIG. 7 shows an example scenario where a vehicle is off-tracking in a 90 degree turn.

FIG. 8 shows an example scenario where an autonomous vehicle returns to a center of a lane after performing lane bias operation when one or more vehicles are located in another lane adjacent to the lane on which the autonomous vehicle is operating.

FIG. 9 shows an example merge area of a k-ramp.

FIG. 10 shows an example scenario where an autonomous vehicle may yield to a cyclist when approaching a right turn only lane or a drop lane.

FIG. 11 shows an identification of hand signs and corresponding meaning determined by an autonomous vehicle so that the autonomous vehicle may react to cyclist hand signals.

FIG. 12 shows an example of wide lade merge zone.

FIG. 13 shows an example scenario of driving operations performed by an autonomous vehicle that is traveling next to an end-of-life vehicle or disabled vehicle.

FIG. 14 shows an example acceleration cessation zone that may be adjacent to a location of an end-of-life vehicle or disabled vehicle.

FIG. 15 shows example driving related operations performed by an autonomous vehicle operating on a multi lane onramp on a highway

FIG. 16 shows an example flowchart of an autonomous driving operation performed by a vehicle operating on a road or highway that includes a pedestrian and/or a cyclist.

FIG. 17 shows an example flowchart of an autonomous driving operation performed by a vehicle to operate a turn signal.

FIG. 18 shows an example flowchart of an autonomous driving operation performed by a vehicle to operate on a curved region of a road.

FIG. 19 shows an example flowchart of an autonomous driving operation performed by a vehicle to operate on a road with an emergency vehicle.

FIG. 20 shows an example flowchart of an autonomous driving operation performed by a vehicle to operate on a road with a stopped vehicle.

FIG. 21 shows an example flowchart of an autonomous driving operation performed by a vehicle to merge onto a highway.

FIG. 22 shows an example flowchart of an autonomous driving operation performed by a vehicle to operate adjacent to another vehicle.

### DETAILED DESCRIPTION

Vehicles traversing highways and roadways are legally required to comply with regulations and statues in the course of safe operation of the vehicle. For autonomous vehicles (AVs), particularly autonomous tractor trailers, the ability to recognize a malfunction in its systems and stop safely can allow for a lawful and safe operation of the vehicle. Described below in detail are systems and methods for the safe and lawful operation of an autonomous vehicle on a roadway, including the execution of maneuvers that bring the autonomous vehicle in compliance with the law while signaling surrounding vehicles of its condition.

This patent document describes in Section I below an example vehicle ecosystem of an autonomous vehicle and driving related operations of the autonomous vehicle. Section II describes a control center or oversight system for one or more autonomous vehicles. Sections III to XXXI describe operations performed by the autonomous vehicle in various scenarios. The example headings for the various sections below are used to facilitate the understanding of the disclosed subject matter and do not limit the scope of the claimed subject matter in any way. Accordingly, one or more features of one example section can be combined with one or more features of another example section.

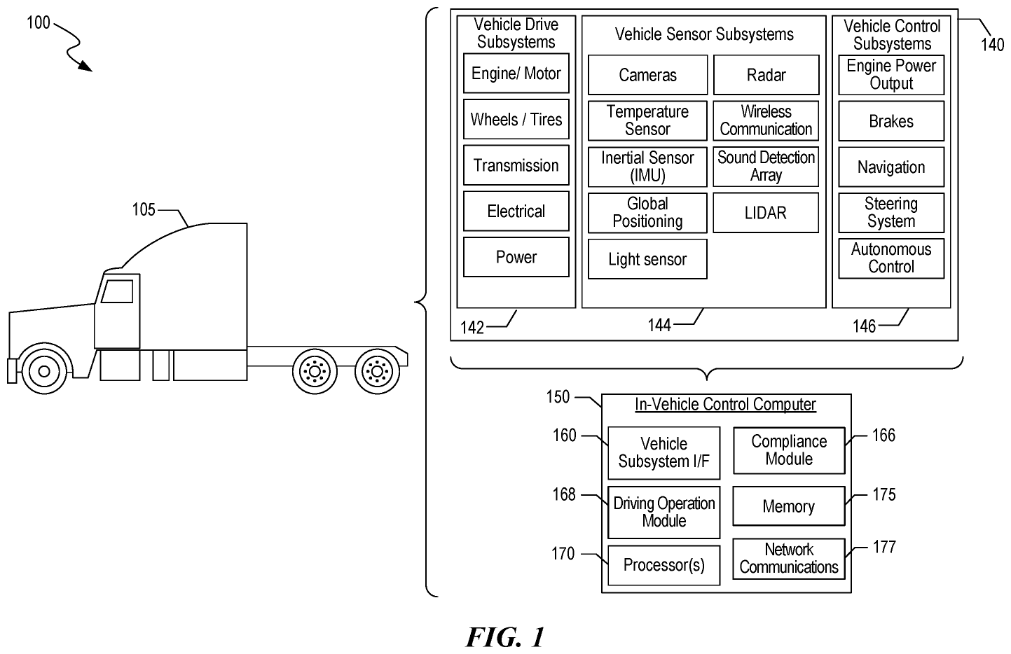

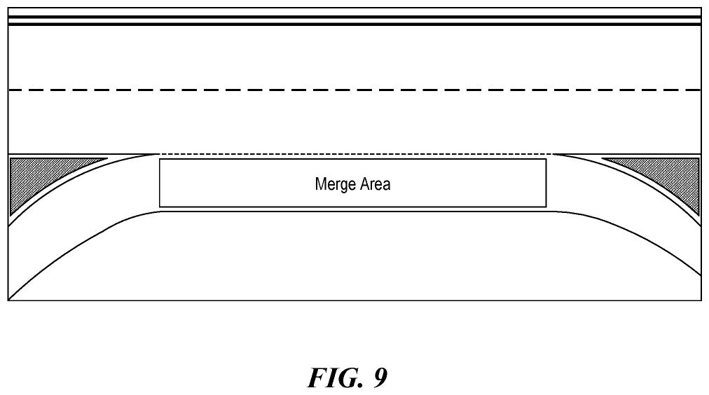

This patent document uses many abbreviations and uncommon terms. For instance, “GNSS” or “GPS” may refer to satellite navigation systems; when referring to an emergency vehicle, such as a police vehicle, ambulance, fire truck, tow truck, and the like, the abbreviation “EV” may be used; the acronym “TTC” indicates “time to collision”; “NPC” refers to non-player characters and may include any other vehicle that is not the autonomous vehicle in FIG. 1. For example, any surrounding vehicle, motorcycle, bicycle, and the like that are manually driven or autonomously driven and that may not be in communication with the autonomous vehicle may be considered NPC; a “k-ramp” denotes a freeway on/off ramp of a particular configuration such as is shown in FIG. 9; “STV” indicates a stopped vehicle; and “ELV” may indicate an end-of-life or disabled vehicle, such as a disabled vehicle on a roadside.

### I. Example Ecosystem of an Autonomous Vehicle

FIG. 1 shows a system 100 that includes an autonomous vehicle 105. The autonomous vehicle 105 may include a tractor of a semi-trailer truck. The autonomous vehicle 105 includes a plurality of vehicle subsystems 140 and an in-vehicle control computer 150. The plurality of vehicle subsystems 140 includes vehicle drive subsystems 142, vehicle sensor subsystems 144, and vehicle control subsystems. An engine or motor, wheels and tires, a transmission, an electrical subsystem, and a power subsystem may be included in the vehicle drive subsystems. The engine of the autonomous truck may be an internal combustion engine, a fuel-cell powered electric engine, a battery powered electrical engine, a hybrid engine, or any other type of engine capable of moving the wheels on which the autonomous vehicle 105 moves. The autonomous vehicle 105 have multiple motors or actuators to drive the wheels of the vehicle, such that the vehicle drive subsystems 142 include two or more electrically driven motors. The transmission may include a continuous variable transmission or a set number of gears that translate the power created by the engine into a force that drives the wheels of the vehicle. The vehicle drive subsystems may include an electrical system that monitors and controls the distribution of electrical current to components within the system, including pumps, fans, and actuators. The power subsystem of the vehicle drive subsystem may include components that regulate the power source of the vehicle.

Vehicle sensor subsystems 144 can include sensors for general operation of the autonomous vehicle 105, including those which would indicate a malfunction in the autonomous vehicle or another cause for an autonomous vehicle to perform a limited or minimal risk condition (MRC) maneuver. A driving operation module (shown as 168 in FIG. 1) can perform a MRC maneuver by sending instructions that cause the autonomous vehicle to steer along a trajectory to a side of the road and to apply brakes so that the autonomous vehicle can be safely stopped to the side of the road. The sensors for general operation of the autonomous vehicle may include cameras, a temperature sensor, an inertial sensor (IMU), a global positioning system, a light sensor, a LIDAR system, a radar system, and wireless communications.

A sound detection array, such as a microphone or array of microphones, may be included in the vehicle sensor subsystem 144. The microphones of the sound detection array are configured to receive audio indications of the presence of, or instructions from, authorities, including sirens and command such as “Pull over.” These microphones are mounted, or located, on the external portion of the vehicle, specifically on the outside of the tractor portion of an autonomous vehicle 105. Microphones used may be any suitable type, mounted such that they are effective both when the autonomous vehicle 105 is at rest, as well as when it is moving at normal driving speeds.

Cameras included in the vehicle sensor subsystems 144 may be rear-facing so that flashing lights from emergency vehicles may be observed from all around the autonomous truck 105. These cameras may include video cameras, cameras with filters for specific wavelengths, as well as any other cameras suitable to detect emergency vehicle lights based on color, flashing, of both color and flashing.

The vehicle control subsystem 146 may be configured to control operation of the autonomous vehicle, or truck, 105 and its components. Accordingly, the vehicle control subsystem 146 may include various elements such as an engine power output subsystem, a brake unit, a navigation unit, a steering system, and an autonomous control unit. The engine power output may control the operation of the engine, including the torque produced or horsepower provided, as well as provide control the gear selection of the transmission. The brake unit can include any combination of mechanisms configured to decelerate the autonomous vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS device and one or more pre-determined maps so as to determine the driving path for the autonomous vehicle 105. The steering system may represent any combination of mechanisms that may be operable to adjust the heading of autonomous vehicle 105 in an autonomous mode or in a driver-controlled mode.

The autonomous control unit may represent a control system configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some embodiments, the autonomous control unit may be configured to incorporate data from the GPS device, the RADAR, the LiDAR (e.g., LIDAR), the cameras, and/or other vehicle subsystems to determine the driving path or trajectory for the autonomous vehicle 105. The autonomous control that may activate systems that the autonomous vehicle 105 has which are not present in a conventional vehicle, including those systems which can allow an autonomous vehicle to communicate with surrounding drivers or signal surrounding vehicles or drivers for safe operation of the autonomous vehicle.

An in-vehicle control computer 150, which may be referred to as a VCU, includes a vehicle subsystem interface 160, a driving operation module 168, one or more processors 170, a compliance module 166, a memory 175, and a network communications subsystem 178. This in-vehicle control computer 150 controls many, if not all, of the operations of the autonomous vehicle 105 in response to information from the various vehicle subsystems 140. The one or more processors 170 execute the operations that allow the system to determine the health of the autonomous vehicle, such as whether the autonomous vehicle has a malfunction or has encountered a situation requiring service or a deviation from normal operation and giving instructions. Data from the vehicle sensor subsystems 144 is provided to VCU 150 so that the determination of the status of the autonomous vehicle can be made. The compliance module 166 determines what action should be taken by the autonomous vehicle 105 to operate according to the applicable (e.g., local) regulations. Data from other vehicle sensor subsystems 144 may be provided to the compliance module 166 so that the best course of action in light of the autonomous vehicle's status may be appropriately determined and performed. Alternatively, or additionally, the compliance module 166 may determine the course of action in conjunction with another operational or control module, such as the driving operation module 168.

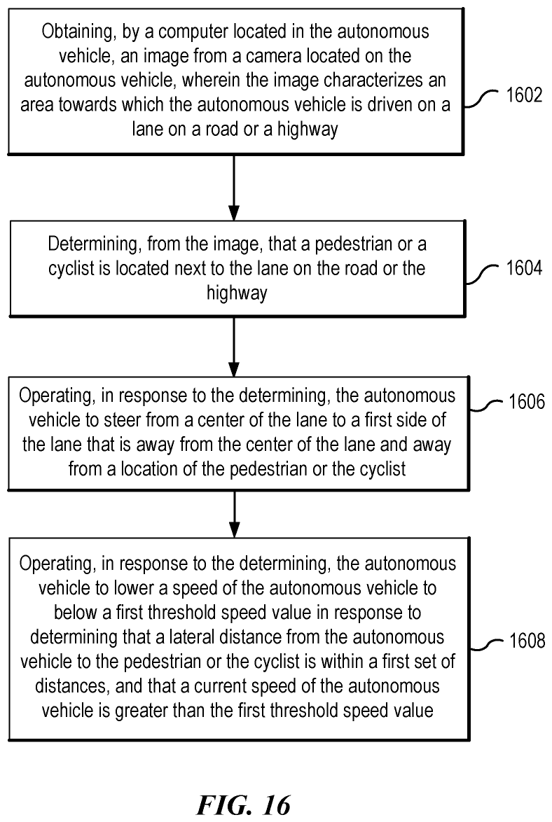

The memory 175 may contain additional instructions as well, including instructions to transmit data to, receive data from, interact with, or control one or more of the vehicle drive subsystem 142, the vehicle sensor subsystem 144, and the vehicle control subsystem 146 including the autonomous Control system. The in-vehicle control computer (VCU) 150 may control the function of the autonomous vehicle 105 based on inputs received from various vehicle subsystems (e.g., the vehicle drive subsystem 142, the vehicle sensor subsystem 144, and the vehicle control subsystem 146). Additionally, the VCU 150 may send information to the vehicle control subsystems 146 to direct the trajectory, velocity, signaling behaviors, and the like, of the autonomous vehicle 105. The autonomous control vehicle control subsystem may receive a course of action to be taken from the compliance module 166 of the VCU 150 and consequently relay instructions to other subsystems to execute the course of action. In Sections III to XXXI below, this patent document describes that the autonomous vehicle or a system performs certain functions or operations. These functions and/or the operations described in FIGS. 16 to 22 can be performed by the compliance module 166 and/or the driving operation module 168.

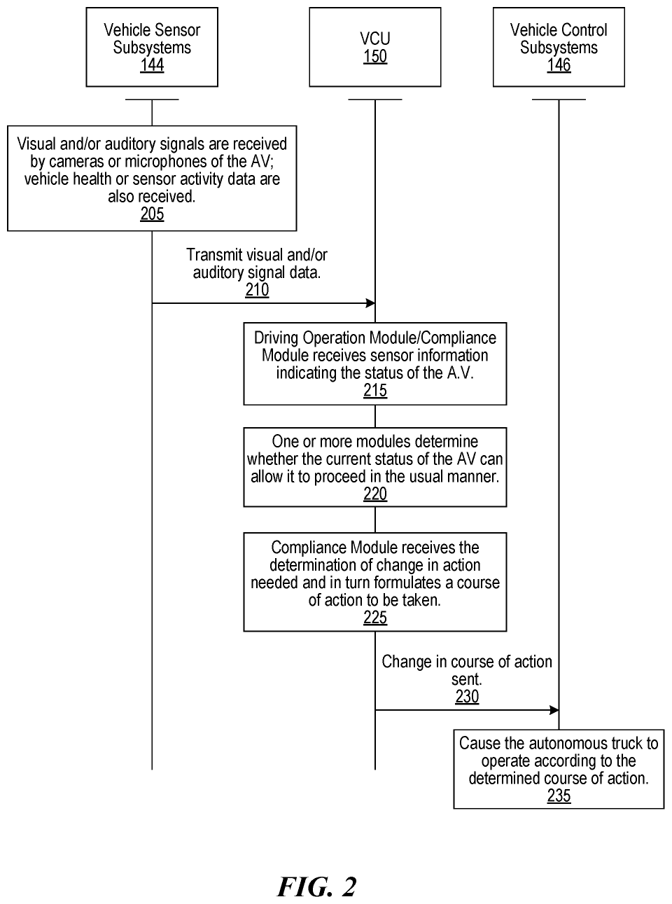

FIG. 2 shows a flow diagram for safe operation of an autonomous vehicle (AV) safely in light of the health and/or surroundings of the autonomous vehicle. Although this figure depicts functional steps in a particular order for purposes of illustration, the process is not limited to any particular order or arrangement of steps. One skilled in the relevant art will appreciate that the various steps portrayed in this figure may be omitted, rearranged, combined and/or adapted in various ways.

As shown in FIG. 2, the vehicle sensor subsystem 144 receives visual, auditory, or both visual and auditory signals indicating the at the environmental condition of the autonomous vehicle, as well as vehicle health or sensor activity data are received in step 205. These visual and/or auditory signal data are transmitted from the vehicle sensor subsystem 144 to the in-vehicle control computer system (VCU) 150, as in step 210. Any of the driving operation module and the compliance module receive the data transmitted from the vehicle sensor subsystem, in step 215. Then, one or both of those modules determine whether the current status of the autonomous vehicle can allow it to proceed in the usual manner or that the autonomous vehicle needs to alter its course to prevent damage or injury or to allow for service in step 220. The information indicating that a change to the course of the autonomous vehicle is needed may include an indicator of sensor malfunction; an indicator of a malfunction in the engine, brakes, or other components that may be necessary for the operation of the autonomous vehicle; a determination of a visual instruction from authorities such as flares, cones, or signage; a determination of authority personnel present on the roadway; a determination of a law enforcement vehicle on the roadway approaching the autonomous vehicle, including from which direction; and a determination of a law enforcement or first responder vehicle moving away from or on a separate roadway from the autonomous vehicle. This information indicating that a change to the autonomous vehicle's course of action or driving related operation is needed may be used by the compliance module to formulate a new course of action to be taken which accounts for the autonomous vehicle's health and surroundings, in step 225. The course of action to be taken may include slowing, stopping, moving into a shoulder, changing route, changing lane while staying on the same general route, and the like. The course of action to be taken may include initiating communications with any oversight or human interaction systems present on the autonomous vehicle. The course of action to be taken may then be transmitted from the VCU 150 to the autonomous control system, in step 230. The vehicle control subsystems 146 then cause the autonomous vehicle 105 to operate in accordance with the course of action to be taken that was received from the VCU 150 in step 235.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

### II. Autonomous Truck Oversight System

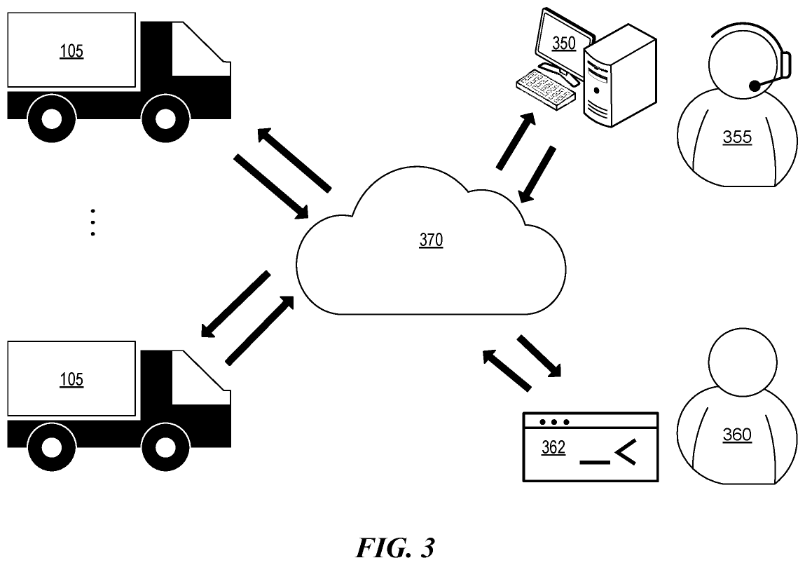

FIG. 3 illustrates a system 300 that includes one or more autonomous vehicles 105, a control center or oversight system 350 with a human operator 355, and an interface 362 for third-party 360 interaction. A human operator 355 may also be known as a remoter center operator (RCO). Communications between the autonomous vehicles 105, oversight system 350 and user interface 362 take place over a network 370. In some instances, where not all the autonomous vehicles 105 in a fleet are able to communicate with the oversight system 350, the autonomous vehicles 105 may communicate with each other over the network 370 or directly. As described with respect to FIG. 1, the VCU 150 of each autonomous vehicle 105 may include a module for network communications 178.

An autonomous truck may be in communication with an oversight system. The oversight system may serve many purposes, including: tracking the progress of one or more autonomous vehicles (e.g., an autonomous truck); tracking the progress of a fleet of autonomous vehicles; sending maneuvering instructions to one or more autonomous vehicles; monitoring the health of the autonomous vehicle(s); monitoring the status of the cargo of each autonomous vehicle in contact with the oversight system; facilitate communications between third parties (e.g., law enforcement, clients whose cargo is being carried) and each, or a specific, autonomous vehicle; allow for tracking of specific autonomous trucks in communication with the oversight system (e.g., third-party tracking of a subset of vehicles in a fleet); arranging maintenance service for the autonomous vehicles (e.g., oil changing, fueling, maintaining the levels of other fluids); alerting an affected autonomous vehicle of changes in traffic or weather that may adversely impact a route or delivery plan; pushing over the air updates to autonomous trucks to keep all components up to date; and other purposes or functions that improve the safety for the autonomous vehicle, its cargo, and its surroundings. An oversight system may also determine performance parameters of an autonomous vehicle or autonomous truck, including any of: data logging frequency, compression rate, location, data type; communication prioritization; how frequently to service the autonomous vehicle (e.g., how many miles between services); when to perform a minimal risk condition (MRC) maneuver while monitoring the vehicle's progress during the maneuver; when to hand over control of the autonomous vehicle to a human driver (e.g., at a destination yard); ensuring an autonomous vehicle passes pre-trip inspection; ensuring an autonomous vehicle performs or conforms to legal requirements at checkpoints and weight stations; ensuring an autonomous vehicle performs or conforms to instructions from a human at the site of a roadblock, cross-walk, intersection, construction, or accident; and the like.

Included in some of the functions executed by an oversight system or command center is the ability to relay over-the-air, real-time weather updates to autonomous vehicles in a monitored fleet. The over-the-air weather updates may be pushed to all autonomous vehicles in the fleet or may be pushed only to autonomous vehicles currently on a mission to deliver a cargo. Alternatively, or additionally, priority to push or transmit over-the-air weather reports may be given to fleet vehicles currently on a trajectory or route that leads towards or within a pre-determined radius of a severe weather event.

Another function that may be encompassed by the functions executed by an oversight system or command center is the transmission of trailer metadata to the autonomous vehicle's computing unit (VCU) prior to the start of a cargo transport mission. The trailer metadata may include the type of cargo being transmitted, the weight of the cargo, temperature thresholds for the cargo (e.g., trailer interior temperature should not fall below or rise above pre-determined temperatures), time-sensitivities, acceleration/deceleration sensitivities (e.g., jerking motion may be bad because of the fragility of the cargo), trailer weight distribution along the length of the trailer, cargo packing or stacking within the trailer, and the like.

To allow for communication between autonomous vehicles in a fleet and an oversight system or command center, each autonomous vehicle may be equipped with a communication gateway. The communication gateway may have the ability to do any of the following: allow for autonomous vehicle to oversight system communication (e.g. V2C) and the oversight system to autonomous vehicle communication (C2V); allow for autonomous vehicle to autonomous vehicle communication within the fleet (V2V); transmit the availability or status of the communication gateway; acknowledge received communications; ensure security around remote commands between the autonomous vehicle and the oversight system; convey the autonomous vehicle's location reliably at set time intervals; enable the oversight system to ping the autonomous vehicle for location and vehicle health status; allow for streaming of various sensor data directly to the command or oversight system; allow for automated alerts between the autonomous vehicle and oversight system; comply to ISO 21434 standards; and the like.

An oversight system or command center may be operated by one or more human, also known as an operator or a remote center operator (RCO). The operator may set thresholds for autonomous vehicle health parameters, so that when an autonomous vehicle meets or exceeds the threshold, precautionary action may be taken. Examples of vehicle health parameters for which thresholds may be established by an operator may include any of: fuel levels; oil levels; miles traveled since last maintenance; low tire-pressure detected; cleaning fluid levels; brake fluid levels; responsiveness of steering and braking subsystems; Diesel exhaust fluid (DEF) level; communication ability (e.g., lack of responsiveness); positioning sensors ability (e.g., GPS, IMU malfunction); impact detection (e.g., vehicle collision); perception sensor ability (e.g., camera, LIDAR, radar, microphone array malfunction); computing resources ability (e.g., VCU or ECU malfunction or lack of responsiveness, temperature abnormalities in computing units); angle between a tractor and trailer in a towing situation (e.g., tractor-trailer, 18-wheeler, or semi-truck); unauthorized access by a living entity (e.g., a person or an animal) to the interior of an autonomous truck; and the like. The precautionary action may include execution of a minimal risk condition (MRC) maneuver, seeking service, or exiting a highway or other such re-routing that may be less taxing on the autonomous vehicle. An autonomous vehicle whose system health data meets or exceeds a threshold set at the oversight system or by the operator may receive instructions that are automatically sent from the oversight system to perform the precautionary action.

The operator may be made aware of situations affecting one or more autonomous vehicles in communication with or being monitored by the oversight system that the affected autonomous vehicle(s) may not be aware of. Such situations may include: irregular or sudden changes in traffic flow (e.g., traffic jam or accident); abrupt weather changes; abrupt changes in visibility; emergency conditions (e.g., fire, sink-hole, bridge failure); power outage affecting signal lights; unexpected road work; large or ambiguous road debris (e.g., object unidentifiable by the autonomous vehicle); law enforcement activity on the roadway (e.g., car chase or road clearing activity); and the like. These types of situations that may not be detectable by an autonomous vehicle may be brought to the attention of the oversight system operator through traffic reports, law enforcement communications, data from other vehicles that are in communication with the oversight system, reports from drivers of other vehicles in the area, and similar distributed information venues. An autonomous vehicle may not be able to detect such situations because of limitations of sensor systems or lack of access to the information distribution means (e.g., no direct communication with weather agency). An operator at the oversight system may push such information to affected autonomous vehicles that are in communication with the oversight system. The affected autonomous vehicles may proceed to alter their route, trajectory, or speed in response to the information pushed from the oversight system. In some instances, the information received by the oversight system may trigger a threshold condition indicating that MRC (minimal risk condition) maneuvers are warranted; alternatively, or additionally, an operator may evaluate a situation and determine that an affected autonomous vehicle should perform a MRC maneuver and subsequently send such instructions to the affected vehicle. In these cases, each autonomous vehicle receiving either information or instructions from the oversight system or the oversight system operator uses its on-board computing unit (e.g. VCU) to determine how to safely proceed, including performing a MRC maneuver that includes pulling-over or stopping.

Other interactions that the remote center operator (RCO) may have with an autonomous vehicle or a fleet of autonomous vehicle includes any of the following: pre-planned event avoidance; real-time route information updates; real-time route feedback; trail hookup status; first responder communication request handling; notification of aggressive surrounding vehicle(s); identification of construction zone changes; status of an autonomous vehicle with respect to its operational design domain (ODD), such as alerting the RCO when an autonomous vehicle is close to or enters a status out of ODD; RCO notification of when an autonomous vehicle is within a threshold distance from a toll booth and appropriate instruction/communication with the autonomous vehicle or toll authority may be sent to allow the autonomous vehicle to bypass the toll; RCO notification of when an autonomous vehicle bypasses a toll; RCO notification of when an autonomous vehicle is within a threshold distance from a weigh station and appropriate instruction/communication with the autonomous vehicle or appropriate authority may be sent to allow the autonomous vehicle to bypass the weigh station; RCO notification of when an autonomous vehicle bypasses a weigh station; notification to the autonomous vehicle from the RCO regarding scheduling or the need for fueling or maintenance; RCO authorization of third-party access to an autonomous vehicle cab; ability of an RCO to start/restart an autonomous driving system (ADS) on a vehicle; ability of an administrator (possibly an RCO) to set roles for system users, including ground crew, law enforcement, and third parties (e.g., customers, owners of the cargo); support from a RCO for communication with a service maintenance system with fleet vehicles; notification to the RCO from an autonomous vehicle of acceleration events; instruction from a RCO to an autonomous vehicle to continue its mission even when communication is interrupted; RCO monitoring of an autonomous vehicle during and after an MRC maneuver is executed; support for continuous communication between an autonomous vehicle and a yard operator at facility where the autonomous vehicle is preparing to begin a mission or where the autonomous vehicle is expected to arrive; oversight system monitoring of software systems on an autonomous vehicle and oversight system receiving alerts when software systems are compromised; and the like.

An oversight system or command center may allow a third party to interact with the oversight system operator, with an autonomous truck, or with both the human system operator and an autonomous truck. A third party may be a customer whose goods are being transported, a law enforcement or emergency services provider, or a person assisting the autonomous truck when service is needed. In its interaction with a third party, the oversight system may recognize different levels of access, such that a customer concerned about the timing or progress of a shipment may only be allowed to view status updates for an autonomous truck, or may able to view status and provide input regarding what parameters to prioritize (e.g., speed, economy, maintaining originally planned route) to the oversight system. By providing input regarding parameter prioritization to the oversight system, a customer can influence the route and/or operating parameters of the autonomous truck.

Actions that an autonomous vehicle, particularly an autonomous truck, as described herein may be configured to execute to safely traverse a course while abiding by the applicable rules, laws, and regulations may include those actions successfully accomplished by an autonomous truck driven by a human. These actions, or maneuvers, may be described as features of the truck, in that these actions may be executable programming stored on the VCU 150 (the in-vehicle control computer unit). These actions or features may include those related to reactions to the detection of certain types of conditions or objects such as: appropriate motion on hills; appropriate motion on curved roads, appropriate motion at highway exits; appropriate motion or action in response to: detecting of one or more stopped vehicle, detecting one or more vehicles in an emergency lane; detecting an emergency vehicle with flashing lights that may be approaching the autonomous vehicle; motion in response to detecting on or more large vehicles approaching, adjacent to, or soon, to be adjacent to the autonomous vehicle; motions or actions in response to pedestrians, bicyclists, and the like after identification and classification of such actors; motions or actions in response to curved or banked portions of the roadway; and/or motions in response to identifying on and off ramps on highways or freeways, encountering an intersection; execution of a merge into traffic in an adjacent lane or area of traffic; detection of need to clean one or more sensor and the cleaning of the appropriate sensor; and the like. Other features of an autonomous truck may include those actions or features which are needed for any type of maneuvering, including that needed to accomplish the features or actions that are reactionary, listed above.

Supporting features may include: changing lanes safely; operating turn signals on the autonomous truck to alert other drivers of intended changes in motion; biasing the autonomous truck in its lane (e.g., moving away from the center of the lane to accommodate the motions or sizes of neighboring vehicles or close objects); ability to maintain an appropriate following distance; the ability to turn right and left with appropriate signaling and motion, and the like. Supporting features may also include: the ability to navigate roundabouts; the ability to properly illuminate with on-vehicle lights as-needed for ambient light and for compliance with local laws; apply the minimum amount of deceleration needed for any given action; determine location at all times; adapting dynamic vehicle control for trailer load distributions, excluding wheel adjustment; launching (reaching target speed), accelerating, stopping, and yielding; operate on roadways with bumps and potholes; enter a minimal risk condition (MRC) on roadway shoulders; access local laws and regulations based on location along a route; operate on asphalt, concrete, mixed grading, scraped road, and gravel; ability to operate in response to metering lights/signals at on-ramps; operate on a roadway with a width up to a pre-determined width; able to stop at crosswalks with sufficient stopping distance; navigate two-way left turn lanes; operate on roadways with entry and exit ramps; utilize the vehicle horn to communicate with other drivers, and the like. One or more features and/or one or more supporting features described in this patent document may combined and can be performed by the in-vehicle control computer in an autonomous truck.

In some embodiments, the actions or features may be considered supporting features and may include: speed control; the ability to maintain a straight path; and the like. These supporting features, as well as the reactionary features listed above, may include controlling or altering the steering, engine power output, brakes, or other vehicle control subsystems 146. The reactionary features and supporting features listed above are discussed in greater detail below.

III. Curved Roads and/or General Curves

An autonomous truck may be able to navigate curved highway roads safely. This navigation includes having the ability to detect that a portion of a highway or roadway is curved. Various types of data, including mapping, navigational, and perception data (e.g., images, radar data, LiDAR data), may be used to identify a curved stretch of road. Once a curved portion of the roadway or highway is identified, an autonomous vehicle (e.g., autonomous truck) can be controlled to maneuver appropriately. The autonomous vehicle may be controlled to stay within the boundaries of its current lane, make appropriate speed and steering adjustments to keep in its lane. The autonomous vehicle control systems can alter the positioning of the autonomous vehicle within its lane, that is to say adjust lane biasing, in light of surrounding vehicles or objects, as will be described in greater detail below. There can also be a threshold amount that the autonomous vehicle, or truck, may be allowed to move to accommodate surrounding vehicles and the curve in the roadway. If this threshold amount would be exceeded, the autonomous truck can perform an alternative maneuver, such as slowing, temporarily moving off the roadway, or rerouting, to travel safely.

III.(a) Curved Road Description

Curved Roads may be defined as continuous road sections that is not interrupted by traffic intersections with a minimum curvature radius between pre-determined threshold values, such as 1250 m, including 1200 m, 1150 m, and 1100 m.

In some implementations, to obtain a higher level of comfort and stability of lateral acceleration less than 1 m/s\hat{ }2 in a curve, the smallest curvature radius that an autonomous vehicle can take without slowing down at a maximum operating speed of 75 mph (33.5 m/s) is calculated to be within the pre-determined threshold values, including a minimum curvature radius of 1112 m, 1124 m, or 1136 m.

III.(b) Mapping

Autonomous vehicle may have curved road sections mapped out for navigation use. Autonomous vehicle can have curved road sections and related semantics included in the map for navigation use. Related semantics may include a vocabulary for identification of features related to a curve in general.

III.(c) Minimum Curve Avoidance

Autonomous vehicle may avoid curved roads with a minimum curvature radius of less than a threshold value or a pre-determined distance. The threshold value for a minimum curvature radius for a curved road may be based on the truck configuration (e.g., length of trailer, position of front wheels of the trailer, position of the 5th-wheel hook-up). The threshold minimum radius of curvature for a road on which an autonomous vehicle (i.e., autonomous truck) can safely operate may be in a range of 15 m to 20 m, such as 17 m to 19 m, including 18 m. Analogously, the minimum curvature value threshold may be in a range of 0.40 rad/m to 0.70 rad/m, such as 0.45 rad/m to 0.65 rad/m or 0.50 rad/m to 0.60 rad/m including 0.055 rad/m.

III.(d) Smooth Acceleration and Deceleration

Except for evasive maneuvers, autonomous vehicle may use acceleration and deceleration of no more than a pre-determined threshold amount or a pre-determined rate (m/s\hat{ }2) in curved roads to prevent jerking that may upset the balance of autonomous vehicle in a curve. The predetermined rate may be within a range of 0.5 m/s\hat{ }2 to 10 m/s\hat{ }2, such as 1 m/s\hat{ }2 to 8 m/s\hat{ }2, and including 2 m/s\hat{ }2 to 6 m/s\hat{ }2.

III.(e) Curved Road Sign Recognition

Autonomous vehicle may be able to recognize curved roads based on the signs. Signs may be recognized based on the color of the sign, the shape of the sign, and an illustration on the sign. Alternatively, or additionally, the signs may include words indicating any of a curve ahead, a speed limit, a distance over which there are curves in the road ahead, reduced visibility due to curves ahead, and changes in the passing conventions due to curves in the road ahead.

III.(f) Curved Road Bias

Autonomous vehicle may bias up to a pre-determined threshold distance from the center of the lane towards the convex side (or side that curves outwards) of the curve when driving on a curved highway section with a minimum curvature radius of that is greater than or equal to a pre-determined threshold distance. The pre-determined threshold distance may be within a range of values such as 0.25 to 1.5 meters, 0.25 to 1.25 meters, including 0.30 to 1.0 meters.

III.(g) Visibility Time-To-Crash (TTC)

Autonomous vehicle may slow down to keep at least a pre-determined amount of time of TTC for visibility when encountering curve. For example, autonomous vehicle can slow down to keep at least a pre-determined number of seconds of TTC of forward visibility of front NPCs or objects in lane when encountering a curve. The pre-determined number of seconds of time to collision (TTC) of forward visibility may fall within a range of values, such as between 2 and 8 seconds, such as between 2 and 6 seconds, including between 3 and 5 seconds.

III.(h) Curved Road Superelevation Avoidance

Autonomous vehicle may avoid curved roads with a superelevation (or an upward angle of the curved road relative to a flat surface) of more than a pre-determined threshold amount or a pre-determined percentage. The pre-determined percentage of superelevation may fall in a range between 5% and 15%, such as between 7% and 12%, including between 8% and 10%.

According to U.S. Department of Transportation, superelevation is the rotation of the pavement on the approach to and through a horizontal curve. This type of rotation of the pavement is intended to assist the driver by counteracting the lateral acceleration produced by tracking the curve.

III.(i) Lane Change Avoidance

Autonomous vehicle may avoid all types of efficiency and lower priority lane changes while on curved roads. An efficiency lane change is a lane change in which efficiency is the reason for the lane change. For example, intending to change lane because staying in the present lane would lead to an unintended exit from the highway onto a local road in a predetermined distance (e.g., 1100 m, 1200 m, 1300 m, 1400 m) is an efficiency lane change. This type of lane change would avoid having to exit the highway and use local roads to get back on course. Other types of efficiency lane changes may include: intending to change lanes due to an upcoming planned exit that is between 1600 meters (1 mile) and 3200 meters away from the autonomous vehicle; intending to change lanes because staying in the present lane would result in an unplanned exit from the highway in more than a predetermined distance 1600 meters (1 mile) and less than 3200 meters; and intending to change lanes to bypass a slow vehicle traveling in a predetermined range under the environmental speed (e.g., between 5 mph and 25 mph under the environmental speed, between 10 mph and 20 mph under the environmental speed).

III.(j) Off-Tracking Area

Unless lane changing or biasing, autonomous vehicle may select a trajectory such that the off-tracking area is within the bounds of the lane lines when in a curved road. In the vehicle arts, off-tracking (or offtracking) occurs when a vehicle makes a turn and the rear wheels do not follow the same path as the front wheels. The off-tracking area is the area swept by the rear wheels of the autonomous vehicle as it traverses a curve.

III.(k) Curved Road Detection

Autonomous vehicle may be able to detect the curvature of the road using onboard sensors located on or in the autonomous vehicle. The onboard sensors used to detect the configuration of a roadway may include visual cameras, LIDAR, radar, GPS or other positioning systems, time-of-flight cameras, ultrasonic sensors, and the like.

III.(l) Speed Reduction

Autonomous vehicle may reduce speed when driving on curved roads to prevent the tipping, swaying or slipping of the trailer. Sensors which may detect tipping, swaying or slipping of the autonomous vehicle or a trailer portion of the autonomous vehicle may include any of one or more inertial measurement units (IMUs), one or more gyroscopes, on-board cameras, one or more ultrasonic sensors, on-board LIDAR data, detectors of irregular changes to wheel slip on pavement, sensors to detect changes in steering angle while keeping a planned trajectory (i.e., this can be an indicator of changes in the distribution of a load or other forces across the axels/wheels of a vehicle), and the like.

Autonomous vehicle may consider the superelevation, the curvature of the road, the road traction condition, the prevailing weather condition, visibility condition as well as the weight and center of gravity of autonomous vehicle and the trailer.

III.(m) do not Cross Lane Boundaries

Autonomous vehicle may not deviate from the center of the lane to the extent that any part of the truck (including mirrors) crosses the nearest edge of a lane boundary, except for evasive maneuvers or when needed for a planned bias.

III.(n) Off-Center Threshold with Nearby Vehicles

When there is an adjacent vehicle parallel to autonomous vehicle on a curve, autonomous vehicle may not deviate from the center of the lane to the extent that any part of the truck (tractor or trailer, including mirrors) comes within a pre-determined distance from the lane boundary that intersects autonomous vehicle and the nearby vehicles (e.g., NPC vehicle). The pre-determined distance from the lane boundary may be within a range of distances from 0.1 m to 0.5 m, such as 0.15 m to 0.4 m, including 0.2 m to 0.3 m. The distance to the lane boundary should be measured from the edge of the boundary closest to autonomous vehicle This restriction can only apply to lanes that are at or above the standard highway lane width in the U.S. of, for example, 3.66 meters (12 feet). A vehicle may be considered parallel to the autonomous vehicle if the on-board sensors detect that there is some degree of overlap.

For example, in one implementation, the width of an autonomous vehicle including mirrors and side sensor assemblies may be between 2.6 m and 2.7 m. The localization sensors and systems of the autonomous vehicle may include errors with respect to the distance from the lane center. This may allow for the pre-determined distance from the lane boundary to be met.

III.(o) Bias for Nearby Vehicles

When there is a nearby adjacent large vehicle, autonomous vehicle may conduct a critical safety bias away from the vehicle.

When there is a nearby adjacent non-large vehicle, autonomous vehicle may conduct a non-critical safety bias away from the vehicle.

A large vehicle may include vehicles with a length greater than 7 meters or if it is an oversized vehicle. Consumer vehicles without an attached trailer may be excluded from being defined as a large vehicle.

A critical safety bias is when the autonomous vehicle moves away from a hazard within its current lane. The autonomous vehicle may relax lane boundaries as needed. Situations that may require a critical safety bias in at least the following situations: when driving parallel to a non-compliant vehicle, and the autonomous vehicle cannot lane change or is in the process of changing lanes; when driving parallel to an oversized vehicle; when driving parallel to a large vehicle on a curved road; when driving parallel to a large vehicle in a narrow lane; and when driving parallel to an ELV with a pedestrian and the autonomous vehicle cannot lane change or is are in the process of changing lanes.

The preferred behavior in the above situations may be to do a different maneuver, such as lane change. Biasing would only apply when a lane change, or other preferred behavior, cannot be performed or the autonomous vehicle is in the process of performing it.

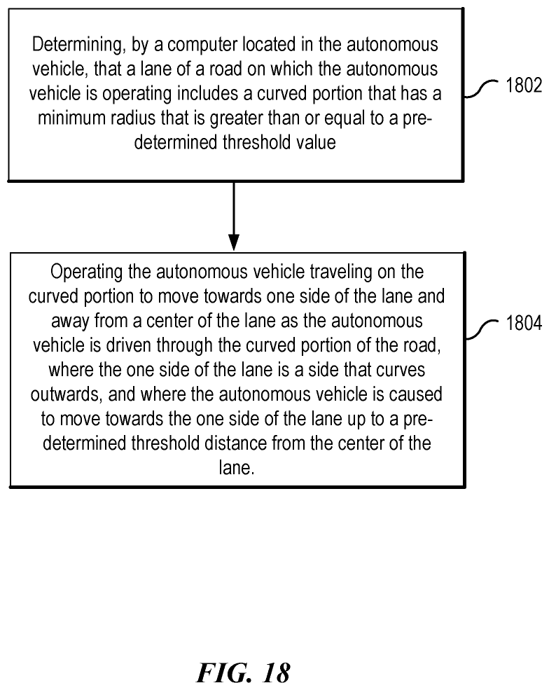

FIG. 18 shows an example flowchart of an autonomous driving operation performed by a vehicle to operate on a curved region of a road. Operation 1802 includes determining, by a computer located in the autonomous vehicle, that a lane of a road on which the autonomous vehicle is operating includes a curved portion that has a minimum radius that is greater than or equal to a pre-determined threshold value. Operation 1804 includes operating the autonomous vehicle traveling on the curved portion to move towards one side of the lane and away from a center of the lane as the autonomous vehicle is driven through the curved portion of the road, where the one side of the lane is a side that curves outwards, and where the autonomous vehicle is caused to move towards the one side of the lane up to a pre-determined threshold distance from the center of the lane. In some embodiments, the operating the autonomous vehicle to move towards one side of the lane in operation 1804 includes sending instructions to one or more devices (e.g., one or more motors) in a steering system of the autonomous vehicle to steer the autonomous vehicle.

In some embodiments, the method further comprises operating the autonomous vehicle to avoid traveling on another curved portion on the road in response to determining that the another curved portion has a superelevation that is greater than a pre-determined threshold amount, where the superelevation describes an upward angle that is formed by the another curved portion that is angled upwards relative to a flat surface. In some embodiments, the pre-determined threshold amount is a value between 5 percent and 15 percent. In some embodiments, the method further comprises operating the autonomous vehicle to accelerate or to decelerate less than or equal to a pre-determined rate in the curved portion of the road. In some embodiments, the method further comprises operating the autonomous vehicle to reduce speed of the autonomous vehicle in response to determining that a time to collision (TTC) value when the autonomous vehicle is operating in the curved portion is greater than a pre-determined amount of time, where the TTC value indicates an amount of time of a visibility provided by one or more cameras on the autonomous vehicle.

### IV. Emergency Lane Vehicle on Highway or Road

An autonomous truck may be able to maneuver appropriately when encountering one or more vehicles in an emergency lane on a roadway that the truck is traversing. This feature includes the ability to identify that there is at least one vehicle in the emergency lane (e.g., shoulder lane). The ability to identify the presence of a vehicle in the emergency lane includes identifying an emergency lane, identifying the type of vehicle in the emergency lane, and identifying the possibility that a vehicle will enter traffic or leave traffic for the emergency lane, as well as identifying the location of the one or more vehicles in the emergency lane.

Behaving appropriately for any vehicle on a freeway passing a vehicle in a shoulder or emergency lane may depend on many factors, including any one or more of: the surrounding traffic, the desired trajectory of the moving vehicle, the presence or approach of emergency responders or law enforcement, the presence of pedestrians adjacent to the pulled-over vehicle, road debris, and/or local regulations.

After detecting the presence of one or more vehicles stopped in the shoulder or emergency lane, an autonomous truck may do any of the following, as deemed appropriate: slow in the current lane; move over in the current lane to accommodate the stopped vehicle(s); move over in the current lane to accommodate other vehicles moving to avoid the stopped vehicle(s), change lanes to create more distance between the autonomous vehicle and the stopped vehicle(s); and exit the roadway.

In some embodiments, when slowing with an emergency vehicle detected in a shoulder or emergency lane adjacent to the autonomous truck, the autonomous vehicle truck may slow down by a predetermined amount when the posted speed limit is 25 mph or more (e.g., at least 20 mph when the posted speed limit is 25 mph or more). Alternatively, if the posted speed limit is less than 25 mph, an autonomous truck traveling in a lane adjacent to an emergency lane in which an emergency vehicle is stopped may slow down to 5 mph.

In some instances, an emergency vehicle or other vehicle that is stopped in a shoulder or emergency vehicle may begin to move into the main lanes of traffic. The autonomous truck can accommodate the emergency vehicle by adjusting its speed or executing other accommodating maneuvers. This process of accommodating one or more vehicle moving from a shoulder to a main lane of traffic can include considerations of local regulations and calculations of which maneuver is safest and most feasible to execute, as well as identifying that a vehicle in a shoulder wants to enter traffic. Conversely, it may be necessary accommodate an emergency or other vehicle that needs to enter a shoulder or emergency lane. Part of such an accommodation by an autonomous truck is the identification of a vehicle that wants to move to a shoulder, as well as considering local regulations and general safety to move in such as way to allow the other vehicle to reach the shoulder, assuming the other vehicle has sufficient power to do so.

IV.(a) Highway Emergency Lane Vehicle (ELV) Description

An Emergency Lane Vehicle (ELV) is any type of vehicle outside the driving lane boundaries and within a pre-determined number of meters (e.g., 7 meters, 7.25 meters, 7.5 meters, 7.75 meters, 8 meters) from the closest point of the NPC to the closest outer driving lane boundaries on highway, including inside a paved/unpaved shoulder, emergency lane, or gore area.

A driving lane boundary refers to the edge line pavement marking that delineates the right or left edges of a roadway. By FWHA MUTCD Section 3B06 and 3B07, right edge line pavement markings will consist of a normal solid white line and left edge line pavement markings (on divided highways or one-way streets) will consist of a normal solid yellow line; additionally, (1) freeways, (2) expressways, and (3) rural arterials with a traveled way greater than or equal to 20 feet and average daily traffic or greater than or equal to 6,000 cars, must include edge line markings.

IV.(b) NPC Transition to ELV

Autonomous vehicle may be able to predict when an NPC is transitioning into becoming an ELV. A NPC, non-player character, may be a manually operated vehicle or another autonomous vehicle that is not controlled by the autonomous driving system of the autonomous vehicle discussed herein that is sometimes referred to as Ego. The autonomous vehicle may use on-board sensors to detect characteristics or behaviors of the NPC that indicate a transition from NPC to ELV. The characteristics or behaviors of the NPC that may be indicative of a transition to ELV may include any of: use of a turn signal indicating a direction toward a shoulder; a change in bias or trajectory of the NPC; activation of hazard lights by the NPC; activation of flashing lights indicative of an emergency vehicle, a rescue vehicle, or a law enforcement vehicle; a change in velocity of the NPC as well as a direct communication from the NPC to the autonomous vehicle (e.g., Ego) indicating the intent of the NPC to move to the emergency lane or shoulder, and the like.

In some implementations, an autonomous vehicle may determine that a NPC is transitioning to an ELV if the NPC is slowing down and signaling its intent to turn into the shoulder (or gore area, etc.).

IV.(c) NPC Transitioning to an ELV—Behavior

If a vehicle is transitioning to an ELV, autonomous vehicle may change lanes away from the shoulder's adjacent lane. If autonomous vehicle is following the vehicle in the shoulder's adjacent lane and is unable to change lanes, autonomous vehicle may slow down and match the speed of the vehicle until it pulls out of autonomous vehicle's lane.

IV.(d) NPC Transitioning to an ELV—Behavior—Do Not Change Lane

An autonomous vehicle may not change lanes into the lane adjacent to the transitioning ELV's destination area.

IV.(e) Late Detection of ELVs

Timely detection of a vehicle in shoulder or gore area in important for maintaining safety of an autonomous vehicle. If the ELV was occluded from autonomous vehicle's view or detected late (e.g., high curvature area, gore area), and the system is unable to meet predetermined reaction distance requirements, the system may react immediately once the ELV is detected. The behaviors remain the same as described in this section. In this scenario, autonomous vehicle may at least finish the deceleration when autonomous vehicle's front bumper is a predetermined distance (e.g., 2.5 meters, 3 meters, 3.5 meters, 4 meters) before (or behind) ELV's rear bumper.

The predetermined reaction distance requirements may be as follows. When encountering an ELV in an area that is directly adjacent to the current lane travelled, an autonomous vehicle may change lanes away from the ELV in order to pass. The autonomous vehicle may aim to change lanes as soon as it detects the ELV and start to react no later than a predetermined distance (e.g., 125 meters, 140 meters, 152 meters (500 ft), 175 meters) before reaching the ELV. In some instances, the autonomous vehicle may not be able to change lanes away from the ELV. When encountering an ELV in an area that is adjacent to the lane currently traversed and unable to change lanes to pass, the autonomous vehicle may start to slow down and bias to maintain a safe speed and lateral distance a predetermined distance before reaching the ELV, such as no later than 125 meters, 140 meters, or 152 meters (500 ft) before reaching the ELV.

IV.(f) ELV Close to Driving Lane

When encountering an ELV that is within a pre-determined distance (e.g., 1.0 meters, 1.3 meters, 1.5 meters) (laterally) of autonomous vehicle autonomous vehicle may do a full lane change or lane bias to maintain at least the distance (e.g., 1.0-meter lateral distance, 1.3-meter lateral distance) from the ELV. It is allowable for autonomous vehicle to cross lane boundaries listed below to perform a full lane change or avoid an accident in this scenario.

| | | Autonomous vehicle may |
|---|---|---|
| | Autonomous vehicle may | only cross to avoid a |
| State | cross for this maneuver | collision |
| AZ | Dotted white lines, dotted | Solid yellow lines, double |
| | yellow lines, solid white | solid white lines |
| | lines | |

IV.(g) Lane Change Preference

When encountering an ELV in an area that is directly adjacent to the current lane, an autonomous vehicle may change lanes away from the ELV in order to pass. The autonomous vehicle may aim to change lanes as soon as it detects the ELV and start to react no later than a pre-determined number of meters (e.g., 125 meters (m), 130 m, 140 m, 150 m, 152 m, 155 m or 160 m) before reaching the ELV.

IV.(h) Roadside Emergency Vehicle

When encountering a roadside emergency vehicle, the autonomous system may change lanes as per the following. When encountering an ELV in an area that is directly adjacent to the current lane travelled, an autonomous vehicle may change lanes away from the ELV in order to pass. The autonomous vehicle may aim to change lanes as soon as it detects the ELV and start to react no later than a predetermined distance (e.g., 125 meters, 140 meters, 152 meters (500 ft), 175 meters) before reaching the ELV.

If a lane change is not possible, autonomous vehicle may slow down according to the law of the state autonomous vehicle is operating that can be defined by a geofence, showing in the table below.

| State | Deceleration requirements | Laws |
|---|---|---|
| Texas | Autonomous vehicle may | TEXAS |
| | slow down by 20 mph when the | TRANSPORTATION |
| | posted speed limit is 25 mph or more, | CODE, |
| | or slow down to 5 mph when the posted | Section 545.157. |
| | speed limit is less than 25 mph. | |

The strictest law regarding roadside emergency vehicles currently comes from Texas regulation.

IV.(i) Slow Down and Bias Strategy

When encountering an emergency lane vehicle (ELV) in an area that is adjacent to the current lane of the autonomous vehicle and the autonomous vehicle is unable to change lanes to pass, the autonomous vehicle may start to slow down and bias to maintain a safe speed (e.g., less than or equal to the “max passing speed” shown in Tables 1 and 2 below) and lateral distance no later than a pre-determined distance before reaching the ELV, e.g., 125 meters, 140 meters, or 152 meters (500 ft) before reaching the ELV.

The lateral distance can refer to the perpendicular distance between the outermost point of autonomous vehicle to the outermost point of the ELV, unless otherwise noted.

Key Parameters (based on interviews with drivers):

TABLE 1
Recommended Max passing speeds for ELVs on highways

| | Max passing speed | Max passing speed |
|---|---|---|
| Posted speed | when lateral distance >1.3 | when lateral distance <= 1.3 |
| limit | meters | meters |
| 75 mph | 65 mph, or between | 55 mph, or between |
| | 60 mph and 65 mph | 50 mph and 55 mph |
| 65 mph | 55 mph, or between | 45 mph, or between |
| | 50 mph and 55 mph | 40 mph and 45 mph |
| 55 mph | 50 mph, or between | 40 mph, or between |
| | 45 mph and 50 mph | 35 mph and 40 mph |

TABLE 2
Recommended Max passing speeds for ELVs on local roads

| Posted speed | |
|---|---|
| limit | Max passing speed |
| 55 mph | 40 mph, or between 35 mph and 40 mph |
| 40 mph | 30 mph, or between 35 mph and 40 mph |
| 30 mph | 20 mph, or between 35 mph and 40 mph |
| 20 mph | 10 mph, or between 5 mph and 10 mph |
| 10 mph | 10 mph, or between 5 mph and 10 mph |

TABLE 3
Preferred bias thresholds

| Lateral distance | | | |
|---|---|---|---|
| between the ELV | | Adjacent vehicle | |
| and the lane | | type in direction | |
| boundary | | of bias (if any) | Lateral Bias Distance |
| 1.3 | meters | Any | Bias not needed |
| =1.3 | meters | Truck or Oversized | Bias not recommended |
| | | Vehicle | |
| =1.3 | meters | Passenger Vehicle | No part of autonomous |
| | | | vehicle crosses any part |
| | | | of adjacent lane line |
| | | | in direction of bias |

IV.(j) ELV with Nearby Pedestrians

When there are pedestrians near an ELV, autonomous vehicle may decelerate and pass with a pre-determined minimum lateral distance (e.g., 3.25 m, 3.5 m, 3.75 m, 4.0 m, 4.25 m). If not possible, autonomous vehicle may maintain a minimum pre-determined distance (e.g., 0.8 m, 0.92 m, 0.95 m, 1.0 m) to the pedestrians.

IV.(k) Emergency Lane Vehicle (ELV) Near Planned Exit

When approaching an exit on a planned route, if there is an ELV (emergency lane emergency vehicle) or ELV with pedestrians nearby, it is acceptable for autonomous vehicle to prioritize deceleration over fully changing lanes in order to avoid missing exits. In these scenarios, autonomous vehicle may decelerate. Deceleration of the autonomous vehicle when there is an ELV near a planned exit may occur according to either Table 4, below. Table 4 has guidance values for maximum passing values when there are ELVs on a highway, with differing maximum passing speeds for various posted speed limits on the highway. Alternatively, or additionally, the autonomous vehicle may decelerate and pass an ELV with pedestrians nearby with a predetermined minimum lateral distance between 2.5 meters and 4.5 meters, such as 3 meters and 4 meters, such as at least 3.75 meters (12 feet). When passing with the predetermined minimum lateral distance, the autonomous vehicle may maintain a distance of at least a predetermined amount to any pedestrians present. In some such cases, the predetermined distance between pedestrians and the autonomous vehicle may be dictated by laws or regulations, such as 0.92 m (3 feet) as per Arizona law.

TABLE 4
Suggested maximum passing speeds for situations when
there are emergency lane vehicles (ELVs) on highways.

| | Max passing speed | |
|---|---|---|
| Posted speed | for Regulatory & | Max passing speed |
| limit | Non-Critical ELVs | for Critical ELVs |
| 75 mph | 65 mph, or between | 55 mph, or between |
| | 60 mph and 65 mph | 50 mph and 55 mph |
| 65 mph | 55 mph, or between | 50 mph, or between |
| | 50 mph and 55 mph | 45 mph and 50 mph |
| 55 mph | 45 mph, or between | 40 mph, or between |
| | 40 mph and 45 mph | 35 mph and 40 mph |
| 40 mph | 30 mph, or between | 30 mph, or between |
| | 25 mph and 30 mph | 25 mph and 30 mph |
| 30 mph | 20 mph, or between | 20 mph, or between |
| | 15 mph and 20 mph | 15 mph and 20 mph |
| 20 mph | 10 mph, or between | 10 mph, or between |
| | 5 mph and 10 mph | 5 mph and 10 mph |
| 10 mph | 10 mph, or between | 10 mph, or between |
| | 5 mph and 10 mph | 5 mph and 10 mph |

IV.(l) ELV Near Speed Limit Change Area

When encountering an ELV in the speed limit change area, there are three states of autonomous vehicle:
1) Autonomous vehicle is at the old speed
2) Autonomous vehicle is changing speed to the new speed
3) Autonomous vehicle is at the new speed

Autonomous vehicle may follow the strategies below according to different ELV locations: State(1) Strategy—ELV in Speed Limit Change Area, State(2) Strategy—Speed Limit Increases, State(2) Strategy—Speed Limit Decreases, State(3) Strategy—ELV in Speed Limit Change Area

The new speed limit takes effect at the point of the speed limit sign.

IV.(m) State(1) Strategy—ELV in Speed Limit Change Area

If the ELV is within (1), autonomous vehicle may decelerate according to the original speed limit,

IV.(n) State (2) Strategy: Autonomous Vehicle Near an ELV and an Area with Speed Limit Increase

An autonomous vehicle accelerating due do an increase in the posted speed limit near an emergency lane vehicle (ELV) may require different behavior based on the location of the ELV. An ELV on a ramp section of a highway may require a first type of behavior, while an ELV on a straight part of a highway may a second, and an ELV on a curved portion of a highway may require a third type of behavior from the autonomous vehicle.

In general, when an autonomous vehicle is accelerating due to a speed limit increase, the autonomous vehicle may cease accelerating when the ELV is within a predetermined distance of the autonomous vehicle. The autonomous vehicle may pass the ELV as a speed no more than the maximum passing speed for the portion of the road that the center of the ELV is located. Further, when the ELV is in a location that is not a ramp section, and the autonomous vehicle has not yet begun to accelerate, the autonomous vehicle may hold at the current posted speed and decelerate, treating the ELV as if it is prior to the posted speed change regardless of the location of the ELV. In such a scenario, with an ELV around which an autonomous vehicle is passing and the posted speed limit is higher than where the autonomous vehicle was previously, when an autonomous vehicle has begun to accelerate, the autonomous vehicle may stop acceleration and reduce speed the required amount from that held speed. In some implementations, an autonomous vehicle may detect an ELV and use the lower bound speed limit in a table (e.g., Table 4, above) to decide how much to decelerate. For example, when an autonomous vehicle is at 67 mph because it is has recently moved into a 70 mph zone, but an ELV is detected, the autonomous vehicle may use the 65 mph speed limit to decelerate as it passes the ELV

IV.(o) State(2) Strategy—Speed Limit Decreases

If the ELV is within (2) and the speed limit is decreasing, autonomous vehicle deceleration may assure its deceleration profile achieves the required ELV crossing speed for the actual position of the ELV even if that speed dips below the upcoming posted speed.

Speed limit takes effect starting from the speed limit sign location.

IV.(p) State(3) Strategy-ELV in Speed Limit Change Area

If the ELV is within (3), autonomous vehicle may maintain the new crossing speed restriction.

IV.(q) ELV Merging In—Prediction

An autonomous vehicle may be able to predict when an ELV is trying to merge back into traffic. When an autonomous vehicle predicts that an ELV is trying to merge back into traffic, the autonomous vehicle may determine if the merging ELV will try to cut in front of or behind the autonomous vehicle based on the motion of the ELV.

For example, if the ELV has its turn signal engaged, has biased toward the direction of traffic, and is accelerating slightly, then an autonomous vehicle may determine that the ELV is likely trying to merge back into traffic. Conversely, if a garbage collector truck is in motion but does not bias toward traffic and does not turn its signals on, then an autonomous vehicle may determine that the ELV is likely not trying to merge back in.

IV.(r) Deceleration Levels and Timing

Autonomous vehicle may use a minimum required deceleration to achieve a predetermined travelling speed and distance by the time when the front bumper of autonomous vehicle is 3 meters before the rear bumper of the ELV (engine braking or engine braking levels (˜−1 m/s\hat{ }2) of deceleration is preferred). The predetermined travelling speed and distance may conform to behavior including that the autonomous vehicle may start to slow down and bias to maintain a safe speed and lateral distance no later than a predefined distance before reaching the ELV (e.g., 125 meters, 140 meters, or 152 meters (500 ft) before reaching the ELV).

IV.(s) ELV Memory

Autonomous vehicle may localize each ELV and store their location until autonomous vehicle has passed each respective ELV. This may be accomplished utilizing the data from the onboard sensor suite and the computing module or modules used to identify and track surrounding objects moment to moment.

IV.(t) Accelerating Near ELVs

When autonomous vehicle is approaching an ELV in an adjacent lane and is within a pre-determined distance (e.g., 125 meters, 140 meters, or 152 meters), the autonomous vehicle may not accelerate (even when the speed is slow) except for a lane change or evasive maneuver (e.g., to prevent an accident or hitting an pedestrian/cyclist). The autonomous vehicle may be able to start accelerating again when autonomous vehicle (or trailer)'s rear bumper is a certain distance (e.g., 2.5 meters, 3 meters, or 3.5 meters) beyond the front bumper of the ELV.

IV.(u) ELV Merging In—Behavior

The operation of an emergency lane vehicle (ELV) merging from a shoulder or other area adjacent to the main road into lanes of traffic may be complicated for an autonomous vehicle to participate in. The following are examples of behaviors an autonomous vehicle may exhibit or execute to increase the probability of a safe merge into traffic for a detected ELV.

In scenarios when an autonomous vehicle is driving in the lane adjacent to an ELV and the ELV is moving, the autonomous vehicle may preferentially change lanes in order to minimize interaction with the NPC. Lane changing may executed by the autonomous vehicle as follows. When encountering an ELV in an area that is directly adjacent to the current lane being traversed, the autonomous vehicle may change lanes away from the ELV in order to pass. Autonomous vehicle may aim to change lanes as soon as it detects the ELV and start to react no later than a pre-determined number of meters (e.g., 125 meters (m), 130 m, 140 m, 150 m, 152 m, 155 m or 160 m) before reaching the ELV.

When an autonomous vehicle is unable to pass with one full lane between itself and the moving ELV, the autonomous vehicle may slow down and move in its lane, that is bias in lane, to safely pass an ELV that is in motion. In such scenarios, the autonomous vehicle may start to slow down and bias to maintain a safe speed and lateral distance no later than a pre-determined distance before reaching the ELV, e.g., 125 meters, 140 meters, or 152 meters (500 ft) before reaching the ELV.

An autonomous vehicle may predict whether a moving ELV will cut in or not. Such a prediction may be based on perceived motions or indicators (e.g., turn signal usage, acceleration and motion towards traffic in active lanes of a highway or roadway, activation of sirens or other audio signals).

If the moving ELV is predicted to cut in, an autonomous vehicle may accept the cut in, otherwise the autonomous vehicle may pass the moving ELV. The decision to accept a cut in by a moving ELV or to pass such a vehicle may be made by an autonomous vehicle based on the distance to the ELV when the intent of the ELV is recognized, as well as the velocity, acceleration, and projected trajectory of the ELV, among other things. Such a decision may be governed by threshold distances which are kept between the autonomous vehicle and moving ELVs.

IV.(v) Stop and Wait for Close ELV

If the ELV is so close that there is a possibility that an autonomous vehicle may collide (also accounting for the uncertainty of trailer position, and our full bias within the lane), it is preferred that the autonomous vehicle not cross the ELV and may either fully change lanes or stop in the current lane (i.e., on its previous trajectory) with lane change signals on, awaiting an opportunity to change lane and cross safely.

IV.(w) ELV Merging In Liability

An autonomous vehicle may behave differently depending on the regulations in the jurisdiction through which the autonomous vehicle is passing. In some instances, laws may vary, including those regarding right of way between an autonomous vehicle and a manually operated or conventional vehicle in various instances. For example, according to Arizona law, an autonomous vehicle has the right of way when ELV is merging in. An autonomous vehicle may follow act to avoid accidents while also complying with local laws and regulations.

IV.(x) Do Not Lane Change Toward ELV

Autonomous vehicle may not lane change into a lane adjacent to an ELV, including an ELV previously identified in ELV Memory that is now occluded.

IV.(y) Critical ELV Definition

A critical ELV may be defined as an ELV that poses an elevated safety risk to both an autonomous vehicle and the ELV itself due to the condition, state or position of the ELV.

The following types of ELVs may be considered Critical ELV:
ELV with pedestrian(s) nearby
ELV emergency vehicle
ELV that is protruding into the driving lane
Moving ELV
ELV that is merging back into traffic
ELV with flashing lights (not hazard light)
Large vehicle ELVs (vehicle's length>=a pre-determined distance (e.g., 8 m, 9 m, 10 m)
All types of ELVs within a pre-determined distance (e.g., 1.25 m, 1.5 m, 1.75 m) from the driving lane.

IV.(z) Non-Critical ELV Definition

Non-critical ELV may be defined as an ELV that has a low probability of posing an imminent safety risk to both autonomous vehicle and the ELV itself.

ELV that is not safety critical and is more than a pre-determined threshold distance (e.g., 1.0 m, 1.25 m, 1.5 m, 1.75 m) but less than a pre-determined upper limit distance (e.g., 3.2 m, 3.4 m, 3.6 m, 3.8 m, 4.0 m) from the lane boundary may be considered Non-critical ELV.

IV.(aa) Regulatory ELV

Regulatory ELV may be defined as an ELV of legal concern that does not pose an imminent safety risk.

Any ELV that is not safety critical and is further than a pre-determined threshold distance (e.g., 3.4 m, 3.6 m, 3.8 m, 4.0 m) from the lane boundary may be classified under this category.

IV.(ab) Initial-Detection Lane Change

An autonomous vehicle travelling on a road that has more than 2 lanes may execute a lane change away from the left-most or right-most lanes as soon as the presence of an ELV is detected (assuming ELV position is unknown) as a precautionary measure. An initial detection of an ELV in which the ELV position is unknown may include any of: a detection based on audio cues (e.g., siren detection); the detection of flashing light patterns; and detection of the motions of traffic in front of the autonomous vehicle (e.g., traffic in lanes ahead are change lanes or biasing in a certain direction) and the like where the actual ELV vehicle is not perceived by characteristics or indicators of an ELV are detected or perceived by the autonomous vehicle.

IV.(ac) Center Lane Preference

An autonomous vehicle travelling on a road that has more than 2 lanes may avoid lane change to the outer or inner most lanes as soon as the presence of an ELV is detected (assuming ELV position is unknown) when the autonomous vehicle is not on the left-most or right-lane of the road.

IV.(ad) Wide Lane Merge Zone Description

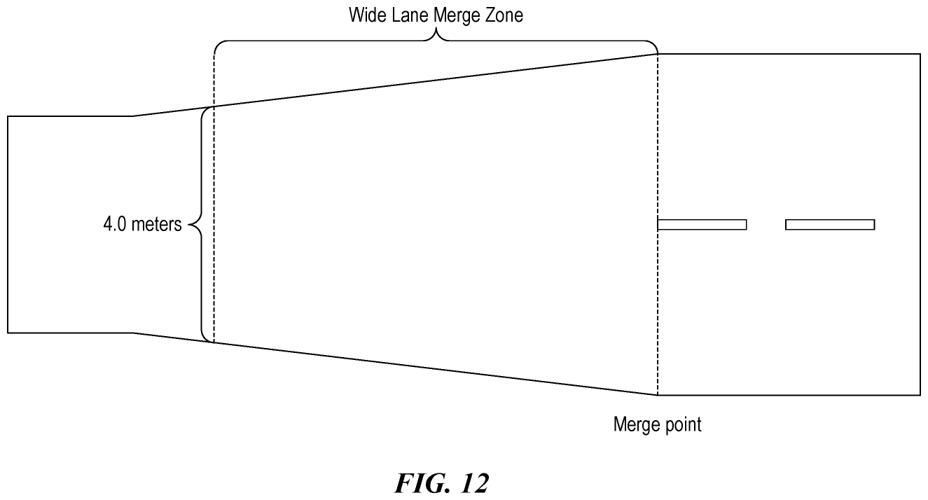

FIG. 12 shows an example of a wide lane merge zone. Wide lane merge zone may be defined as when two adjacent lanes are parallel, in the same direction, are separated by dashed lines, and merge into a single lane that's more than a predetermined width (e.g., more than 4 meters in width). The beginning of the zone may be defined as the merge point and the end point may be defined as when the merged single lane's width falls below a pre-determined distance, such as 3.75 m, 4 m. 4.25 m.

IV.(ae) Wide Lane Merge Zone Exception

When an ELV is present on the shoulder within the wide lanes and lane merge zone on a two-lane road merging into one lane, an autonomous vehicle may change lanes to the merge lane (i.e., the lane adjacent to the shoulder) and slow down and bias.

IV.(af) ELV Before Wide Lane Merge Zone

When the ELV is not within the Wide lanes and Wide lane merge zone (as described above), but is within a pre-determined number of meters (e.g., 75 m, 100 m, 125 m) before the merge point, an autonomous vehicle may prioritize lane changes only for critical ELVs (i.e., ELVs that pose a safety threat) if conditions allow. For Non-critical and regulatory ELVs (as defined herein above) not within a wide lane or the Wide lane merge zone, the autonomous vehicle may instead slow down and bias. For example, when both ELV and autonomous vehicle are in the lane that is not ending, the autonomous vehicle may only change lanes for critical ELVs. When both the ELV and the autonomous vehicle are in the lane that is ending, the autonomous vehicle may change lanes early to avoid the ELV. In situations where ELV is in the lane that is not ending and the autonomous vehicle is in the ending lane, the vehicle may change lanes to merge after passing the ELV. When an autonomous vehicle is in the lane that is not ending and ELV is in the ending lane, autonomous vehicle may keep to the same lane.

IV.(ag) ELV Near Planned Exit Route Exception

When approaching an exit on a planned route, an autonomous vehicle may keep to the exit lane for at least a pre-determined number of meters (e.g., 700 m, 800 m, 900 m) in order to avoid missing exits, autonomous vehicle may change lanes only for critical ELVs and slow down and bias for non-critical and regulatory ELVs in this zone.

If an exit is missed, an autonomous vehicle may MRC (i.e., perform a minimal risk condition maneuver such as pulling over out of the lanes of traffic, gradually come to a stop in its present lane, or come to an abrupt stop in its present lane) or the autonomous vehicle may take alternative route.

IV.(ah) Lane Change Decider—Lane Bias

If any part of an autonomous vehicle is predicted to be unable to laterally vacate half of autonomous vehicle's original lane on the ELV side through a lane change by the time autonomous vehicle has closed the longitudinal gap with the ELV, then autonomous vehicle may slow down and bias to the greatest extent (e.g., using Maximum Bias, extending the maximum bias past any lane lines as needed to avoid a collision) for all types of ELV to keep a lateral distance of at least a minimum number of meters (e.g., 2.5 m, 2.74 m, 3.0 m, 3.25) to the closest lateral point of the ELV instead of lane changing. The autonomous vehicle may end lane biasing after completely passing the ELV. An autonomous vehicle may act to avoid a collision with an ELV, or pedestrians surrounding the ELV, as its priority.

IV.(ai) Multi-Lane Merge Zone Lane Change

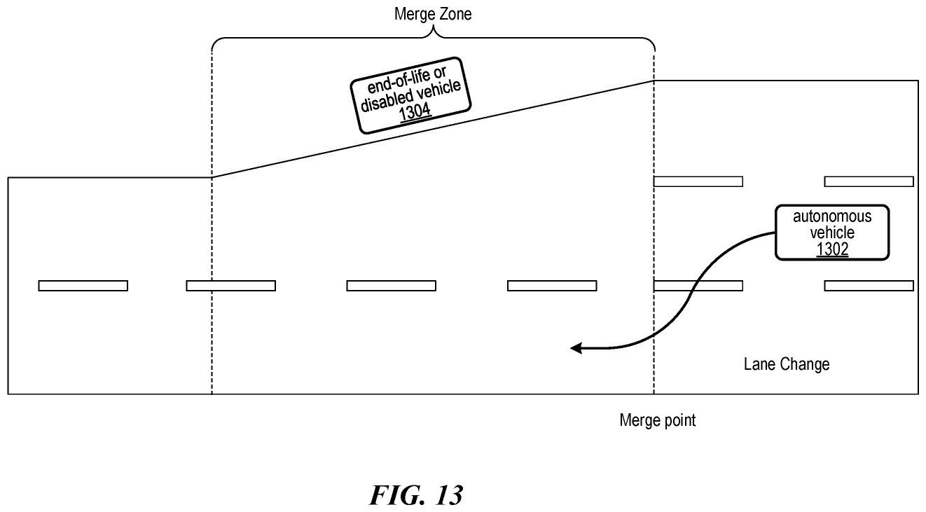

FIG. 13 shows an example scenario of driving operations performed by an autonomous vehicle 1302 that is traveling next to an ELV 1304. When the autonomous vehicle is traveling on a multi-lane road and is in a lane where an adjacent lane is merging into autonomous vehicle's lane, and an ELV is present on the shoulder within the lane merge zone, autonomous vehicle may execute lane change away from the direction of the ELV to the adjacent lane if the conditions allow and lane change is available.

When encountering an ELV in an area that is adjacent to the current lane being traversed and an autonomous vehicle is unable to change lanes to pass according to predetermined criteria, then autonomous vehicle may start to slow down and bias to maintain a safe speed and lateral distance no later than a pre-determined number of meters (e.g., 75 meters, 90 meters, 110 meters, 125 meters, 152 meters, 160 meters, 170 meters) before reaching the ELV. The predetermined criteria that may lead to the autonomous vehicle starting to slow down and bias may be as follows. The autonomous vehicle may aim to change lanes as soon as it detects the ELV and start to react no later than a pre-determined number of meters (e.g., 125 meters (m), 130 m, 140 m, 150 m, 152 m, 155 m or 160 m) before reaching the ELV.

In some scenarios, an autonomous vehicle may decelerate and move away from the center of its lane of current travel (i.e. bias) or it may simply bias in-lane. For example, an autonomous vehicle may slow down and bias may be used together except for onramp scenarios and scenarios in which the autonomous vehicle determines that the ELV is merging in and intends to cut behind, which only bias is used. In the scenario in which the autonomous vehicle determines that the ELV is merging in and intends to cut behind, the autonomous vehicle may maintain its current velocity or reduce it minimally (e.g., decelerate no more than 1 m/s\hat{ }2) so as to indicate that it will pass the ELV. An autonomous vehicle may slow down for emergency lane vehicle pedestrians (ELVP—persons near or surrounding an ELV), emergency lane emergency vehicles (ELEV), and ELV with flashing lights using the max passing speed from Table 5, below, or the minimum of (1) the value in the Table 5 below and (2) 5 mph less than the max passing speed in Table 4, above.

TABLE 5

| Lateral Distance | Recommended Highway | Recommended Local |
|---|---|---|
| to Pedestrian | Max Passing Speed | Max Passing Speed |
| 3.28 to 6 feet | min (45 mph, 5 mph less | min (25 mph, 5 mph less |
| | than speed limit) | than speed limit) |
| 6 to 9 feet | min (55 mph, 5 mph less | min (35 mph, 5 mph less |
| | than speed limit) | than speed limit) |
| 9 to 12 feet | min (65 mph, 5 mph less | min (45 mph, 5 mph less |
| | than speed limit) | than speed limit) |
| 12+ feet | No adjustment needed | No adjustment needed |

IV.(aj) ELV Near Speed Limit Change Area

When encountering an ELV in the speed limit change area, autonomous vehicle may follow the strategies below according to autonomous vehicle state:
1) autonomous vehicle is accelerating
2) autonomous vehicle is decelerating

The new speed limit takes effect at the point of the speed limit sign.

IV.(ak) Autonomous Vehicle Accelerating Near ELV Behavior

With the exception of when autonomous vehicle is passing an ELV is at an on ramp section, if autonomous vehicle is accelerating due to a speed limit increase may cease accelerating when ELV is within a pre-determined number of meters (e.g., 75 meters, 90 meters, 110 meters, 125 meters, 152 meters, 160 meters, 170 meters) of autonomous vehicle and pass the ELV at a speed no more than the max passing speed for the section of road that the centroid of the ELV is in.

At the point of ceasing acceleration, if autonomous vehicle is faster than the max passing speed, autonomous vehicle may slow down, if autonomous vehicle is slow than the max passing speed, autonomous vehicle may maintain constant speed.

IV.(al) Acceleration Cessation Zone

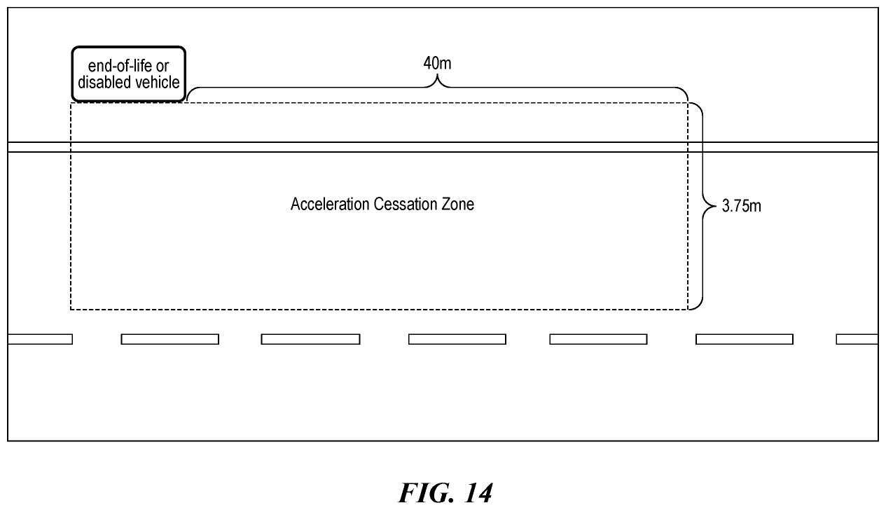

FIG. 14 shows an example acceleration cessation zone that may be adjacent to a location of an end-of-life vehicle or disabled vehicle. With the exception when autonomous vehicle is at the on ramp section, in a traffic jam or accelerating to change lanes, autonomous vehicle may cease accelerating and maintain a constant speed when any part of autonomous vehicle is within the acceleration cessation zone as defined by a box extending longitudinally from the farthest most point of the ELV to a pre-determined distance (e.g., 30 m, 35 m, 40 m, 45 m, 50 m) from the closest point of the ELV and laterally from the closest point of the ELV to a pre-determined distance (3 m, 3.25 m, 3.5 m, 3.75 m, 4.0 m) towards autonomous vehicle's lane.

IV.(am) ELV Near Single Lane Onramp Exception

If an ELV is present at a single lane onramp and autonomous vehicle is accelerating to merge onto the highway, autonomous vehicle may Lane Bias and cease acceleration when passing the ELV at a speed that autonomous vehicle is able to merge safely.

When deciding the speed to pass the ELV, autonomous vehicle may take into account the distance between the ELV and merge point and autonomous vehicle's maximum possible acceleration within this distance (assumed max acceleration of any of 0.35 m/s\hat{ }2, 0.4 m/s\hat{ }2, 0.5 m/s\hat{ }2, 0.5 m/s\hat{ }2).

IV.(an) Acceleration Resumption

An autonomous vehicle may resume accelerating after the autonomous vehicle's rear most point has passed the ELV's front most point.

IV.(ao) ELV Near Multi Lane Onramp Exception

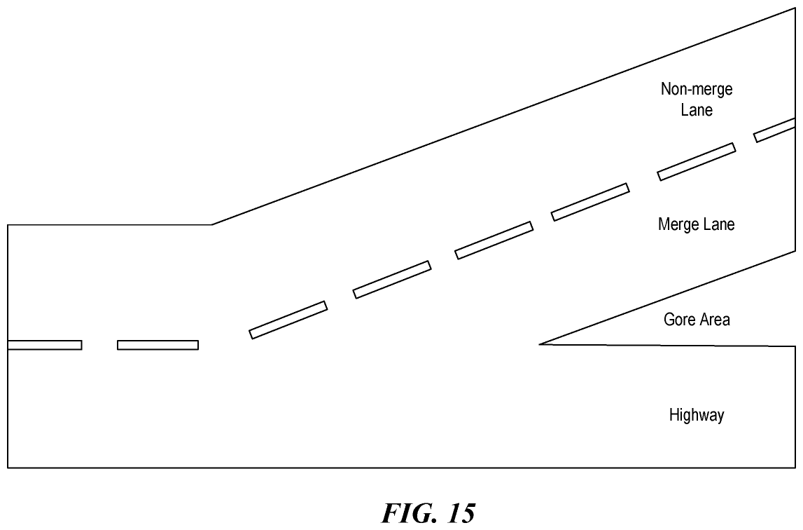

FIG. 15 shows example driving related operations performed by an autonomous vehicle operating on a multi lane onramp on a highway. When the autonomous vehicle encounters an ELV on a multi-lane onramp, the autonomous vehicle may avoid being in the adjacent lane of the ELV only if it does not impede autonomous vehicle from merging into the highway traffic.

For example, when an ELV is present on the merge lane of the onramp and an autonomous vehicle is on the merge lane, the autonomous vehicle may keep to the merge lane and bias for the ELV. When an ELV is present on the merge lane of the onramp and autonomous vehicle is on the non-merge lane, autonomous vehicle may keep to the same lane and only change lanes to merge after passing the ELV. When an ELV is present on the non-merge lane of the onramp and autonomous vehicle is accelerating to merge onto the highway, autonomous vehicle may prioritize lane change away from the ELV to the merge lane in order to pass and merge safely. When deciding the speed to use to pass the ELV, an autonomous vehicle may take into account the distance between the ELV and the merge point, as well as the maximum possible acceleration within this distance for the autonomous vehicle (assuming a predetermined max acceleration, e.g., 0.3 m/s\hat{ }2, 0.4 m/s\hat{ }2, 0.5 m/s\hat{ }2, 0.6 m/s\hat{ }2).

IV.(Ap) Autonomous Vehicle Decelerating Near ELV Behavior

When an autonomous vehicle is decelerating due to an anticipated speed limit decrease and an ELV detected, the autonomous vehicle may continue deceleration and aim to pass the ELV with a speed no more than the max passing speed as stipulated in Table 4 (above) for the section of the road which the ELV is on.

IV.(aq) Deceleration Timing

An autonomous vehicle may achieve the targeted Slow Down and Bias Strategy before the front bumper of autonomous vehicle passes the longitudinally (with respect to autonomous vehicle) closest point of the ELV. The targeted slow down and bias strategy may be as follows. The autonomous vehicle may aim to change lanes as soon as it detects the ELV and start to react no later than a pre-determined number of meters (e.g., 125 meters (m), 130 m, 140 m, 150 m, 152 m, 155 m or 160 m) before reaching the ELV.

IV.(ar) Lane Bias Level

When biasing for an ELV, autonomous vehicle may execute Critical Safety Bias for Critical ELV and Non-critical Safety Bias for Non-critical and Regulatory ELV. A Critical Safety Bias may be defined as follows. When bias is available for situations with an immediate safety concern, an autonomous vehicle may bias the maximum amount away from the hazard with a relaxation of lane boundaries if needed, such that maximum bias is extended past any lane lines as needed to avoid a collision. A Non-critical Safety Bias may be defined as biasing the maximum amount away from a hazard without a relaxation of lane boundaries.

IV.(as) Governed Speed Slow Down

If autonomous vehicle is traveling at a governed speed that is lower than the maximum passing speed for that section of the road, autonomous vehicle may slow down at least 5 mph from the governed speed when executing slow down to show slow down intention.

IV.(at) ELV Close to Driving Lane

When encountering an ELV that is within a pre-determined number of meters (laterally) (e.g., 1.0 m, 1.3 m, 1.5 m, 1.75 m) of autonomous vehicle autonomous vehicle may do a full lane change or lane bias to maintain at least a pre-determined lateral distance (e.g, 1.0 m, 1.2 m, 1.3 m, 1.4 m, 1.5 m) from the ELV. It is allowable for autonomous vehicle to cross lane boundaries listed below to perform a full lane change or avoid an accident in this scenario.

For example, in Arizona, autonomous vehicle may cross these lines to avoid an ELV: dotted white lines, dotted yellow lines, solid white lines. An autonomous vehicle may only cross the following lines to avoid a collision: solid yellow lines, and double solid white lines.

IV.(au) Stop and Wait for Close ELV

If the ELV is predicted to be unable to maintain a minimum critical distance of 0.5 m to the ELV at the closest point of approach, autonomous vehicle may not cross the ELV and may either fully change lanes or stop with lane change signals on, awaiting an opportunity to change lane and cross safely.

IV.(av) NPC Transitioning to an ELV—Behavior

If a vehicle is transitioning to an ELV and autonomous vehicle is adjacent to the emergency lane, autonomous vehicle may lane change away from the current lane.

IV.(aw) NPC Transitioning to an ELV—Lane Bias

If autonomous vehicle is following the transitioning ELV on the shoulder's adjacent lane and is unable to change lanes, autonomous vehicle may slow down and maintain the preferred following distance with the transitioning ELV, autonomous vehicle may pass the transitioning ELV using the slow down and bias strategy only after it has completely pulled out of autonomous vehicle's lane.

IV.(ax) ELV Merging In—Behavior

When an autonomous vehicle is driving in the lane adjacent to an ELV where the ELV is moving, the autonomous vehicle may follow the lane change priority of Lane Change Intention Priority Model to change lanes in order to minimize interaction with the moving ELV (i.e., vehicle transitioning to becoming a NPC). The Lane Change Intention Priority Model is as follows:
Lane change intentions are based on safety, regulatory, and efficiency concerns, unless otherwise specified. More specifically, the priority order shall be as follows (from highest priority to lowest priority):
1. Critical safety—hazard present that is an immediate threat to the safety of the autonomous vehicle
2. Non-critical safety—hazard present
3. Regulatory—situations in which legal authority or regulations may dictate behavior of a vehicle, including an autonomous vehicle
4. Efficiency
5. Precautionary
6. Preference

If autonomous vehicle is unable to pass with one full lane between itself and the moving ELV, autonomous vehicle may respond to the merging ELV based on Cut Infront and Cut Behind requirements (as described herein below) depending on if the merging ELV is predicted to cut infront or cut behind autonomous vehicle respectively.

IV.(ay) ELV Merging In—Cut Infront

When a moving ELV is predicted to cut in front of an autonomous vehicle, the autonomous vehicle may accept the cut in, and maintain preferred following distance with NPC after cut in. A cut-in vehicle may be defined as a vehicle that changes partially or completely into an autonomous vehicle's lane of travel within a minimum gap distance. The minimum gap distance may be defined as the gap (i.e., the distance between the rear of the vehicle ahead and the front end of the autonomous vehicle) that ensures the critical stopped distance is maintained in the event that the vehicle in front of the autonomous vehicle (in this case the cutting in ELV) immediately brakes and comes to a complete stop. The minimum gap may be based on the most conservative distance taking into account the autonomous system's reaction time, the brake system's reaction time, the system's maximum available deceleration, the maximum possible deceleration characteristics of the leading vehicle based on type (assume the worst case scenario for type of vehicle, load, etc.), and the speed of autonomous vehicle and the leading vehicle. The critical stopped distance may be defined as a distance needed to avoid a collision between an autonomous vehicle and a vehicle surrounding it when the autonomous vehicle comes to an abrupt stop.

IV.(az) ELV Merging In—Cut Behind

When the moving ELV is predicted to cut in behind, autonomous vehicle may bias and pass the ELV. Unless safety critical, autonomous vehicle may not decelerate more than a threshold velocity (e.g., 0.8 m/s\hat{ }2, 1 m/s\hat{ }2, 1.5 m/s\hat{ }2) before and during passing to signal intent of passing. Biasing and passing the ELV may include the autonomous vehicle starting to slow down and bias to maintain a safe speed and lateral distance no later than a predetermined distance before reaching the ELV (e.g., such as 125 meters, 140 meters, or 152 meters (500 ft) before reaching the ELV).

IV.(ba) ELV Memory

Autonomous vehicle may localize each ELV and store their location until autonomous vehicle has passed each respective ELV.

IV.(bb) Do Not Lane Change Toward ELV

Autonomous vehicle may avoid lane change into a lane adjacent to an ELV, including an ELV previously identified in ELV Memory that is now occluded.

IV.(bc) Late Detection of ELVs

If the ELV was occluded from autonomous vehicle's view or detected late (e.g. high curvature area, gore area), and the system is unable to meet the reaction distance requirements to safely change lanes or slow down and bias (e.g., start to slow down and bias to maintain a safe speed and lateral distance no later than a predetermined distance before reaching the ELV (e.g., such as 125 meters, 140 meters, or 152 meters (500 ft) before reaching the ELV), the system may determine if autonomous vehicle may lane change or lane bias based on the following criteria. If any part of the autonomous vehicle is predicted to be unable to laterally vacate half of the autonomous vehicle's original lane on the ELV side through a lane change by the time the autonomous vehicle has closed the longitudinal gap with the ELV, then the autonomous vehicle may slow down and bias, extending the maximum bias past any lane lines as needed to avoid a collision, for all types of ELV to keep a predetermined lateral distance (e.g., at least 2 m, at least 2.5 m, at least 2.74 m (9 ft)) to the closest lateral point of the ELV instead of lane changing. The autonomous vehicle may end lane biasing after completely passing the ELV.

IV.(bd) Consecutive ELVs in a Group

An autonomous vehicle may treat multiple consecutive ELVs in the same lane that are within a pre-determined number of meters (e.g., 20 m, 25, 30 m, 35 m, 40 m) between their closest points from each other as a group and respond to them based on the ELV of the highest criticality in the group. Criticality of an ELV may correlate to the hazard posed by any given ELV to the autonomous vehicle.

IV.(be) Lane Straddling

When an autonomous vehicle is on a 2 lane highway and there are ELVs on both sides of the road within a predetermined amount of curvature corrected longitudinal distance (e.g., 100 m, 125 m, 150 m, 175 m) of each other and lane straddle is available, the autonomous vehicle may react no later than a pre-determined number of meters (e.g., 100 m, 125 m, 152 m, 175 m, 200 m) from the nearest ELV and lane straddle between the 2 lanes to maintain lateral equidistant between the ELVs.

IV.(bf) Lane Straddling Description

Lane straddling may be defined to be when autonomous vehicle is positioned over lane lines rather than between them and occupying more than one lane.

IV.(bg) Lane Straddling Behavior

An autonomous vehicle may slow down when lane straddling and switch on hazard lights. Once the autonomous vehicle has passed the last ELV in a group, the autonomous vehicle may return to the original lane that autonomous vehicle was travelling on before the start of the lane straddle.

IV.(bh) Land Straddle Availability

Lane straddle may be defined as available when the condition described below are satisfied:

Autonomous vehicle is able maintain a bumper-to-bumper gap of a predetermined amount (e.g., at least 10 meters, at least 15 meters, at least 17 meters, at least 20 meters) with the front vehicle of both lanes that autonomous vehicle is intending to straddle.

The lane that autonomous vehicle is encroaching into has no targets behind autonomous vehicle that has a bumper-to-bumper gap to autonomous vehicle of less than 12 meters and a time-to-collision of less than 7 seconds.

IV.(bi) Hazard Light Usage

An autonomous vehicle may activate hazard light when autonomous vehicle starts to lane straddle and may keep the hazard light on until autonomous vehicle has completely returned autonomous vehicle's original lane of travel.

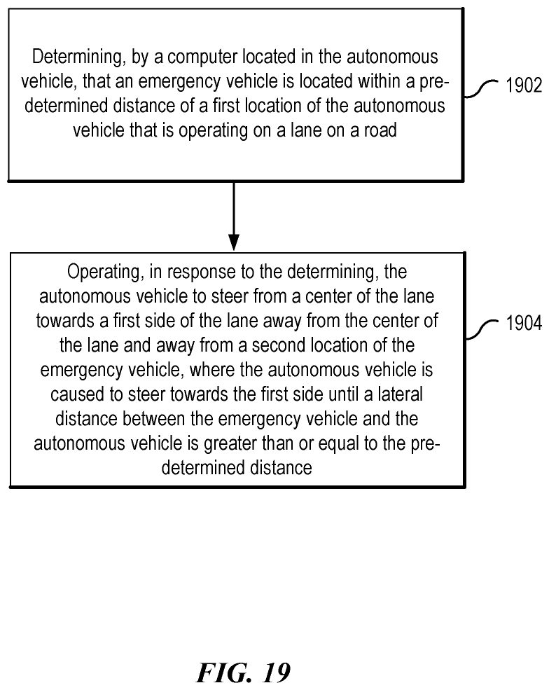

FIG. 19 shows an example flowchart of an autonomous driving operation performed by a vehicle to operate on a road with an emergency vehicle. Operation 1902 includes determining, by a computer located in the autonomous vehicle, that an emergency vehicle is located within a pre-determined distance of a first location of the autonomous vehicle that is operating on a lane on a road. Operation 1904 includes operating, in response to the determining, the autonomous vehicle to steer from a center of the lane towards a first side of the lane away from the center of the lane and away from a second location of the emergency vehicle, where the autonomous vehicle is caused to steer towards the first side until a lateral distance between the emergency vehicle and the autonomous vehicle is greater than or equal to the pre-determined distance. In some embodiments, the operating the autonomous vehicle to steer from the center of the lane as explained in operation 1904 includes sending instructions to one or more devices (e.g., one or more motors) in a steering system of the autonomous vehicle to steer the autonomous vehicle.

In some embodiments, the autonomous vehicle is caused to steer towards the first side of the lane and onto a second lane immediately adjacent to the lane in response to determining that a line that separates the lane and the second lane includes dotted white lines, dotted yellow lines, or solid white lines. In some embodiments, the method further comprises in response to determining that the emergency vehicle is located within the pre-determined distance of the first location of the autonomous vehicle and in response to determining that a lane change operation by the autonomous vehicle is not possible: sending instructions that causes the autonomous vehicle to apply brakes or slow down the autonomous vehicle to a speed that is less than a threshold speed value.

In some embodiments, the threshold speed value is based on a rule of an area or a state or a region in which the autonomous vehicle is located. In some embodiments, the threshold value is based on a speed limit of the first location where the autonomous vehicle is operating and the lateral distance between the emergency vehicle and the autonomous vehicle. In some embodiments, the autonomous vehicle operates to steer from the center of the lane towards the first side of the lane, and the autonomous vehicle is caused to apply brakes or slow down the autonomous vehicle to a speed that is less than a threshold speed value in response to: determining that the emergency vehicle is operating on another lane that is immediately adjacent to the lane on which the autonomous vehicle is operating; and determining that a lane change operation by the autonomous vehicle is not possible. In some embodiments, the method further comprises operating the autonomous vehicle to accelerate only for changing lanes or for performing an evasive maneuver in response to determining that the emergency vehicle is approaching the autonomous vehicle and that the emergency vehicle is operating on another lane that is immediately adjacent to the lane on which the autonomous vehicle is operating.

In some embodiments, a system further comprises sensor subsystems comprising cameras, a temperature sensor, an inertial sensor (IMU), a global positioning system, a light sensor, a LIDAR system, a radar system, and wireless communications, and wherein the computer located in the autonomous vehicle is configured to utilize data from any of the sensor subsystems to perform the determining and the operating. In some embodiments, a system further comprises a vehicle control subsystem in operable communication with the computer located in the autonomous vehicle, wherein the processor is configured to communicate with the vehicle control subsystem to perform the method that causes the autonomous vehicle to steer from the center of the lane towards the first side of the lane, and that causes the autonomous vehicle to apply brakes or slow down the autonomous vehicle to a speed that is less than a threshold speed value in response to: determining that the emergency vehicle is operating on another lane that is immediately adjacent to the lane on which the autonomous vehicle is operating; and determining that a lane change operation by the autonomous vehicle is not possible. In some embodiments, a system further comprises a vehicle control subsystem operably connected to the computer located in the autonomous vehicle, wherein the processor is configured to perform the method that further comprises: operating the autonomous vehicle via the vehicle control system to accelerate only for changing lanes or for performing an evasive maneuver in response to determining that the emergency vehicle is approaching the autonomous vehicle and that the emergency vehicle is operating on another lane that is immediately adjacent to the lane on which the autonomous vehicle is operating.

In some embodiments, the threshold speed value is based on: a rule of an area or a state or a region in which the autonomous vehicle is located; and on a speed limit of the first location where the autonomous vehicle is operating and the lateral distance between the emergency vehicle and the autonomous vehicle. In some embodiments, the method further comprises for an emergency vehicle that is transitioning into an emergency lane vehicle, the autonomous vehicle changes lanes away from a lane adjacent to the emergency lane; and slowing and matching, by the autonomous vehicle, the speed of an emergency vehicle that is transitioning into an emergency lane vehicle until the emergency vehicle pulls out of a current lane of travel of the autonomous vehicle. In some embodiments, the autonomous vehicle identifies an emergency vehicle as transitioning to an emergency lane vehicle using on-board sensors to detect any of: use of a turn signal by an emergency vehicle indicating a direction toward a shoulder; a change in bias or trajectory of the emergency vehicle; activation of flashing lights indicative of an emergency vehicle, a rescue vehicle, or a law enforcement vehicle; a change in velocity of the emergency vehicle; and a direct communication from the emergency vehicle to the autonomous vehicle indicating an intent of the emergency vehicle to move to the emergency lane or shoulder.

### V. Lane Bias

An autonomous truck may be able to bias its location in the lane properly. A technique for biasing the autonomous vehicle may include moving the autonomous vehicle from center of a lane closer to a right or left edge of the lane in which the autonomous vehicle is travelling. A technical benefit of lane bias related operations is that it can improve safety or comply with applicable regulations where the autonomous vehicle may need to move from the center of the lane.

Appropriate utilization and execution of lane bias related techniques by an autonomous vehicle may be performed by the compliance module (shown as 166 in FIG. 1) and may include: identification of an opportunity to bias in-lane; definitions of lane biasing based on applicable regulations; identification and abiding by maximum allowable biasing in-lane; identification of bias timing, including when to start and when to stop biasing; identification of bias triggering conditions, such as the presence of a vehicle or encroaching object located predominately in an adjacent lane; and/or the like.

V.(a) When to End Biasing

When biasing due to another vehicle, autonomous vehicle may cease biasing when autonomous vehicle has passed or been passed by a non-player character vehicle (NPC) and is a lateral distance of a pre-determined value (e.g., 10 meters) away bumper to bumper.

When autonomous vehicle is doing the passing, autonomous vehicle may measure from the front bumper of the NPC to the rear bumper of autonomous vehicle

When autonomous vehicle is being passed, autonomous vehicle may measure from the front bumper of autonomous vehicle to the rear bumper of the NPC.

V.(b) Non-Critical Safety Bias

When bias is available for situations with a non-immediate safety concern, autonomous vehicle may bias the maximum amount away from the hazard without a relaxation of lane boundaries as defined in Maximum Bias Within Lane Description.

This requirement may apply to the following situations:

1. When driving parallel to an emergency lane vehicle (ELV) without a pedestrian (and we cannot lane change or are in the process of changing lanes)

V.(c) Critical Safety Bias

When bias is available for situations with an immediate safety concern, an autonomous vehicle may bias the maximum amount away from the hazard with a relaxation of lane boundaries, if needed, in order to avoid collision.

This requirement may apply to the following situations:
1. When driving parallel to a non-compliant vehicle (and the autonomous vehicle cannot lane change or are in the process of changing lanes).
2. When driving parallel to an oversized vehicle.
3. When driving parallel to a large vehicle on a curved road.
4. When driving parallel to a large vehicle in a narrow lane.
5. When driving parallel to an ELV with a pedestrian (and the autonomous vehicle cannot lane change or are in the process of changing lanes).

The preferred behavior in the above situations may be to do a different maneuver (such as lane change). Biasing would only apply when a lane change (or other preferred behavior) cannot be performed or while the autonomous vehicle is in the process of performing the behavior.

V.(d) Bias Level

Autonomous vehicle may define biasing thresholds based on the level of bias required.

Standard Bias: Standard bias may be defined as a bias that places an autonomous vehicle's widest point at a lateral distance of a pre-determined number of meters from the closest edge of the lane boundary. This may only apply to lanes with standard width (3.66 meters or 12 feet). For reference, in a standard width lane, a perfectly centered autonomous vehicle has 0.51 meters (1 foot 8 inches) of clearance from the widest point of autonomous vehicle to the nearest lane boundary. If using the center of the lane as the point of reference, this requirement indicates a planned deviation from the center of a number less than the pre-determined number of meters.

Maximum Bias Within Lane Description: The maximum bias within a lane may be defined as the maximum possible bias, given the width of the current lane, such that autonomous vehicle's widest point is at the nearest edge of the lane boundary.

V.(e) Bias Strategy when Bias is not Available

Autonomous vehicle may bias half of the distance required in the bias level chosen without crossing lane boundaries, and may leave this relative position by adjusting speed, when bias is not available in any of the following situations:
When driving parallel to a non-compliant semi-truck.
When driving parallel to an oversized vehicle.
When biasing for a pedestrian.

In some embodiments, for other bias situations, autonomous vehicle may not bias when bias is not available, unless avoiding a collision. In some embodiments, for other bias situations, autonomous vehicle may bias only when bias is available, unless avoiding a collision.

Optionally, an autonomous vehicle may bias more than half the amount as needed to avoid a collision. For example, an autonomous vehicle may bias half the max amount when there are semi-trucks driving parallel on each side of the autonomous vehicle and one of the semi-trucks is non-compliant.

V.(e) Maximum Bias—Relaxing Lane Boundary Condition

When there is an immediate safety concern, an autonomous vehicle may consider extending the maximum bias past any lane lines as needed to avoid a collision. The autonomous vehicle may minimize the extension of the maximum bias such that the collision is still avoided. The max bias may not put autonomous vehicle at risk of hitting a hard shoulder, hitting a pedestrian, getting into a liable accident, running over significant road debris, or running over unknown objects. The autonomous vehicle may only extend past lane lines if it is not at risk of getting into a liable accident, hitting a hard shoulder, hitting a pedestrian, running over road debris, or hitting other objects.

V.(f) Biasing when Vehicles on Both Sides

Referring to a timeline during which an autonomous vehicle may bias for a vehicle (defined by when to start biasing and when to end biasing) as the biasing period. When there are parallel vehicles on each side of the autonomous vehicle with overlapping biasing periods in the presence of a non-compliant swerving vehicle, the autonomous vehicle may bias half of the distance required in the bias level chosen and may leave this relative position as soon as possible by adjusting speed. If vehicles on both sides of the autonomous vehicle are swerving non-compliant or both vehicles are compliant, then the autonomous vehicle may avoid bias and may leave this relative position by its adjusting speed.

V.(g) Efficiency Bias

In an act of efficiency, when a biasing maneuver is available for situations where there is not a large safety concern an autonomous vehicle may bias as a precaution, autonomous vehicle may bias the standard amount, that is an amount that places an autonomous vehicle's widest point at a predetermined lateral distance (e.g., 0.2 meters, 0.25 meters, 0.28 meters (˜11 inches), 0.3 meters) from the closest edge of the lane boundary. This may only apply to lanes with a standard width (3.66 meters or 12 feet). This requirement may apply when driving parallel to a compliant semi-truck on a non-curved lane of standard width (3.66 meters or 12 feet).

V.(h) Bias Available

An autonomous vehicle may define bias as an available maneuver based on the level of the bias intention. The autonomous vehicle may preferably define bias as available if:
Autonomous vehicle is in an outer lane and there is no hard shoulder.
Autonomous vehicle is in an outer lane and there are no cars merging onto the highway at that point.
Autonomous vehicle is in an outer lane and there is no upcoming ELV.
Autonomous vehicle is in an outer lane and there are no upcoming unknown objects or road debris on the shoulder.
Autonomous vehicle is in a middle lane biasing beyond the lane boundaries, the lane change gap requirements are satisfied in the direction of the planned bias.
Autonomous vehicle is in a middle lane biasing within the lane boundaries, there are parallel NPCs on both sides (limited bias available).

A critical safety bias may adhere to the lane change gap requirements of a critical safety lane change intention.

V.(i) Maximum Bias Within Lane Description

The maximum bias within a lane may be defined as the maximum possible bias, given the width of the current lane, such that autonomous vehicle's widest point is at the nearest edge of the lane boundary. A perfectly centered autonomous vehicle the max bias within a lane for a non-curved standard width lane (3.66 m or 12 ft) is 0.51 meters (1 foot 8 inches).

V.(j) Description of Bias Available

An autonomous vehicle may define bias as available if:
Autonomous vehicle is in an outer lane and there is no hard shoulder.
Autonomous vehicle is in an outer lane and there are no cars merging onto the highway at that point.
Autonomous vehicle is in an outer lane and there is no upcoming ELV.
Autonomous vehicle is in a middle lane biasing beyond the lane boundaries, the lane change gap requirements are satisfied in the direction of the planned bias.
Autonomous vehicle is in a middle lane biasing within the lane boundaries, there are parallel NPCs on both sides (limited bias available).

A critical safety bias may adhere to the lane change gap requirements of a critical safety lane change intention. A critical safety intention may be defined as an intention where the lane change should be done because of an immediate safety concern. The following lane change intentions may be classified under this category: intending to change lanes a predetermined distance (e.g., 75 meters, 100 meters, 125 meters, 150 meters) from the merge point of a merge area where the autonomous vehicle's trajectory is predicted to intersect with the trajectory of a merging vehicle; intending to change lanes due to a moving ELV, ELVP (i.e., a pedestrian surrounding an emergency lane vehicle), an emergency vehicle, a flashing light vehicle, an abnormal stopped vehicle, or an ELV that is protruding into the autonomous vehicle's lane; intending to change lanes to avoid a harsh trajectory with a current acceleration<=−3 m/s\hat{ }2 or a future intended acceleration<=−2 m/s\hat{ }2; intending to change lanes to ensure that the autonomous vehicle does not miss the intended exit that is within a predetermined distance (e.g., 600 meters, 800 meters (˜½ mile), 1000 meters, 1600 meters (˜1 mile)); intending to change lanes because staying in the current lane traversed by the autonomous vehicle would result in an unplanned exit from the highway in less than a predetermined distance (e.g., 600 meters, 800 meters (˜½ mile), 1000 meters, 1600 meters (˜1 mile)); intending to change lanes due to a height clearance restriction where the autonomous vehicle is too tall, such an area may be this should be classified as a No Commercial Vehicle zone.

V.(k) When to Start Biasing

An autonomous vehicle may calculate when to start biasing based on the perceived location of surrounding vehicles. When bias is necessary due to another vehicle, autonomous vehicle may begin biasing when it is a predetermined lateral distance (e.g., 8 meters, 10 meters, 12 meters) away (or less) bumper to bumper. When approaching a vehicle from behind, autonomous vehicle may measure from the front bumper of autonomous vehicle to the rear bumper of the NPC (i.e., the other vehicle).

When being approached, autonomous vehicle may measure from the front bumper of the NPC to the rear bumper of autonomous vehicle.

V.(l) Audio Notifications when Biasing

The system may have an audio and human machine interface (HMI) notification whenever autonomous vehicle is planned to start biasing, except for Efficiency Biases (e.g., voluntary biasing maneuvers), where autonomous vehicle may only have an HMI notification. In this patent document, an example of HMI notification may include displaying a message on a display located in the autonomous vehicle.

Autonomous vehicle may only have 1 audio (if applicable) and 1 HMI notification per instance of planned bias. Additionally, the notification HMI of a biasing maneuver may be repeated until acknowledged by a human, such as a human safety driver or test engineer.

V.(m) Standard Bias Description

Standard bias may be defined as a bias that places autonomous vehicle's widest point at a lateral distance of 0.36 meters (1 foot 2 inches) from the closest edge of the lane boundary. This may only apply to lanes with standard width (3.66 meters or 12 feet).

For reference, in a standard width lane, a perfectly centered autonomous vehicle has 0.51 meters (1 foot 8 inches) of clearance from the widest point of autonomous vehicle to the nearest lane boundary.

V.(n) Bias Priority Model

An autonomous vehicle may prioritize and react to lane bias scenarios based on safety, regulatory, and efficiency concerns.

V.(o) Bias Timing

When bias is necessary, autonomous vehicle may begin biasing before arriving at the vehicle or object and may end biasing after autonomous vehicle is a safe distance passed the vehicle or object.

V.(p) End Biasing—Return Cautiously When Vehicles Nearby

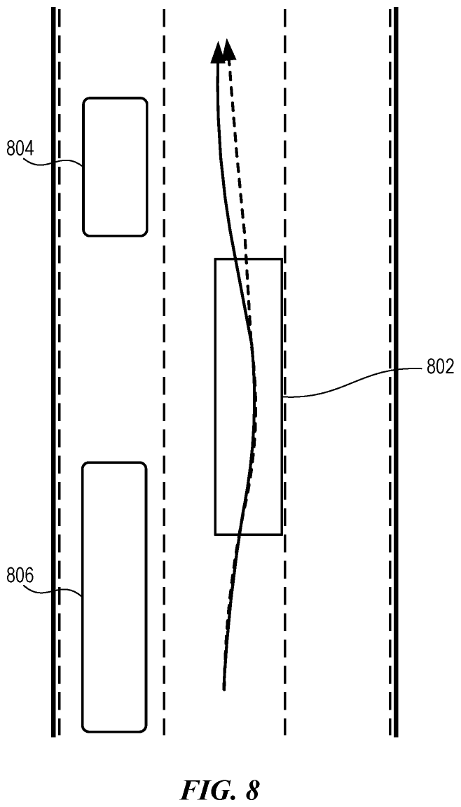

FIG. 8 shows an example scenario where an autonomous vehicle 802 returns to a center of a lane after performing lane bias operation when one or more vehicles 804, 806 are located in another lane adjacent to the lane on which the autonomous vehicle 802 is operating.

If autonomous vehicle is returning to the center of the lane after a planned bias and there are vehicles or other objects nearby in the planned direction of lateral movement, autonomous vehicle may preferably converge to the center of the lane at a slower rate (e.g., using a trajectory indicated by the dashed line with an arrow) than when there are no vehicles or objects in the direction of lateral movement (e.g., using a trajectory indicated by the solid line with arrow), unless a faster rate is needed for obstacle/collision avoidance. The solid line with arrow indicates a faster rate of return to a center of the lane compared to the dashed line with arrow that that indicates a more cautious (or slower) return to center compared to the solid arrow line.

V.(q) Bias Level Prioritization—Local Road Lane Bias

An autonomous vehicle may define the amount of bias by prioritizing the bias level available over the bias level required.

V.(r) Bias Level Available—Local Road Lane Bias

The bias level available may be determined by the type of local road that autonomous vehicle is in and the locations of NPCs (e.g., other surrounding vehicles that the autonomous vehicle interacts with) in that section of the road.

Single Lane One-Way—Within Lane:

If sidewalks or barriers are on the side of the road, autonomous vehicle may only be allowed to execute Maximum Bias Within Lane (e.g., that is to allow the biasing maneuver to reach lane lines without crossing the lane lines to avoid a collision) and keep at least a pre-determined amount of lateral distance between the outermost point of autonomous vehicle to the outermost edge of the sidewalks or barriers.

Two-Way Road with Reversible Lane:

An autonomous vehicle may be allowed to execute Maximum Bias—Relaxing Lane Boundary Condition (e.g., that is to allow the biasing maneuver to extend beyond lane lines to avoid a collision) up to half of the lane width onto the reversible lane is on provided the reversible lane does not have an NPC within a pre-determined number of seconds of time-to-crash (TTC) to the autonomous vehicle at the expected time of autonomous vehicle's complete departure from the reversible lane.

Two-Way Road without Divider:

An autonomous vehicle may be allowed to execute Maximum Bias—Relaxing Lane Boundary Condition (e.g., that is to allow the biasing maneuver to extend beyond lane lines to avoid a collision) up to a pre-determined distance into the opposite lane provided that the opposite lane does not have an NPC within a pre-determined amount of time of TTC to autonomous vehicle at the expect time of autonomous vehicle's complete departure from the opposite lane.

Multi Lane:

Autonomous vehicle may be allowed to execute Maximum Bias—Relaxing Lane Boundary Condition (e.g., that is to allow the biasing maneuver to extend beyond lane lines to avoid a collision) up to half of the lane width on an adjacent lane that is in the same direction of travel provided that the lane is clear.

Bicycle Lane:

Autonomous vehicle may be allowed to execute Maximum Bias—Relaxing Lane Boundary Condition (e.g., that is to allow the biasing maneuver to extend beyond lane lines to avoid a collision) of up to a pre-determined distance into the bicycle lane provided that there are no NPCs in the bicycle lane within a curvature corrected longitudinal distance of a pre-determined number of meters (e.g., 100 m, 125 m, 150 m, 175 m) from autonomous vehicle.

V.(s) Bias Level Required

Autonomous vehicle may define a bias distance based on the distance to NPC and the condition of the Lane.

Passing Scenario:

Autonomous vehicle may execute non-critical safety bias of a minimum of 0.23 m from center of the lane up to Maximum Bias Within Lane (e.g., that is to allow the biasing maneuver to reach lane lines without crossing the lane lines to avoid a collision) when autonomous vehicle is passing an NPC or being passed by an NPC travelling in the same direction in the adjacent lane of a multi-lane road.

The amount of bias may align with Standard Bias for non-critical safety bias.

Autonomous vehicle may maintain a pre-determined minimum lateral distance from the NPC travelling in the same direction in the adjacent lane of a multi-lane road.

Parked cars in Adjacent Lane:

An autonomous vehicle may bias up to the Maximum Bias Within Lane (e.g., that is to allow the biasing maneuver to reach lane lines without crossing the lane lines to avoid a collision) for a parked car in the adjacent lane and autonomous vehicle may maintain a pre-determined minimum lateral distance from the parked car.

Parked cars in Adjacent Lane—Extended Bias:

If an autonomous vehicle is in a narrow lane or if a pre-determined minimum lateral distance cannot be maintained from the parked car, autonomous vehicle may execute Maximum Bias—Relaxing Lane Boundary Condition (e.g., that is to allow the biasing maneuver to extend beyond lane lines to avoid a collision).

Bicycle in the Same Lane:

If autonomous vehicle determines that there is enough lateral distance to pass a bicycle travelling in the same lane, autonomous vehicle may abide by Maximum Bias—Relaxing Lane Boundary Condition (e.g., that is to allow the biasing maneuver to extend beyond lane lines to avoid a collision) to pass the bicycle with a pre-determined minimum lateral distance between the autonomous vehicle and the bicycle. The pre-determined minimum lateral distance between the autonomous vehicle and the bicycle may be dictated by local regulations or laws, or may be determined based on safety parameters for the autonomous vehicle. The pre-determined minimum lateral distance between the autonomous vehicle and the bicycle may be a value in a range between 0.5 meters and 3 meters, such as between 1 meter and 2.5 meters, including between 1.25 meters and 2 meters.

Bicycle in Bike Lane:

Autonomous vehicle may bias up to the Maximum Bias Within Lane to pass a moving bicycle in the adjacent bike lane and autonomous vehicle may maintain a pre-determined minimum lateral distance from the bicycle.

Bicycle in Bike Lane—Extended Bias:

If autonomous vehicle is in a narrow lane or if a pre-determined minimum lateral distance cannot be maintained from the bicycle, autonomous vehicle may execute Maximum Bias—Relaxing Lane Boundary Condition.

Opposing Traffic:

Autonomous vehicle may bias up to the Maximum Bias Within Lane when passing an oncoming vehicle in the adjacent opposing lane and autonomous vehicle may maintain a pre-determined minimum lateral distance from the oncoming vehicle.

Opposing Traffic—Extended Bias:

If autonomous vehicle is in a narrow lane or if a pre-determined minimum lateral distance cannot be maintained from the oncoming vehicle, autonomous vehicle may execute Maximum Bias—Relaxing Lane Boundary Condition. The pre-determined minimum lateral distance may be between 0.5 meters and 3.5 meters, between 0.75 meters and 3.0 meters, and between 1.0 meters and 2.5 meters.

Opposing Traffic Biasing Timing:

Autonomous vehicle may start biasing for opposing traffic NPC no later than a pre-determined number of seconds of time-to-crash (TTC) before passing it. The predetermined number of seconds of TTC may be in a range of 1 to 12 seconds, 2 to 10 seconds, 5 to 9 seconds, such as 8 seconds.

Reversible Lane Vehicle:

Autonomous vehicle may bias up to the Maximum Bias Within Lane when passing a vehicle in the reversible lane and autonomous vehicle may maintain a pre-determined minimum lateral distance from the vehicle. The pre-determined minimum lateral distance may be between 0.5 meters and 3.5 meters, between 0.75 meters and 3.0 meters, and between 1.0 meters and 2.5 meters.

Reversible Lane Vehicle—Extended Bias:

If autonomous vehicle is in a narrow lane or if vehicle in the reversible lane is intruding into autonomous vehicle's lane, autonomous vehicle may execute Maximum Bias—Relaxing Lane Boundary Condition and pass the vehicle with a pre-determined minimum lateral distance. The pre-determined minimum lateral distance may be between 0.5 meters and 3.5 meters, between 0.75 meters and 3.0 meters, and between 1.0 meters and 2.5 meters.

Intersection Traffic:

If autonomous vehicle is going straight in an intersection as part of the through-traffic, autonomous vehicle may bias up to the Maximum Bias Within Lane when avoiding a turning vehicle turning into the adjacent opposing lane and autonomous vehicle may maintain a pre-determined minimum lateral distance from the turning vehicle and its predicted path. The pre-determined minimum lateral distance may be between 0.5 meters and 3.5 meters, between 0.75 meters and 3.0 meters, and between 1.0 meters and 2.5 meters.

Intersection Traffic—Extended Bias:

If autonomous vehicle is in a narrow lane or if turning vehicle is expected to intrude into autonomous vehicle's lane, autonomous vehicle may execute Maximum Bias—Relaxing Lane Boundary Condition and leave a pre-determined minimum lateral distance between autonomous vehicle and the turning vehicle's path. The pre-determined minimum lateral distance may be between 0.5 meters and 3.5 meters, between 0.75 meters and 3.0 meters, and between 1.0 meters and 2.5 meters.

Stopped Emergency Vehicle:

Autonomous vehicle may execute Maximum Bias—Relaxing Lane Boundary Condition when passing a stopped emergency vehicle and autonomous vehicle may maintain a pre-determined minimum lateral distance from the emergency vehicle. The pre-determined minimum lateral distance may be between 0.5 meters and 3.5 meters, between 0.75 meters and 3.0 meters, and between 1.0 meters and 2.5 meters.

Stopped Vehicle with Pedestrians or Hazard Lights:

Autonomous vehicle may execute Maximum Bias—Relaxing Lane Boundary Condition when passing a stopped vehicle on the adjacent lane in a multi-lane road in the same direction of travel with pedestrians or hazard lights and autonomous vehicle may maintain a pre-determined minimum lateral distance from the vehicle or pedestrian whichever is closer. The pre-determined minimum lateral distance may be between 0.5 meters and 3.5 meters, between 0.75 meters and 3.0 meters, and between 1.0 meters and 2.5 meters.

ELVs:

When an autonomous vehicle is unable to change lanes, the autonomous vehicle may bias up to the Maximum Bias Within Lane (e.g., that is to allow the biasing maneuver to reach lane lines without crossing the lane lines to avoid a collision) to pass an ELV and autonomous vehicle may maintain a pre-determined minimum lateral distance from the ELV.

ELVs—Extended Bias:

If autonomous vehicle is in a narrow lane or if a pre-determined minimum lateral distance cannot be maintained from a critical ELV, autonomous vehicle may execute Maximum Bias—Relaxing Lane Boundary Condition (e.g., that is to allow the biasing maneuver to extend beyond lane lines to avoid a collision).

Unknown Objects:

Autonomous vehicle may bias up to the Maximum Bias Within Lane (e.g., that is to allow the biasing maneuver to reach lane lines without crossing the lane lines to avoid a collision) when passing an unknown object in the adjacent lane and autonomous vehicle may maintain a pre-determined minimum lateral distance from the unknown object.

Biasing Between NPCs:

When autonomous vehicle is in a situation that there are NPCs on both sides of autonomous vehicle that requires biasing, the autonomous vehicle may bias to ensure that autonomous vehicle passes both NPCs at an equidistance laterally.

Narrow Lane Description:

Narrow lanes may be defined as any lanes that has a width of less than that of a standard lane or a pre-determined distance, such as 3.5 meters, 3.45 meters, 3.4 meters, 3.35 meters, or 3.3 meters.

V.(t) Biasing in Heavy Traffic

When autonomous vehicle is in a traffic jam, autonomous vehicle may avoid executing Maximum Bias—Relaxing Lane Boundary Condition (e.g., that is to allow the biasing maneuver to extend beyond lane lines to avoid a collision).

V.(u) Map—Soft Boundary

For shoulders that do not have a guardrail, wall, or other physical barrier, the map may define the soft boundary as the boundary that separates any paved section of the shoulder from any unpaved area.

If there are bushes, trees, or branches that extend into the paved section (up to the height of autonomous vehicle), the map may define the soft boundary as the boundary that separates any paved section of the shoulder from the widest point of the bushes, trees, or branches.

V.(v) Map—Hard Boundary

For shoulders that do have a guardrail, wall, or other physical barrier, the map may define the hard boundary as the boundary that separates the paved section of the shoulder from the widest point of the physical barrier.

V.(w) Minimum Lateral Distance to Boundary

When biasing within lane boundaries or biasing past a lane boundary onto a shoulder or gore area, the widest point of the autonomous vehicle combination (e.g., including a tractor and trailer) may at all times remain at least a pre-determined distance (e.g., 30 cm, 40 cm, 50 cm, 60 cm) from the outermost point of any hard or soft boundary in the upcoming curve-corrected longitudinal pre-determined number of meters (e.g., 100 meters, 125 meters, 150 meters, 175 meters, 200 meters), relative to the frontmost point of the autonomous vehicle combination.

V.(x) Loss of Global Navigation Satellite System (GNSS)—Bias Within Lane Only:

In the event of an interference, loss or low confidence of Global Navigation Satellite System (GNSS) or real-time kinematic positioning systems signals, autonomous vehicle may restrict bias to within lanes only, to keep to the center of the lane and may deviate no more than a predetermined distance (e.g., 0.2 meters, 0.3 meters, 0.4 meters) from the center of the lane.

V.(y) Loss of Global Navigation Satellite System (GNSS)—Return to Original Lane

In the event of an interference, loss or low confidence of GNSS or real-time kinematic positioning systems signals, if autonomous vehicle is currently biased past a lane boundary, autonomous vehicle may cease biasing past the lane boundary and return to its original lane, unless doing so would cause a liable accident.

V.(z) Extended Bias—Minimize Time

Autonomous vehicle may bias past a lane boundary for the minimal amount of time needed to evade other vehicles or objects.

V.(aa) Extended Bias—Lateral Distance to Lane Crossing Vehicles:

When traveling adjacent to another vehicle, autonomous vehicle may only extend past a lane boundary if the vehicle crosses the intersecting lane boundary into autonomous vehicle's current lane. At this point, autonomous vehicle may maintain a predetermined lateral distance (e.g., 1.0 meters, 1.15 meters, 1.3 meters, 1.5 meters), measured from the widest point of the autonomous vehicle combination to the widest point of the NPC. This requirement may apply to lanes of all widths.

Extended Bias—Trajectory Smoothing:

When biasing past a lane boundary for an adjacent vehicle, autonomous vehicle may smooth its trajectory such that if the adjacent vehicle begins to oscillate back and forth, autonomous vehicle will not mimic the oscillation.

Extended Bias—Return to Lane:

When extending past a lane boundary for an adjacent vehicle, autonomous vehicle may cease the extended bias and return to autonomous vehicle's original lane when the adjacent vehicle is no longer invading autonomous vehicle's original lane or when autonomous vehicle is no longer parallel to the vehicle as described herein below in Return to Lane—No Liable Accidents.

Return to Lane—No Liable Accidents:

When returning back to its original lane after biasing past a lane boundary, an autonomous vehicle may seek to return to a longitudinal position that would not cause a liable accident, adjusting speed as necessary to avoid a collision.

Extended Bias—Preferred Bias on Return to Lane:

On returning to a lateral position within the lane boundaries, an autonomous vehicle may prefer to bias a pre-determined amount, such as an amount specified in the Lane Bias Priority Model.

V.(ab) Extended Bias—Preferred Longitudinal Behavior

When biasing past a lane boundary for a vehicle in the adjacent lane, autonomous vehicle may prefer the following behaviors.

When the vehicle in the adjacent lane is faster than autonomous vehicle, and the speed differential is greater than a threshold value (e.g., 8 mph, 10 mph, 15 mph), the autonomous vehicle may avoid accelerating to let the vehicle pass.

Conversely, when the vehicle in the adjacent lane is slower than the autonomous vehicle and the speed differential is greater than a threshold value (e.g., 8 mph, 10 mph, 15 mph), the autonomous vehicle may prefer to pass the vehicle.

Otherwise, the autonomous vehicle may prefer to slow down unless it can overtake the vehicle in the adjacent lane within a pre-determined number of meters (e.g., 100 meters, 125 meters, 150 meters, 175 meters, 200 meters) and the expected time to overtake is less than the expected time to decelerate out of being parallel, in which case the autonomous vehicle need not slow down.

In these scenarios, to overtake means to be able to pass a vehicle to the extent that there is no overlap between the rearmost point of the autonomous vehicle combination (including trailer) and the frontmost point of the adjacent lane vehicle.

V.(ac) Extended Bias—Significant Increase or Decrease in Pavement Height

Autonomous vehicle may ensure to not bias past a lane boundary onto a shoulder or gore area within a pre-determined number of meters (e.g., 100 meters, 125 meters, 150 meters, 175 meters 200 meters) of any section(s) of road with an increase or decrease in pavement height that would be problematic for controls.

V.(ad) Extended Bias—Avoid Objects

An autonomous vehicle may only bias past a lane boundary onto a shoulder or gore area if there are no emergency lane vehicles (ELVs, i.e., vehicles in the emergency lane or shoulder of a roadway), pedestrians, animals, road signs, or other objects parallel to autonomous vehicle or in front of autonomous vehicle within a pre-determined number of meters (e.g., 100 meters, 125 meters, 150 meters, 175 meters 200 meters) or the distance it would take to come to a complete stop, whichever distance is greater. In the context of roadways, a gore area is the space or area, usually triangular, that is defined by solid white lines of a through lane and an off-ramp or on-ramp, or an exit or entrance to a roadway; a gore area may help drivers organize when entering or exiting highways as well as connect two areas where the is a difference in elevation or grading, as there would be between a ramp and a through portion of roadway.

V.(ae) Extended Bias—Avoid Objects—Return to Original Lane

When an ELV, pedestrian, animal, road sign, or other object appears within the distance it would take autonomous vehicle to come to a complete stop or a pre-determined number of meters (e.g., 100 meters, 125 meters, 150 meters, 175 meters 200 meters), whichever distance is greater, while autonomous vehicle is biased past a lane boundary onto a shoulder or gore area, the autonomous vehicle may slow down, cease to bias past the lane boundary, and return to its original lane.

V.(af) Extended Bias—Gore Point and Merging Vehicles

When biasing past a lane boundary onto a gore area and there are vehicles merging, autonomous vehicle may slow down, cease to bias past the lane boundary, and return to its original lane before reaching the gore point.

V.(ag) Extended Bias—Adjacent Lane

When biasing past a lane boundary onto an adjacent driving lane that is in the same direction of travel (local and highway), autonomous vehicle may be allowed to bias up to the point where the widest part of the autonomous vehicle combination (an autonomous vehicle with a tractor and including a trailer) reaches half of the width of the adjacent lane, provided that the lane is clear.

V.(ah) Extended Bias—Audio Notification

At the moment that the intention to bias past a lane boundary is known, the autonomous vehicle may provide an audio notification that says “Extended Lane Bias” to notify drivers of its intention. The audio notification may be announced internally, to the cabin of the autonomous vehicle, or external, such as to notify drivers of surrounding NPC vehicles of the intent of the autonomous vehicle.

### VI. Lane Change

An autonomous truck may be able to properly change lanes on a highway or roadway. Techniques for performing lane change may include at least the following: the identification of spaces (e.g., windows) in adjacent lanes into which the autonomous trucks can move into; monitoring of the vehicles in the lane into which the autonomous truck wants to move; identifying conditions in which a lane change should be aborted; making sure that lane change and aborted lane changes can be executed smoothly; and how to avoid collisions when changing lanes.

VI.(a) Priority Order

When it comes to making decisions around changing lanes, autonomous vehicle may prioritize safety over regulation, and both safety and regulation over efficiency.

VI.(b) Lane Change Intention Priority Model

Autonomous vehicle may categorize lane change intentions based on safety, regulatory, and efficiency concerns, unless otherwise specified. More specifically, the priority order may be as follows (from highest priority to lowest priority):

Critical Safety

A critical safety intention is an intention where the lane change may be done because of an immediate safety concern. The following lane change intentions may be classified under this category: intending to change lanes a predetermined distance from the merge point of a merge area (e.g., 75 meters, 100 meters, 125 meters, 150 meters from the merge point) of a merge area where the autonomous vehicle's trajectory is predicted to intersect with the trajectory of a merging vehicle; intending to change lanes due to a moving emergency lane vehicle (ELV), a pedestrian associated with an emergency lane vehicle (ELVP), an emergency vehicle, a flashing light vehicle, an abnormal stopped vehicle, or an ELV that is protruding into autonomous vehicle's lane; intending to change lanes to avoid a harsh trajectory with a current acceleration less than or equal to a first value or a future intended acceleration less than or equal to a second value; intending to change lanes to ensure the autonomous vehicle does not miss its exit that is within a pre-determined distance; intending to change lanes because staying in our lane would result in an unplanned exit from the highway in less than a pre-determined distance; and intending to change lanes due to a height clearance restriction where autonomous vehicle is too tall (this may be classified as a No Commercial Vehicle zone).

Non-Critical Safety

A non-critical safety intention is an intention where the lane change may be done because of a safety concern that will likely not result in a collision.

The following lane change intentions may be classified under this category: intending to change lanes between a first distance and a second distance from the merge point of a merge area where autonomous vehicle's trajectory is predicted to intersect with the trajectory of a merging vehicle; intending to change lanes due to driving by an adjacent emergency land vehicle (ELV) that is not safety critical; intending to change lanes to avoid a harsh trajectory with a current acceleration less than or equal to a first value or a future intended acceleration less than or equal to a second value; intending to change lanes to ensure the autonomous vehicle does not miss an intended exit that is between a first distance and a second distance from autonomous vehicle; intending to change lanes because staying in the current lane of travel would result in an unplanned exit from the highway in less than a first distance but greater than a second distance; and intending to change lanes to bypass a slow vehicle traveling a pre-determined number of mph or more under the environmental speed.

Regulatory

A regulatory intention is an intention where the lane change may be done because of a legal concern that does not pose a major concern for safety.

The following lane change intentions may be classified under this category: intending to change lanes because autonomous vehicle is traveling on a lane that ends (e.g., lane ending merge) within a pre-determined number of meters; and intending to change lanes due to a zone that does not allow commercial vehicles (e.g. No Commercial Vehicle zone) that begins within pre-determined number of meters and is not higher priority.

Efficiency

An efficiency intention is an intention where the lane change may be done for efficiency reasons.

The following lane change intentions may be classified under this category: intending to change lanes because staying in the current lane of travel would lead to an unintended exit of the autonomous vehicle from the highway onto a local road, from which the autonomous vehicle may get back onto the highway through the local road, in a pre-determined number of meters (e.g., 1000 meters, 1100 meters, 1200 meters, 1300 meters, 1400 meters); intending to change lanes due to an upcoming planned exit that is between pre-determined number of meters (e.g., 1200 meters (0.75 miles), 1600 meters (1 mile), 2000 meters (1.25 miles)) and a larger pre-determined number of meters (e.g., 2800 meters (1.75 miles), 3200 meters (2 miles), 3600 meters (2.25 miles)) away from the autonomous vehicle; intending to change lanes because staying in the current lane or travel would result in an unplanned exit from the highway in more than a pre-determined number of meters (e.g., 1200 meters (0.75 miles), 1600 meters (1 mile), 2000 meters (1.25 miles)) and a larger pre-determined number of meters (e.g., 2800 meters (1.75 miles), 3200 meters (2 miles), 3600 meters (2.25 miles)); and intending to change lanes to bypass a slow vehicle traveling between a first number of mph (e.g., 8 mph, 10 mph, 12 mph, 15 mph) and a second number of mph (e.g., 15 mph, 18 mph, 20 mph, 25 mph) under the environmental speed

Precautionary

A precautionary lane change intention is an intention where the lane change may be done as a precaution.

The following lane change intentions may be classified under this category: intending to change lanes between a first distance (e.g., 250 meters, 275 meters, 300 meters) and a second distance (e.g., 1150 meters, 1175 meters, 1200 meters, 1225 meters) from the merge point of a merge area where autonomous vehicle's trajectory is predicted to intersect with the trajectory of a merging vehicle; intending to change lanes because autonomous vehicle is traveling on a lane that ends (e.g., lane ending merge) between a first distance (e.g., 250 meters, 275 meters, 300 meters) and a second distance (e.g., 1150 meters, 1175 meters, 1200 meters, 1225 meters) from autonomous vehicle; and intending to change lanes to bypass a slow vehicle traveling in a predetermined range of values under the environmental speed (e.g., between 5 mph and 15 mph, between 5.5 mph and 12 mph, between 6.7 mph and 10 mph) under the environmental speed.

Preference

A preference intention is an intention where the lane change may be done because of a concern that does not pose a major concern for safety and is the lowest priority.

The following lane change intentions may be classified under this category: intending to change lanes when autonomous vehicle has more right lanes available than left lanes (e.g., right lane preference); and intending to change lanes due to a No Commercial Vehicle zone that begins between a first distance and a second distance (e.g., between 50 meters and 1000 meters, between 75 meters and 900 meters, between 100 meters and 800 meters) from the autonomous vehicle and is not higher priority.

VI.(c) Lane Change Denier Priority Model

An autonomous vehicle may categorize lane change deniers based on safety, regulatory, and efficiency concerns, unless otherwise specified. More specifically, the priority order may be as follows (from highest priority to lowest priority):

Critical Safety

A critical safety denier is a denier where the lane change should not be executed due to an immediate safety concern.

The following lane change deniers may be classified under this category: lane change where perception limitations would prevent autonomous vehicle from safely changing lanes; lane change that would put us in a lane that has a height clearance restriction where autonomous vehicle is too tall (may be classified as a No Commercial Vehicle zone); lane change that would move the autonomous vehicle away from the lane the autonomous vehicle needs to be in for an upcoming planned exit that is less than a pre-determined distance away (e.g., 800 meters (0.5 miles), 1200 meters (0.75 miles), 1600 meters (1 mile)); lane change that would move us away from the lane we need to be in to avoid an unplanned exit that is less than a pre-determined distance away (e.g., 800 meters (0.5 miles), 1200 meters (0.75 miles), 1600 meters (1 mile)); and lane change that would move the autonomous vehicle away from a pre-configured trajectory for an upcoming intersection turn; lane change that would make the autonomous vehicle adjacent to a moving emergency lane vehicle (ELV), pedestrian near an emergency lane vehicle (ELVP), emergency vehicle, flashing light vehicle, abnormal stopped vehicle, or an ELV that is protruding into autonomous vehicle's target lane; lane change where autonomous vehicle does not have enough room resulting in a high collision risk; lane change with a harsher trajectory than the critical safety harsh trajectory intention that triggered it; and lane change where the target lane front vehicle is a slow-moving vehicle traveling a pre-determined number of mph (e.g., 15 mph, 18 mph, 20 mph, 25 mph) or more under the environmental speed.

Non-Critical Safety

A non-critical safety denier is a denier where the lane change should not be done because of a safety concern that will likely not result in a collision.

The following lane change deniers may be classified under this category: lane change that would move the autonomous vehicle away from the lane the autonomous vehicle needs to be in for an upcoming planned exit that is more than a first distance (e.g., 400 meters (0.25 miles), 800 meters (0.5 miles), 1200 meters (0.75 miles)) away but less than a second distance (e.g., 1200 meters (0.75 miles), 1600 meters (1 mile), 2000 meters (1.25 miles)), 2400 meters (1.5 miles)); lane change that would move the autonomous vehicle away from the lane the autonomous vehicle needs to be in to avoid an unplanned exit that is more than a first distance (e.g., 400 meters (0.25 miles), 800 meters (0.5 miles), 1200 meters (0.75 miles)) away but less than a second distance (e.g., 1200 meters (0.75 miles), 1600 meters (1 mile), 2000 meters (1.25 miles)); lane change that would make us adjacent to an ELV that is not safety critical; lane change where the target lane front vehicle is a slow-moving vehicle traveling between a first number of mph (e.g., 5 mph, 8 mph, 10 mph) and a second number of mph (e.g., 18 mph, 20 mph, 25 mph) under the environmental speed; lane change that would make an autonomous vehicle adjacent to a highway entrance ramp or lane ending merge ramp with a merge point that begins in less than a pre-determined number of meters (e.g., 250 meters, 275 meters, 300 meters, 325 meters) and has at least one NPC on the ramp; and lane change with a harsher trajectory than the non-critical safety harsh trajectory intention that triggered it.

Regulatory

A regulatory denier is a denier where the lane change should not be done because of a legal concern that does not pose a major safety concern.

The following lane change deniers may be classified under this category: lane change that would result in autonomous vehicle being in a No Commercial Vehicle zone that begins within a pre-determined distance and is not higher priority; lane change that would result in the autonomous vehicle crossing white solid lane boundaries; and lane change that would result in autonomous vehicle traveling on a lane that ends within a pre-determined distance (e.g., 1100 meters, 1150 meters, 1200 meters, 1250 meters).

Efficiency

An efficiency denier is a denier where the lane change should not be done due to efficiency reasons.

The following lane change deniers may be classified under this category: lane change that would move autonomous vehicle away from the lane it needs to be in for an upcoming planned exit that is between a first distance (e.g., 1200 meters (0.75 miles), 1600 meters (1 mile), 2000 meters (1.25 miles)) and a second distance (e.g., 2800 meters (1.75 miles), 3200 meters (2 miles), 3600 meters (2.25 miles)) from the autonomous vehicle; lane change that would move autonomous vehicle away from the lane it need to be in to avoid an unplanned exit that is more than a first distance (e.g., 1200 meters (0.75 miles), 1600 meters (1 mile), 2000 meters (1.25 miles)) and less than a second distance (e.g., 2800 meters (1.75 miles), 3200 meters (2 miles), 3600 meters (2.25 miles)) away; lane change where the target lane front vehicle is a slow-moving vehicle traveling between a first speed and a second speed (e.g., 6.25 mph and 15 mph, 6.5 mph and 12 mph, 6.7 mph and 10 mph) under the environmental speed; and lane change that would lead to an unintended exit from the highway onto a local road, from which the autonomous vehicle can get back onto the highway through, within a pre-determined number of meters (e.g., 1200 meters (0.75 miles), 1600 meters (1 mile), 2000 meters (1.25 miles)).

Precautionary

A precautionary lane change denier is a denier where the lane change should not be done due to relatively low priority precautionary measures.

The following lane change deniers may be classified under this category: lane change that would make autonomous vehicle adjacent to a highway entrance ramp or lane ending merge ramp with a merge point that begins within a first and a second number of meters (e.g., 250 and 700 meters, 275 and 650 meters, 300 and 600 meters) from autonomous vehicle and has at least one NPC on the ramp; lane change that would result in autonomous vehicle driving parallel to a large vehicle (e.g., another semi-truck)

Preference

A preference denier is a denier where the lane change should not be done due to a concern that does not pose a major concern for safety and is the lowest priority.

The following lane change denier may be classified under this category: lane change that would result in autonomous vehicle being in a No Commercial Vehicle zone that begins between a first number of meters (e.g., 75 meters, 100 meters, 125 meters) and a second number of meters (e.g., 700 meters, 800 meters, 900 meters) from autonomous vehicle and is not higher priority.

VI.(d) De-conflicting Priority Across Models

When faced with a lane change intention and lane change denier of differing priorities, an autonomous vehicle may adhere to the intention or denier with the higher priority, unless otherwise specified.

When faced with an intention and denier of the same priority, the autonomous vehicle may weigh the costs associated with all possible actions, and choose the action with the lowest cost.

If it is possible to fulfill a lane change intention related to a planned or unplanned exit while still being able to clear an equal or lower-level priority denier, the autonomous vehicle may have preference to do so.

For example, when an autonomous vehicle is within a predetermined distance (e.g., 0.75 miles, 1 mile, 1.25 miles, 1.5 miles) from its exit and needs to move to the right lane. When there is a non-critical safety emergency lane vehicle (ELV) denier up ahead, the autonomous vehicle may prefer to pass the ELV before changing lanes to the right, if it has room to do so while still being able to make the planned exit.

VI.(e) Continuously Monitor the Target Front Vehicle

An autonomous vehicle may continuously monitor the bumper-to-bumper gap to the target front vehicle. The bumper-to-bumper gap is defined as the distance in meters between the front bumper of autonomous vehicle and the rear bumper of the target front vehicle. The target front vehicle is defined as the vehicle that is expected to be in front of the autonomous vehicle when autonomous vehicle completes its lane change maneuver.

Predict the Expected Target Front Deceleration:

An autonomous vehicle may be able to make an instantaneous prediction on the expected target lane front vehicle deceleration, if any. An instantaneous prediction is one that uses any currently available information gathered from the sensors. For example, a vehicle may be expected to decelerate a certain amount if our sensors detect that heavy traffic is up ahead.

Target Front Critical Distance—Description:

Autonomous vehicle may define the critical distance with the target front vehicle as the largest gap from the following options: the bumper-to-bumper gap required to maintain a high confidence in our sensor coverage; the bumper-to-bumper gap required to be outside of our response time minimums; and the bumper-to-bumper gap required to avoid a collision under the assumption that both autonomous vehicle and the target lane front vehicle have to decelerate to a complete stop at the expected deceleration of the target lane front vehicle and autonomous vehicle's expected reactive deceleration. This gap may account for autonomous vehicle's reaction time and may include an additional safety buffer. When the target front vehicle is not expected to decelerate, this gap may be equal to the safety buffer.

Target Front Critical Distance—Behavior:

Autonomous vehicle may avoid changing lanes within the critical distance to the target lane front vehicle.

Target Front General Preferred Behavior:

For all but critical safety lane change intentions, an autonomous vehicle may preferably: prefer to change lanes with a bumper-to-bumper gap of at least a pre-determined distance (e.g., 10 meters, 12 meters, 15 meters) with the target front vehicle; follow the deceleration behavior outlined in General Deceleration Behavior in Section VI.(g); and prefer not to change lanes behind a target front slow-moving vehicle as outlined in Target Lane Slow Vehicle Behavior in Section VI.(i).

Target Front Gap Growth:

For all lane change intentions, autonomous vehicle may grow the front gap as follows until the front gap is at the appropriate following distance: after the outermost point of autonomous vehicle's combined load has crossed the lane boundary of the target lane, the autonomous vehicle may maintain a positive front gap growth rate with the target front vehicle; and after the centroid of autonomous vehicle's combined load has crossed the lane boundary of the target lane, autonomous vehicle may gradually grow the front gap growth rate with the target front vehicle to a pre-determined velocity (e.g., 1.5 m/s, 2 m/s, 2.25 m/s). The bumper-to-bumper gap may be measured from the front bumper of autonomous vehicle to the rear bumper of the target front vehicle.

VI.(f) Continuously Monitor the Target Back Vehicle

An autonomous vehicle may continuously monitor the bumper-to-bumper gap to the target back vehicle. The bumper-to-bumper gap is defined as the distance in meters between the back bumper of autonomous vehicle and the front bumper of the target back vehicle. The target back vehicle is defined as the vehicle that is expected to be behind autonomous vehicle when autonomous vehicle completes its lane change maneuver.

Determine autonomous vehicle's Expected Deceleration:

When considering whether to change lanes, autonomous vehicle may be able to determine its expected deceleration if it were to make the lane change

Target Back Critical Distance—Description:

An autonomous vehicle may preferably define the critical distance as the bumper-to-bumper gap that is required to avoid a collision under the assumption that both autonomous vehicle and the target lane back vehicle have to decelerate to a complete stop at autonomous vehicle's expected deceleration and the target lane back vehicles expected reactive deceleration. This gap may account for the target back's expected reaction time and may include an additional safety buffer.

When the autonomous vehicle does not plan to decelerate, this gap should be equal to the safety buffer.

Target Back Critical Distance—Behavior:

An autonomous vehicle may avoid changing lanes within the critical distance to the target lane back vehicle.

Target Back General Preferred Behavior:

For all but critical safety lane change intentions, an autonomous vehicle may prefer to lane change following the listed conditions: when the bumper-to-bumper gap with the target lane back vehicle is at least a pre-determined distance (e.g., 10 meters, 12 meters, 15 meters) and the time-to-collision with the target back is at least a pre-determined number of seconds (e.g., 5 seconds, 7 seconds, 9 seconds), an autonomous vehicle may prefer to change lanes, only when the target back's speed is greater than that of the autonomous vehicle; and when conducting an Efficiency, Precautionary, or Preferential Lane Change and the Target Back vehicle is a Large Vehicle, an autonomous vehicle may prefer to change lanes when the time-to-collision with the target back is at least a pre-determined number of seconds (e.g., 8 seconds, 10 seconds, 12 seconds).

Target Back General Deceleration Behavior:

For all but critical safety lane change intentions, if the target lane back vehicle is outside our target back critical distance but inside our preferred distance, autonomous vehicle may not plan to decelerate.

For all but critical safety lane change intentions, an autonomous vehicle may prefer to lane change following the listed conditions: an autonomous vehicle may prefer to change lanes when the bumper-to-bumper gap with the target lane back vehicle is at least a predetermined distance (e.g., 8 meters, 10 meters, 12 meters, 15 meters) and the time-to-collision with the target back is at least a predetermined time (e.g., 5 seconds, 6 seconds, 7 seconds, 8 seconds) only when the target back's speed is greater than that of the autonomous vehicle; and when conducting an Efficiency, Precautionary, or Preferential Lane Change and the Target Back vehicle is a Large Vehicle, an autonomous vehicle may prefer to change lanes when the time-to-collision with the target back is at least a predetermined amount of time (e.g., 7 seconds, 8 seconds, 9 seconds, 10 seconds, 15 seconds).

VI.(g) General Deceleration Behavior

For all but critical safety lane change intentions, when intending to change lanes autonomous vehicle may avoid planning to decelerate more than a pre-determined rate (e.g., 2.24 m/s\hat{ }2 or approximately 3 to 6 mph per second, or approximately 4-5 mph per second) on completion of the lane change. An autonomous vehicle's expected deceleration may depend on the target front's current speed and expected deceleration.

VI.(h) Assist in Finding a Gap

Under normal traffic conditions, autonomous vehicle may interact with nearby vehicles for assistance in creating a gap to lane change.

Gap Finding Turn Signal Usage:

An autonomous vehicle may engage the appropriate turn signal when it intends to lane change, unless the lane change is denied by an equal or higher priority lane change denier. When an autonomous vehicle is finding a gap to lane change into, it may avoid immediately cancelling the gap finding intent due to not having enough room (a critical safety lane change denier) since the whole point of gap finding is to signal and wait for room to be made.

Gap Finding Turn Signal Duration:

For all lane change intentions, an autonomous vehicle may keep the signal engaged until the autonomous vehicle has successfully changed lanes or the gap finding intent is canceled.

Recognize Yielding Vehicle:

Autonomous vehicle may recognize when a vehicle in the target lane is yielding to it.

A yielding vehicle may flash its lights, create a growing gap, and/or maintain a non-positive acceleration.

Canceling Intent—Yield Gap Too Small:

For all but safety critical lane change intentions, if a vehicle is yielding but (1) the rear gap is between our target back critical distance and preferred distance and (2) autonomous vehicle plans to decelerate after the lane change, autonomous vehicle can consider canceling the gap finding intention.

Ultimately this decision may come down to the cost of changing lanes within the preferred distance of the autonomous vehicle versus staying in the current lane of travel.

Canceling Intent—Preferred Gap Finding Intent Duration:

For efficiency-level lane change intentions, if a pre-determined number of seconds (e.g., 15 seconds, 18 seconds, 20 seconds, 22 seconds) have elapsed since the turn signals were engaged and autonomous vehicle does not foresee a vehicle yielding, autonomous vehicle may consider canceling the gap finding intent. For regulatory, non-critical safety, and critical safety lane change intentions, the amount of time that has elapsed since the turn signals were engaged should not play a role in whether the gap finding intent is canceled.

Retrying a Gap Finding Intent:

If an efficiency-related gap finding intent was canceled as a result of the duration (see Canceling Intent—Preferred Intent Duration), autonomous vehicle should consider retrying the intent after a pre-determined number of seconds (e.g., 15 seconds, 18 seconds, 20 seconds, 25 seconds) have passed.

VI.(i) Continuously Monitor for Slow-Moving Vehicles

Autonomous vehicle may continuously monitor for the presence of slow-moving vehicles in its current lane and target lane.

Environmental Speed:

The environmental speed may be the speed at which autonomous vehicle should be traveling given its current environment, never to exceed the speed limit or contract limit (if applicable).

This speed may take into account the speed limit, contract limit (if applicable), the density of traffic, the speed of the majority of traffic, and weather conditions. For free-flowing traffic in nominal weather conditions, the environmental speed may be the speed limit or contract limit. “Free-flowing traffic” may include traffic with levels of service A, B, or C. Level of Service (LoS) is “a term used to qualitatively describe the operating conditions of a roadway based on factors such as speed, travel time, maneuverability, delay, and safety. The level of service of a facility is designated with a letter, A to F, with A representing the best operating conditions and F the worst.

Current Lane Slow Moving Vehicle Description:

An autonomous vehicle may consider a vehicle in the current lane as a slow vehicle if it is traveling a pre-determined number of m/s or mph (e.g., 3 m/s (6.7 mph), 4 m/s (8.95 mph)) or more under the environmental speed.

Target Lane Slow Moving Vehicle Description:

Autonomous vehicle may define a target lane slow moving vehicle as any target front vehicle that would cause autonomous vehicle to violate its target back general deceleration behavior requirement or would be considered a Current Lane Slow Moving Vehicle after the autonomous vehicle has completed the lane change and is not expected to speed up.

Predict the Duration of Slowness:

If there is a slow-moving vehicle in either autonomous vehicle's current lane or target lane, autonomous vehicle may predict whether the vehicle will remain slow in the foreseeable future.

Some slow-moving vehicles may be accelerating rapidly, which would impact whether they remain “slow” for long. When there is an upcoming decrease in the speed limit, identifying slow vehicles can be benchmarked against the new slower speed limit.

Current Lane Slow Moving Vehicle Observation Window:

When a vehicle in an autonomous vehicle's current lane is predicted to remain slow for a foreseeable amount of time (e.g., 10 seconds, 12 seconds, 15 seconds, 18 seconds), autonomous vehicle may monitor the vehicle for at least a pre-determined number of seconds (to allow it to speed up) before considering passing.

Current Lane Slow Vehicle Behavior:

For slow moving vehicles that are predicted to remain slow for an unforeseeable amount of time, autonomous vehicle can consider passing.

This type of slow-moving vehicle should trigger an efficiency lane change intention if it is traveling less than a pre-determined number of mph (e.g., 8 mph, 10 mph, 12 mph) under the environmental speed.

This type of slow-moving vehicle may trigger a non-critical safety lane change intention if it is traveling a pre-determined number of mph (e.g., 8 mph, 10 mph, 12 mph) or more under the environmental speed.

Passing Consideration:

When the autonomous vehicle is considering passing, it may prefer to pass on the left.

Passing a Slow Vehicle—Cooldown Period:

When overtaking a slow vehicle, an autonomous vehicle may consider waiting up to a pre-determined number of seconds (e.g., 45 seconds, 60 seconds, 75 seconds) before canceling the passing intent (to allow autonomous vehicle to finish passing) unless a higher priority lane change intention urges the autonomous vehicle to another lane. In some embodiments, an efficiency-related lane preference for the original lane should not take higher priority when autonomous vehicle is passing a slow vehicle (e.g., autonomous vehicle should wait a pre-determined number of seconds before giving up, decelerating, and going back to the original lane due to an efficiency-related lane preference).

Target Lane Slow Vehicle Behavior:

If a target lane slow-moving vehicle is predicted to remain slow for an unforeseeable amount of time and is traveling less than a pre-determined number of mph under the environmental speed, an autonomous vehicle should classify this as an efficiency lane change denier.

If a target lane slow-moving vehicle is predicted to remain slow for an unforeseeable amount of time and is traveling a pre-determined number of mph or more under the environmental speed, an autonomous vehicle can classify this as a non-critical safety lane change denier.

If possible, an autonomous vehicle may prefer to pass the target lane slow vehicle and then change lanes.

VI.(j) Lane Change Duration

An autonomous vehicle may complete all but critical safety lane changes in approximately a pre-determined number of seconds. For critical safety lane changes or evasive maneuvers, the autonomous vehicle may follow a minimum safe lane change duration defined by vehicle dynamics.

VI.(k) Avoid Collisions when Changing Lanes

An autonomous vehicle may never make a lane change that will result in a collision with another vehicle.

VI.(l) Monitor the Second Lane Over Vehicle

Autonomous vehicle may monitor for the presence of a vehicle that is adjacent to autonomous vehicle's target lane (e.g., a vehicle that is two lanes over from autonomous vehicle's current lane in the direction of the lane change) and may prefer to change lanes when there is no vehicle in that position

VI.(m) Aborting Lane Changes

Since lane changes occur temporally over ˜8 seconds, an autonomous vehicle may be ready to abort a lane change if the original lane (e.g., lane of original travel) is still clear and there is a safety reason to prefer the original lane.

VI.(n) Abort Smoothness

When aborting a lane change and there is no immediate risk of collision, an autonomous vehicle may preferably smoothly return to its original lane in approximately the same amount of time it took to get to its current position in the lane change. If there is an immediate risk of collision, autonomous vehicle may preferably follow a minimum safe abort duration defined by vehicle dynamics. As an example, if autonomous vehicle is 3 seconds into a lane change when it decides to abort, then it may take 3 seconds to return back to its original lane.

VI.(o) Cooldown Period Description

A cooldown period may be defined as the time period following the completion of a lane change during which another lane change cannot be initiated, typically used to account for limitations in perception.

A lane change may be considered complete when autonomous vehicle is in the targeted lateral position of the target lane.

VI.(p) Cooldown Period—Higher Priority Intention

If the current lane change intention has a higher priority than the previous one, the cooldown period may last a pre-determined number of seconds, less than that for lower priority intentions and less than or equal to the number of seconds for same level intentions, unless otherwise specified. The pre-determined number of seconds may be 2 seconds or less, including 1 second or less or 0.5 seconds or less.

VI.(q) Cooldown Period—Lower Priority Intention

If the current lane change intention has a lower priority than the previous lane change intention, the cooldown period may last a pre-determined number of seconds, unless otherwise specified. The pre-determined number of seconds may be 4 seconds or more, such as 5 seconds or more, 6 seconds or more, and 7 seconds or more.

VI.(r) Cooldown Period—Same Priority Intention

With the exception of critical lane change intentions and lane change intentions related to slow vehicles, if the current lane change intention has the same priority as the previous lane change intention, the cooldown period may last a pre-determined number of seconds. This pre-determined number of seconds may be 2 seconds, 3 seconds, 4 seconds, or 5 seconds.

VI.(s) Cooldown Period—Same Priority Intention—Critical Lane Change Intentions

If both the current and previous lane change intentions have a priority of critical safety, the cooldown period may last a pre-determined number of seconds, equal to the number of seconds for cooldown for when the current lane intention has a higher priority than the previous lane.

For critical lane change intentions, an autonomous vehicle may want to make sure it is able to react quick enough even if the previous intention was of the same priority.

Additional techniques for performing lane change by the compliance module can include: Continuously Monitor for Slow Moving Vehicles Actions; Critical Safety Lane Change Intention Actions; Non-Critical Safety Lane Change Denier Actions; Non-Critical Safety Lane Change Intention Actions; Proactive Lane Change Strategy When Accepting Merge-In Vehicles at Ramps Actions; Regulatory Lane Change Denier Actions; Efficiency Lane Change Denier Actions; Regulatory Lane Change Intention Actions; Critical Safety Lane Change Denier Actions; and/or Efficiency Lane Change Intention Actions

### VII. Merging Onto Highway

An autonomous truck may properly merge into lanes on highways from on-ramps or utilize k-ramps as appropriate. Executing a merge onto a highway may include the ability to identify a gap in traffic allowing for the merge by the autonomous truck, as well as the ability to identify when the truck should commence a merge and complete a merge to be in accordance with applicable regulations.

VII.(a) Gap Seeking—Minimize Change in Planned Acceleration

An autonomous vehicle may prefer a gap that requires the least change in planned longitudinal or lateral acceleration.

VII.(b) Gap Seeking—Shrinking Gap

An autonomous vehicle may prefer a gap that is not shrinking in size. A gap with a target back vehicle that intends to pass the autonomous vehicle may be considered a shrinking gap, even if there is no target front vehicle.

VII.(c) Merge Speed Preference

When merging onto the highway, an autonomous vehicle may accelerate to the speed of traffic prior to reaching the merge point, if possible.

VII.(d) K-Ramp—Alternative Route

The autonomous driving system may have an alternative route pre-mapped for all k-ramps on an autonomous vehicle's routes that the autonomous vehicle may merge off of. The alternative route may outline the path to be taken on an unsuccessful merge. Alternatively, an oversight system may provide an alternative route for all k-ramps on the route an autonomous vehicle may use to merge off a roadway.

VII.(e) Gap Creation

When merging onto the highway, an autonomous vehicle may actively create a gap and identify yielding vehicles as described herein above regarding lane change requirements.

An autonomous vehicle may not cancel the intent due to a yield gap that is too small and therefore may void the following requirement that for all but critical safety lane change intentions, an autonomous vehicle may prefer to lane change following the listed conditions: an autonomous vehicle should prefer to change lanes when the bumper-to-bumper gap with the target lane back vehicle is at least a predetermined distance (e.g., 8 meters, 10 meters, 12 meters, 15 meters) and the time-to-collision with the target back is at least a predetermined time (e.g., 5 seconds, 6 seconds, 7 seconds, 8 seconds) which only applies when the target back's speed is greater than that of the autonomous vehicle.

When conducting an Efficiency, Precautionary, or Preferential Lane Change and the Target Back vehicle is a Large Vehicle, Ego should prefer to change lanes when the time-to-collision with the target back is at least a predetermined amount of time (e.g., 7 seconds, 8 seconds, 9 seconds, 10 seconds, 11 seconds, 12 seconds).

Merge Gap Creation in Traffic Jams:

An autonomous vehicle may creep forward to find a potential merge gap when unable to find a merge gap in a traffic jam,

When a potential merge gap is found, an autonomous vehicle may use its turn signals and move in the direction of merge to where the autonomous vehicle is about to intrude into the final merged lane to show intention of merge in.

When the merge gap is increasing, an autonomous vehicle may continue to merge in. When the merge gap is decreasing, an autonomous vehicle may stop and wait for vehicles to yield to the autonomous vehicle.

VII.(f) Gap Seeking—Maximize our Probability of Success

When merging onto the highway, an autonomous vehicle may seek a gap that satisfies the target front and target back critical distances (see Merge Gap section) and maximizes the probability of a successful merge.

Gap Seeking—Minimize Change in Planned Acceleration:

Autonomous vehicle may prefer a gap that requires the least change in planned longitudinal or lateral acceleration.

Gap Seeking—Shrinking Gap:

An autonomous vehicle may prefer a gap that is not shrinking in size.

A gap with a target back vehicle that intends to pass autonomous vehicle may be considered a shrinking gap, even if there is no target front vehicle.

Gap Seeking—Trajectory of Leading Vehicle:

When gap seeking, autonomous vehicle may take into account the expected trajectory of any leading vehicles. In other words, autonomous vehicle may not seek a gap that a leading vehicle is expected to enter and as a result would not leave enough room for autonomous vehicle.

VII.(g) Merging and Solid White Lines

When merging onto the highway, an autonomous vehicle may determine to avoid lane change when the tractor or trailer is parallel to a solid white line, unless for an evasive maneuver.

Optionally, if necessary, autonomous vehicle may start a merge onto a highway when the tractor is not parallel to a solid white line but the trailer is parallel as long as the trailer ceases to be parallel to the solid white line by the time it crosses the lane boundary.

Exception—Merge off of K-Ramp Already Started:

For k-ramps, if an autonomous vehicle becomes parallel to an ending solid white line when it is in the middle of the lane change onto the highway (e.g., ½ of the tractor is on the highway and the other ½ is on the ramp), the autonomous vehicle may preferably finish the lane change even if it requires crossing a solid white line.

VII.(h) Merge Time Preference

An autonomous vehicle may prefer to merge onto the highway as soon as possible while obeying the avoiding entering or planning a merge trajectory that requires entering the gore area unless doing so for an evasive maneuver, as well as avoiding any lane changes when the tractor or trailer is parallel to a solid white line, unless for an evasive maneuver.

VII.(i) Gap Seeking—Trajectory of Leading Vehicle

When gap seeking, an autonomous vehicle may take into account the expected trajectory of any leading vehicles. In other words, the autonomous vehicle may determine to avoid seeking a gap that a leading vehicle is expected to enter and as a result would not leave enough room for the autonomous vehicle.

VII.(j) Merging and Gore Area

When merging onto the highway, an autonomous vehicle may determine to avoid entering or planning a merge trajectory that requires entering the gore area unless doing so for an evasive maneuver.

An autonomous vehicle's tires touching a bordering solid white line may be considered “entering” the gore area.

VII.(k) Merge Gap

When merging onto the highway, autonomous vehicle may obey the lane change requirements, described herein, except that the autonomous driving system may determine to avoid having a preferred target front distance or a preferred target back distance. Rather, when it comes to the merge gap, the system may only follow the target front and target back critical distance requirements

VII.(l) K-Ramp Merge Priority

Merging off of a k-ramp onto the highway may be classified as a non-critical safety lane change intention.

Given this classification, lower priority deniers, may not overrule the intention, unless otherwise specified. A lower priority denier may include a denier for the scenario in which the autonomous vehicle monitors for and detects the presence of a vehicle that is adjacent to the autonomous vehicle's target lane (i.e., a vehicle that is two lanes over from the current lane of travel in the direction of the lane change), the autonomous vehicle may prefer to change lanes when there is no NPC vehicle in that position.

VII.(m) Exception—Merge off of K-Ramp Already Started

For k-ramps, if an autonomous vehicle becomes parallel to an ending solid white line when it is in the middle of the lane change onto the highway (e.g., ½ of the tractor is on the highway and the other ½ is on the ramp), the autonomous vehicle may finish the lane change even if it requires crossing a solid white line.

An autonomous vehicle still may avoid crossing into the gore area in this situation, unless it's for an evasive maneuver.

VII.(n) K-Ramp—Canceling the Merge Attempt

When attempting to merge off of a k-ramp, autonomous vehicle may cancel the merge attempt (and continue on the k-ramp) if it cannot find or create a sufficient gap by the time the front of the tractor has reached a solid white line or gore point.

VII.(o) Zipper Merge in Traffic Jam

When merging in a traffic jam, an autonomous vehicle may follow the zipper merge rule to achieve safety and public comfort.

VII.(p) Zipper Merge Rule

Zipper merge rule can be defined as the behavior of vehicles from the two merging lanes merging in a sequence of alternating vehicles from each of the lanes into the final lane. This rule may be used in low speed and heavy traffic conditions when merge in gaps are not large enough and vehicles are slow enough to stop within a single car length.

VII.(q) Two Lane Merge into One

If encountering two lanes merging into to one lane, an autonomous vehicle may execute regulatory change lane to the final merge-in lane from a pre-determined distance to the lane end point so that it can avoid being pushed to the end of the lane.

Lane Merge Sign Detection:

Autonomous vehicle may be able to detect a lane merge sign from a pre-determined distance and interpret which lane will be the final merge in lane.

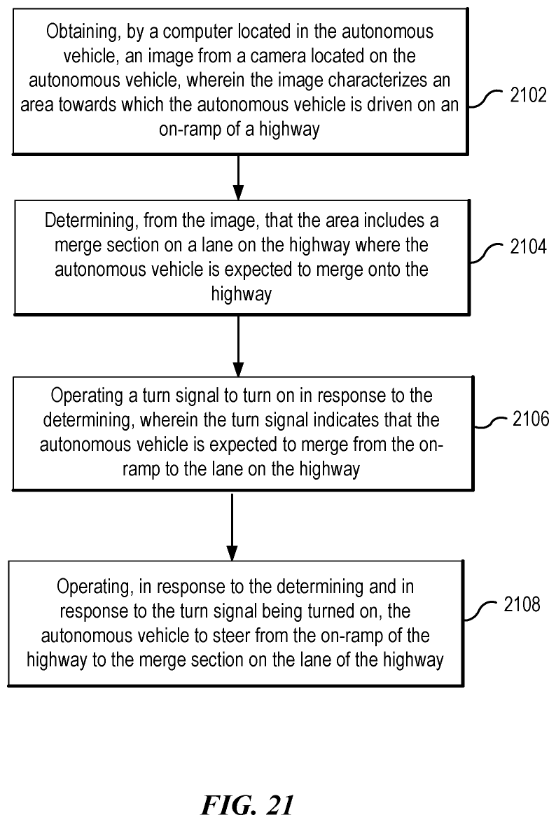

FIG. 21 shows an example flowchart of an autonomous driving operation performed by a vehicle to merge onto a highway. Operation 2102 includes obtaining, by a computer located in the autonomous vehicle, an image from a camera located on the autonomous vehicle, where the image characterizes an area towards which the autonomous vehicle is driven on an on-ramp of a highway. Operation 2104 includes determining, from the image, that the area includes a merge section on a lane on the highway where the autonomous vehicle is expected to merge onto the highway. Operation 2106 includes operating a turn signal to turn on in response to the determining, where the turn signal indicates that the autonomous vehicle is expected to merge from the on-ramp to the lane on the highway. Operation 2108 includes operating, in response to the determining and in response to the turn signal being turned on, the autonomous vehicle to steer from the on-ramp of the highway to the merge section on the lane of the highway.

In some embodiments, a total length of the merge section includes a length of the autonomous section, a first minimum distance allowed between the autonomous vehicle and a first vehicle expected to be located in front of the autonomous vehicle, and a second minimum distance allowed between the autonomous vehicle and a second vehicle expected to be located behind the autonomous vehicle. In some embodiments, the method further comprises performing a first determination that a length of the merge section is decreasing; and operating, in response to the first determination, the autonomous vehicle to apply brakes to stop the autonomous vehicle. In some embodiments, the method further comprises performing a second determination, in response to the determining, of a trajectory for the autonomous vehicle to follow from the on-ramp to the merge section, where the trajectory avoids having the autonomous vehicle enter a gore area. In some embodiments, the image is obtained by the autonomous vehicle upon determining an absence of another merge section from a prior image from the camera of another area towards which the autonomous vehicle is driven, and upon operating the autonomous vehicle to creep forward on the highway, where the prior image is obtained in time before a time when the image is obtained from the camera. In some embodiments, the autonomous vehicle operates to creep forward at a speed less than a pre-determined speed.

### VIII. Parallel Large Vehicles and Objects

An autonomous truck may behave appropriately when approaching, being approached, or driving in parallel to a large vehicle. Encompassed in this appropriate behavior is the ability to determine that another vehicle is indeed driving or may soon be driving parallel to the autonomous vehicle, as well as the risk associated with the situation if and when the other vehicle is parallel to the moving autonomous vehicle. The appropriate behavior executed by the autonomous truck can be determined on the assessed risk, which can be influenced by the duration of parallel driving, the overall speed of the autonomous vehicle and surrounding traffic, as well as the desired route or trajectory of the autonomous vehicle. Appropriate behavior may include biasing in the current lane, changing lanes, slowing down, and/or the like.

VIII.(a) Risk Assessment for Parallel Driving with an Adjacent Large Vehicle

Autonomous vehicle may define the acceptable time spent driving parallel with an adjacent large vehicle based on a risk model.

VIII.(b) Low-Risk Description

Autonomous vehicle may define a low-risk parallel driving situation as a situation that is not medium, high, or critical risk.

Lanes that have normal width and where bias is projected to be available for the duration of the parallel driving event may be considered low risk.

VIII.(c) Low-Risk Nominal Behaviors

In a low-risk parallel driving situation, autonomous vehicle may prefer an expected parallel driving time that is less than or equal to a certain time that may be pre-determined (e.g., 45 seconds, 50 seconds, 55 seconds, 60 seconds).

An autonomous vehicle may prefer actions with minimal deviations from what its planned actions would be in the absence of a parallel truck. For example, approximately 55 seconds is the time it may take to pass an adjacent truck with a speed differential 0.89 m/s (2 mph).

VIII.(d) Medium Risk Nominal Behaviors

In a medium risk parallel driving situation, autonomous vehicle may prefer an expected parallel driving time that is less than or equal to a certain time that may be pre-determined (e.g., 30 seconds, 36 seconds, 40 seconds).

For example, approximately 36 seconds may be the time it would take to pass an adjacent truck with a speed differential of e.g., 1.34 m/s (3 mph).

VIII.(e) Medium Risk Description

An autonomous vehicle may define a medium risk parallel driving situation as a situation that satisfies any one or more of the following: a situation that reduces or will reduce the number of outs by more than 1; a situation where the lanes are less than regulation width for the U.S. interstate highway system (3.6576 m, 12 feet); a situation where bias is projected to be unavailable for a portion of the parallel driving event; a situation where the roads are curved; a situation that may become higher risk if no action is taken; and a situation where there are or will be parallel large vehicles on both sides of autonomous vehicle may be considered medium risk.

VIII.(f) High-Risk Description

An autonomous vehicle may define a high-risk parallel driving situation as a situation that satisfies any one or more of the following: a situation where autonomous vehicle is currently parallel, or within a predetermined distance (e.g., 12 meters, 15 meters, 18 meters) of being parallel, to a swerving non-compliant large vehicle; and situation that may become critical risk if no action is taken.

VIII.(g) High-Risk Nominal Behaviors

In a high-risk parallel driving situation, autonomous vehicle may prefer not to enter the high-risk parallel driving zone unless the risk changes. If already in the zone, autonomous vehicle may prefer to transition out of the zone unless the risk changes.

Although the recommendations here are similar to the critical risk situation, autonomous vehicle may recognize that more immediate action is required in a critical risk scenario and that a high-risk scenario may involve a longer transition phase (such as biasing and decelerating for longer before lane changing, etc.).

An autonomous vehicle may avoid high risk parallel driving by any combination of the following actions: acceleration, deceleration, or lane change.

VIII.(h) Heavy Traffic Exception

Autonomous vehicle may avoid following the low-risk nominal behaviors or medium risk nominal behaviors (as described above) if traffic conditions are level of service D, E, or F, which are the worse to worst levels of service, as defined herein above.

VIII.(i) Non-Compliant Truck Description

In general, a non-compliant driver, and by extension a non-compliant truck, is a driver, NPC, or truck that does not comply to laws or regulations such as right-of-way or speed limits, or that change lanes erratically, cut in sharply, utilize gore areas or shoulders irregularly, and the like.

VIII.(j) Parallel Driving Time Prediction

An autonomous vehicle may predict the expected parallel driving time when approaching or being approached by a large vehicle in an adjacent lane.

VIII.(k) Description of Approaching or Being Approached

An autonomous vehicle may define approaching or being approached as any time when our current planned actions will result in autonomous vehicle being parallel to another large vehicle in an adjacent lane.

VIII.(l) Bias for Adjacent Truck Actions

Autonomous vehicle may bias, if available, when parallel with another large vehicle in an adjacent lane.

VIII.(m) Description of Bias Available

An autonomous vehicle may define bias as available when any of the following conditions are met: the autonomous vehicle is in an outer lane and there is no hard shoulder; the autonomous vehicle is in an outer lane and there are no cars merging onto the highway at that point; the autonomous vehicle is in an outer lane and there is no upcoming ELV; the autonomous vehicle is in an outer lane and there are no upcoming unknown objects or road debris on the shoulder; the autonomous vehicle is in a middle lane biasing beyond the lane boundaries, the lane change gap requirements are satisfied in the direction of the planned bias; and the autonomous vehicle is in a middle lane biasing within the lane boundaries, there are parallel NPCs on both sides, when limited bias is available.

VIII.(n) Description of Driving in Parallel

Autonomous vehicle may define driving in parallel as any time our system detects an overlap between autonomous vehicle and a large vehicle in an adjacent lane.

VIII.(o) Description of Large Vehicle

With respect to parallel large vehicle, an autonomous vehicle may classify a vehicle as a large vehicle if its length is greater than a pre-determined length (e.g., 6 meters, 7 meters, 8 meters) or if it is an oversized vehicle. An autonomous vehicle may avoid classifying a stock consumer vehicle (with no trailer attached) as a large vehicle.

For example, the length of a 2020 Ford® F450 Crew Cab—Long Wheel Base, which may be considered a particularly long consumer vehicle, can be 6.8 meters. We would want to avoid classifying this consumer vehicle as a large vehicle for these requirements, unless it has a trailer attached.

VIII.(p) Critical Risk Nominal Behaviors

In a critical risk parallel driving situation, an autonomous vehicle may get out of driving parallel through immediate swift action. In some embodiments, a quicker maneuver may be preferred over a slower one.

VIII.(q) Improvement in Number of Outs

For the low-risk and medium-risk scenarios only, if performing an action would not result in an expected improvement in our number of outs, autonomous vehicle may avoid performing the intended action.

In some embodiments, when an autonomous vehicle intends to change lanes, it may prefer to change lanes into an area that does not result in driving parallel to a large vehicle, if that option is available.

When an autonomous vehicle is driving parallel to a truck and intends to accelerate past, it may avoid doing so if accelerating would result in autonomous vehicle driving parallel to another truck (unless autonomous vehicle can get past both trucks in the time described in the low risk and medium risk requirements).

VIII.(r) De-Conflicting Risks Actions

When faced with a decision involving two distinct parallel driving situations with differing risk classifications, autonomous vehicle may adhere to the nominal behaviors of the higher risk classification.

VIII.(s) Description of an “Out”

Autonomous vehicle may define an “out” as any of the 8 zones that surround it: front, back, two sides, and four corners.

The order of importance for the zones may be as follows: back>two sides>front>four corners. That is to say that it is preferable to find an out to the rear of the autonomous vehicle, then to either side of the autonomous vehicle, then if none are available to either side to the front of the vehicle, and then to the four corners of the vehicle.

Having an empty back zone is important because autonomous vehicle can decelerate quickly if need be. Having open sides is important for changing lanes, however it is typically riskier to change lanes than it is to decelerate so therefore these zones may not be as important as the back zone. Having an open front is important, but accelerating a large truck typically takes a significant amount of time and therefore may not be as high in importance as some of the other zones. Lastly the corners are likely the least important because an autonomous vehicle cannot directly enter these zones without first passing through another zone.

VIII.(t) Critical Risk Description

Autonomous vehicle may define a critical risk parallel driving situation as any situation where an immediate safety liable risk exists.

Driving parallel when high winds may push autonomous vehicle into the adjacent large vehicle may be categorized as a critical risk.

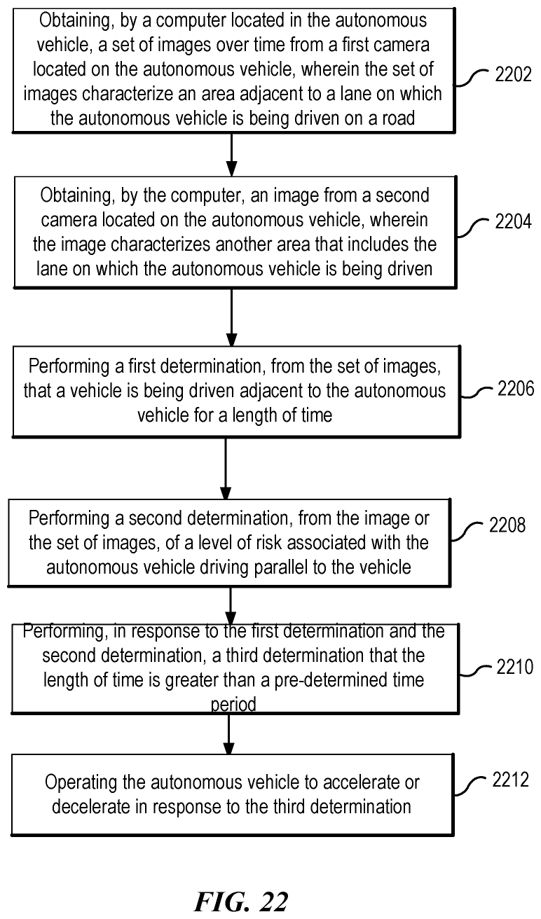

FIG. 22 shows an example flowchart of an autonomous driving operation performed by a vehicle to operate adjacent to another vehicle. Operation 2202 includes obtaining, by a computer located in the autonomous vehicle, a set of images over time from a first camera located on the autonomous vehicle, where the set of images characterize an area adjacent to a lane on which the autonomous vehicle is being driven on a road. Operation 2204 includes obtaining, by the computer, an image from a second camera located on the autonomous vehicle, where the image characterizes another area that includes the lane on which the autonomous vehicle is being driven. Operation 2206 includes performing a first determination, from the set of images, that a vehicle is being driven adjacent to the autonomous vehicle for a length of time. Operation 2208 includes performing a second determination, from the image or the set of images, of a level of risk associated with the autonomous vehicle driving parallel to the vehicle. Operation 2210 includes performing, in response to the first determination and the second determination, a third determination that the length of time is greater than a pre-determined time period. Operation 2212 includes operating the autonomous vehicle to accelerate or decelerate in response to the third determination. In some embodiments, the operating the autonomous vehicle to accelerate or decelerate includes sending instructions to the engine to accelerate or decelerate or sending instructions to an actuator in the brake unit to apply brakes.

In some embodiments, the performing the second determination includes: determining that the level of risk is low in response to determining from the image that that the lane has a width that is within a range of a pre-defined standard width of a standard lane and in response to determining that a trajectory is available for the autonomous vehicle to steer away from a center of the lane to one side of the lane, where the pre-determined time period is associated with the level of risk that is low. In some embodiments, the performing the second determination includes: determining that the level of risk is medium in response to: determining from the image that that the lane has a width that is less than a range of a pre-defined standard width of a standard lane, or determining that a trajectory is unavailable for the autonomous vehicle to steer away from a center of the lane to one side of the lane, or determining that the lane includes a curved portion; where the pre-determined time period is associated with the level of risk that is medium.

In some embodiments, the performing the second determination includes determining that the level of risk is high in response to determining from the set of images that the autonomous vehicle is parallel to or within a certain distance of being parallel to the vehicle that is swerving; and where the method further comprises operating, in response to the determining, the autonomous vehicle to accelerate or decelerate or change lanes in response. In some embodiments, the method further comprises determining, from at least one image from the set of images, that the vehicle has a length that is greater than a pre-determined length; and operating, in response to the determining, the autonomous vehicle to steer away from a center of the lane to one side of the lane.

IX. Pedestrian and/or Cyclist Interaction

An autonomous truck may identify, classify, and properly interact with pedestrians and cyclists. Each jurisdiction (e.g., state, country) may have its own regulations to be followed with any vehicle is operating around pedestrians and/or cyclists. Some of the regulations are high-level, such as avoidance of encroaching on cross-walks or bicycle lanes. Other regulations are more granular and depend on the relative position of the trajectories of the pedestrian or cyclist as well as the vehicle. For example, when a vehicle is turning from one road to another, and there is a dedicated lane for such a turn, the regulations may dictate how to interact with a cyclist in a bicycle lane or path that is adjacent to the turning lane. In order for an autonomous truck to operate properly, in accordance with applicable regulations, the compliance module (shown as 166 in FIG. 1) of the autonomous truck can determine which regulation(s) to apply based upon location and the type of interaction. In some embodiments, the compliance module can not only determine where the autonomous vehicle is located (e.g., based on location provided by a GPS device on the autonomous vehicle), but it can also identify a pedestrian and/of cyclist and can track the motions of the pedestrian/cyclist in relation to the roadway and lanes or specialized surrounding areas (e.g., cross-walk, side walk, bike lane).

IX.(a) Minimum Lateral Distance when Passing a Pedestrian/Cyclist

When passing a pedestrian/cyclist, an autonomous vehicle may maintain a minimum lateral distance of at least a pre-determined distance (e.g., 0.91 meters or 3 feet) from the widest point of autonomous vehicle (e.g., on a side of the autonomous vehicle facing away from the pedestrian) to the widest point of the pedestrian (e.g., on a side of the pedestrian facing away from the autonomous vehicle) until the entire tractor and trailer have passed the pedestrian/cyclist.

IX.(b) Do Not Penetrate Crosswalk With Pedestrians

The front bumper of an autonomous vehicle may not penetrate a crosswalk that is being crossed by a pedestrian or cyclist.

For example, a crosswalk in Arizona or Texas spans both directions of traffic, and in these states, an autonomous vehicle may not penetrate the crosswalk when a pedestrian or cyclist is on the half of the roadway in which autonomous vehicle is traveling.

In another example, for a crosswalk in California or New Mexico that spans both directions of traffic, an autonomous vehicle may not penetrate the crosswalk when a pedestrian or cyclist is on either half of the roadway.

IX.(c) Yield to Cyclists in Right Turn Lane

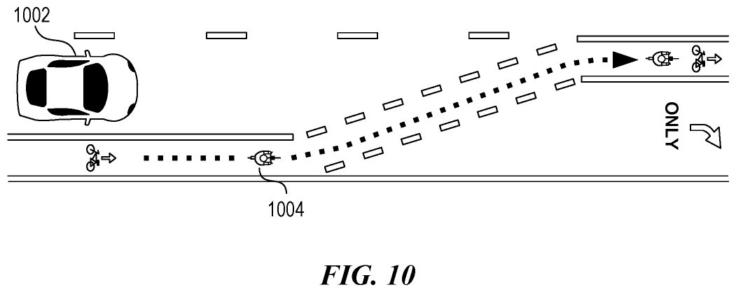

As shown in FIG. 10, an autonomous vehicle 1002 may yield to a cyclist 1004 when approaching a right turn only lane/drop lane.

IX.(d) Following Distance for Pedestrians/Cyclists

If an autonomous vehicle cannot pass a pedestrian or cyclist while travelling on local roads with the distance between the autonomous vehicle and pedestrian or cyclist, speed, or other safety constraints as described herein, an autonomous vehicle may maintain a following distance to the leading pedestrian or cyclist of at least a pre-determined amount and match the speed of the pedestrian or cyclist.

Autonomous vehicle may stop for pedestrians on the highway if unable to change lanes to avoid the pedestrian due to possible pedestrians being law enforcement officers.

IX.(e) Continuous Perception Distance for Pedestrians

On highway and local roads, the compliance module may be able to continuously and accurately detect a pedestrian or cyclist at a distance that is greater than or equal to autonomous vehicle's current stopping distance.

Although this perception distance represents a lower bound to detection, there may be other maneuvers that require a greater perception distance. Therefore, autonomous vehicle may adjust its continuous perception distance for pedestrians to satisfy the increased perception distance required by those other maneuvers.

IX.(f) Visibility Adjustment

When necessary, the system may adjust its speed such that it is capable of coming to a complete stop within the current visibility distance.

The visibility distance is the maximum distance at which a driver, including an autonomous driving system, of a vehicle can see and identify objects around the vehicle.

IX.(g) Horn Usage

An autonomous vehicle may determine that it is best to avoid using horns when driving adjacent to a cyclist. A sudden loud blast from a horn may startle the cyclist and cause them to swerve into traffic. Driving adjacent to a cyclist may be considered to be within 2 meters, 3 meters, 3.5 meters, or another suitable distance which may be altered depending on the volume of the horn of the autonomous vehicle.

IX.(h) Cyclist Hand Signals

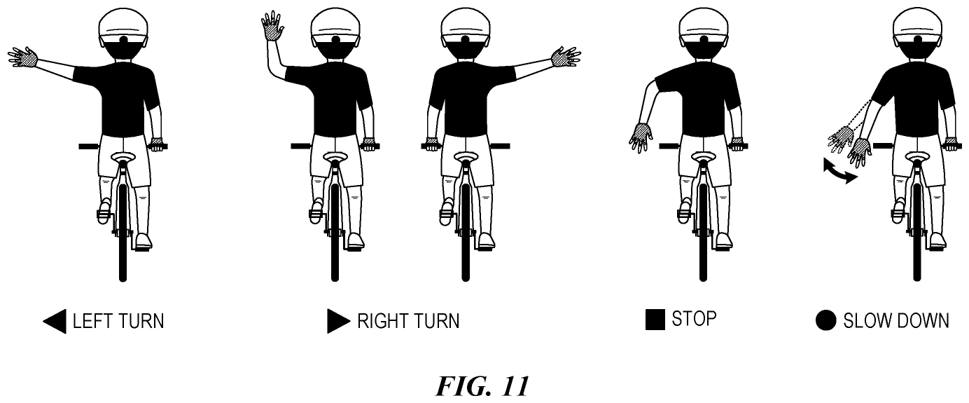

FIG. 11 shows an identification of hand signs and corresponding meaning determined by an autonomous vehicle so that the autonomous vehicle may react to cyclist hand signals. The autonomous driving system of the autonomous vehicle may utilize camera and other sensor data to determine the presence of a cyclist in conjunction with a computing module to identify the hand signals made by the cyclist. Knowledge provided by a map or mapping module on the autonomous vehicle may aid in identification of hand signals, by perhaps increasing the likelihood of a cyclist using hand signals to change directions or slow down. Alternatively, or additionally, an autonomous vehicle may transmit data to a remote operator at an oversight or control center for confirmation of a cyclist using hand signals, and the remote operator may transmit information back to the autonomous vehicle via communication modules at the oversight system and the autonomous vehicle, the transmitted information from the remote control operator or oversight system may include the type of signal, the type of action that should be taken by the autonomous vehicle, any changes of the trajectory of the autonomous vehicle and the like.

IX.(i) Do Not Pass Vehicle Waiting for Pedestrian to Cross

At a marked or unmarked crosswalk, an autonomous vehicle may not pass/overtake a stopped vehicle that is waiting for a pedestrian to cross.

IX.(j) Pedestrian Memory

The compliance module of the autonomous vehicle may record in memory the presence of a pedestrian or cyclist that later becomes fully or partially occluded from view.

IX.(k) Yield to Pedestrians

An autonomous vehicle may yield to pedestrians and cyclists that are intending to cross into the autonomous vehicle's path of travel at roundabouts, intersections, and marked or unmarked crosswalks.

IX.(l) Preferred Lateral Distance when Passing a Pedestrian/Cyclist

When passing a pedestrian/cyclist on a highway or local road, an autonomous vehicle may prefer to pass at a lateral distance of at least a pre-determined amount of meters (e.g., 3.66 meters or 1 standard lane width) from the widest point of autonomous vehicle to the widest point of the pedestrian until the tractor and trailer have fully passed the pedestrian/cyclist.

The behavior of an autonomous vehicle while passing a pedestrian/cyclist on a highway or local road, can be guided by a recommendation made by a department of transportation (e.g., Arizona department of transportation (ADOT)).

On detection of a pedestrian or cyclist on a shoulder or gore area of a highway, the compliance module of the autonomous vehicle may prefer for the autonomous vehicle to drive in lanes that are not adjacent to the shoulder/gore area.

IX.(m) Pedestrian Slow Down and Bias Strategy

On detection of a pedestrian or cyclist on a highway or local road, if an autonomous vehicle is unable to satisfy the preferred lateral distance requirement (e.g., distance from the autonomous vehicle to the pedestrian/cyclist), then it may slow down and bias away from the pedestrian/cyclist. For example, if the compliance module determines from a sensor data (e.g., image) from a sensor (e.g., camera) that a pedestrian or cyclist is located on a highway or on a local road, then the compliance module can send instructions to devices (e.g., brake system, steering system, etc.) on the autonomous vehicle's devices to show down and bias the autonomous vehicle (or cause the autonomous vehicle to move (e.g., steer) from approximately the center of the lane on the highway or road) away from the pedestrian or cyclist.

An autonomous vehicle may bias the max amount with relaxed lane boundaries away from the pedestrian/cyclist.

An autonomous vehicle may adjust its speed based on the proximity to the pedestrian/cyclist as outlined below:

TABLE 6

| Lateral Distance | Recommended Highway | Recommended Local |
|---|---|---|
| to Pedestrian | Max Passing Speed | Max Passing Speed |
| 3 to 6 feet | min (45 mph, 5 mph | min (25 mph, 5 mph |
| | less than speed limit) | less than speed limit) |
| 6 to 9 feet | min (55 mph, 5 mph | min (35 mph, 5 mph |
| | less than speed limit) | less than speed limit) |
| 9 to 12 feet | min (65 mph, 5 mph | min (45 mph, 5 mph |
| | less than speed limit) | less than speed limit) |
| 12+ feet | No adjustment needed | No adjustment needed |
| | (e.g., to the speed of the | (e.g., to the speed of the |
| | autonomous vehicle) | autonomous vehicle) |

When there is an emergency lane vehicle (ELV) in addition to a pedestrian, an autonomous vehicle's recommended max passing speed may be the minimum of (1) the value in the table above and (2) 5 mph less than the corresponding value from either Table 1 or Table 2, above, discussed with respect to emergency lane vehicle on highway or road.

IX.(n) Pedestrian Control Signal

An autonomous vehicle may yield right-of-way to a pedestrian crossing on a marked or unmarked crosswalk with a pedestrian control signal that indicates or symbolizes that a pedestrian can “walk”. The autonomous vehicle may utilize its sensors and detection modules or mapping and location information, or a combination of sensors and detection modules and mapping a location information to determine that a pedestrian may be crossing in a crosswalk, marked or unmarked, with a pedestrian control signal that indicates or symbolizes that a pedestrian may proceed to cross.

IX.(o) do not Collide with a Pedestrian

An autonomous vehicle may not collide with a pedestrian or cyclist even when the pedestrian or cyclist does not have the right-of-way.

IX.(p) Stopping Distance Prediction

An autonomous vehicle may be able to predict the distance it would take for it to come to a complete stop given its current operating and environmental conditions.

IX.(q) Do Not Follow Pedestrians on the Highway

An autonomous vehicle may avoid planning a trajectory that would result in autonomous vehicle driving directly behind a pedestrian or cyclist on the highway.

IX.(r) Partial Occlusion

An autonomous vehicle may be able to detect partially occluded pedestrians. The autonomous vehicle's partial occlusion detection may be benchmarked against partial occlusion detection by humans.

FIG. 16 shows an example flowchart of an autonomous driving operation performed by a vehicle operating on a road or highway that includes a pedestrian and/or a cyclist. Operation 1602 includes obtaining, by a computer located in the autonomous vehicle, an image from a camera located on the autonomous vehicle, where the image characterizes an area towards which the autonomous vehicle is driven on a lane on a road or a highway. Operation 1604 includes determining, from the image, that a pedestrian or a cyclist is located next to the lane on the road or the highway. Operation 1606 includes operating, in response to the determining, the autonomous vehicle to steer from a center of the lane to a first side of the lane that is away from the center of the lane and away from a location of the pedestrian or the cyclist. In some embodiments, the autonomous vehicle is operated to steer by sending instructions to one or more devices (e.g., one or more motors) in a steering system of the autonomous vehicle to steer the autonomous vehicle. Operation 1608 includes operating, in response to the determining, the autonomous vehicle to lower a speed of the autonomous vehicle to below a first threshold speed value in response to determining that a lateral distance from the autonomous vehicle to the pedestrian or the cyclist is within a first set of distances, and that a current speed of the autonomous vehicle is greater than the first threshold speed value. In some embodiments, the autonomous vehicle is operated to lower a speed by sending instructions to one or more devices (e.g., engine or one or more actuators of brake unit) to apply brakes or slow down the autonomous vehicle.

In some embodiments, the autonomous vehicle is caused to lower the speed of the autonomous vehicle by comparing the lateral distance from the autonomous vehicle to the pedestrian or the cyclist and the current speed of the autonomous vehicle to a table comprising a plurality of sets of distances and a plurality of threshold speed values, where the plurality of sets of distances include the first set of distances and a second set of distances that are greater than or equal to the first set of distances, where the plurality of threshold speed values include the first threshold speed value and a second threshold speed value that is greater than the first threshold value, and where the first set of distances and the second set of distances respectively correspond to the first threshold speed value and the second threshold speed value. In some embodiments, the first threshold speed value is a minimum of a first pre-determined speed value and a first speed value, the first speed value is obtained by subtracting a certain speed less from a speed limit, and the second threshold speed value is a minimum of a second pre-determined speed value and the first speed value.

In some embodiments, the method further comprises operating the autonomous vehicle to maintain the speed of the autonomous vehicle in response to determining that the lateral distance from the autonomous vehicle to the pedestrian or the cyclist is greater than a third set of distances that is greater than or equal to the second set of distances. In some embodiments, the method further comprises in response to determining, from the image, a presence of an emergency vehicle on the road or the highway: operating the autonomous vehicle to lower a speed of the autonomous vehicle to below a third threshold speed value in response to determining that the lateral distance from the autonomous vehicle to the pedestrian or the cyclist is within the first set of distances, and that the current speed of the autonomous vehicle is greater than the third threshold speed value, where the third threshold speed value is a minimum of the first threshold speed value and a maximum passing speed value.

In some embodiments, the maximum passing speed value is a certain speed less than a speed value, and where the speed value is based on at least a speed limit of the road or the highway and whether the autonomous vehicle is operating on either the road or the highway. In some embodiments, the method further comprises operating the autonomous vehicle to pass the pedestrian or the cyclist by maintaining a minimum lateral distance between the autonomous vehicle and the pedestrian or the cyclist, where the minimum lateral distance is a pre-determined distance from one side of the autonomous vehicle that is farthest from the pedestrian or the cyclist to the location of the pedestrian or the cyclist. In some embodiments, the pedestrian or the cyclist is determined from an image when a first distance from a first position of the autonomous vehicle to a second position of the pedestrian or the cyclist is greater than or equal to a stopping distance of the autonomous vehicle, and where the stopping distance is a second distance needed by the autonomous vehicle to come to a complete stop.

### X. Turn Signals

An autonomous truck may properly use turn signals to safely traverse a route. Proper use of a turn signal may require recognition of any applicable regulations and acting in accordance with those regulations. Proper use of turn signals can also include recognizing that a turn is coming up in the autonomous vehicle's trajectory and activating and terminating the signaling in a way that effectively alerts surrounding drivers and vehicles. More complicated maneuvers or combinations of maneuvers may require more detailed sub-features or tasks for execution or fulfillment of this features. Proper use of turn signals may also include a recognition of when not to use a turn signal or when to terminate a turn signal. For example, when a lane change or turn is no longer desired, a turn signal may be terminated. Alternatively, or additionally, when an autonomous truck wants to preclude a following vehicle from entering a gap into which the truck intends to merge, early initiation of the turning signal may be prohibited.

X.(a) Signal State Integrity

Turn signals may only be used to signal an intent to turn.

When autonomous vehicle is in the through lane for a lane reduction (e.g., 2-to-1 merge), autonomous vehicle may not engage the turn signals.

Autonomous vehicle may not use turn signals as a tool to inhibit passing traffic if autonomous vehicle does not intend to turn.

X.(b) Pre-Mapped Turn Signal Usage—Deceleration

If the turn signal is not already engaged, an autonomous vehicle may turn on the appropriate turn signal as soon as it starts decelerating as a direct result of an upcoming pre-mapped turning maneuver (e.g., if the compliance module determines that the autonomous vehicle is decelerating when a location of the autonomous vehicle is within a pre-determined distance of another location where the autonomous vehicle is to perform the turning maneuver).

This requirement may not apply when the deceleration is a direct result of something other than the upcoming maneuver, such as heavy traffic.

X.(c) Faulty Signal

If the compliance module on an autonomous vehicle detects that the turn signals are not working, the autonomous vehicle may not be driven until repaired, unless the autonomous vehicle is already on the road, in which case the autonomous vehicle may refer to the designated MRC (minimum risk condition) maneuver.

X.(d) Chained Turning Maneuvers—Same Direction

For a timeline that includes a turn signal engaged for a turning maneuver as the turn signal engagement period, when two or more back-to-back turning maneuvers have overlapping turn signal engagement periods, and the maneuvers are in the same direction (e.g., lane change to the right followed by a right intersection turn), the autonomous vehicle may proceed to keep the appropriate turn signal engaged until the last maneuver is complete.

X.(e) Description of Turning Maneuver

A turning maneuver may be defined as a lane change, highway merge, highway exit, intersection turn, or any other planned action that would result in autonomous vehicle driving in a different lane than its current lane.

X.(f) Turn Signals when Maneuver is Canceled

When a turning maneuver is canceled, an autonomous vehicle may turn off the turn signals, unless the canceled maneuver is immediately retried (e.g., attempted again).

X.(g) Unmapped Turn Signal Usage

For turning maneuvers that are not pre-mapped, an autonomous vehicle may turn on the appropriate turn signal as soon as the intent for the maneuver is known, unless otherwise specified. An autonomous vehicle may turn off the turn signal as soon as the maneuver is complete, unless another turning maneuver causes the autonomous vehicle to keep the signal engaged.

An autonomous vehicle may signal continuously for a pre-determined number of meters (e.g., at least 30.5 meters (100 feet)) before turning as outlined by Arizona law, New Mexico law, and Texas law.

Examples of turning maneuvers that are not pre-mapped include lane changes for slow moving vehicles, emergency lane vehicles (ELVs), and avoiding bad merge interactions.

X.(h) Pre-Mapped Turn Signal Usage

For turning maneuvers that the compliance module of an autonomous vehicle knows in advance it will have to perform, such as due to knowledge of the map, the autonomous vehicle may proactively engage the appropriate turn signal prior to arriving at the point where the maneuver may begin. Then the autonomous vehicle may turn off the turn signal as soon as the maneuver is complete, unless another turning maneuver causes autonomous vehicle to keep the signal engaged.

X.(i) Chained Turning Maneuvers—Different Directions

In a scenario in which a turn signal is engaged for a turning maneuver as the turn signal engagement period, when two or more back-to-back turning maneuvers have overlapping turn signal engagement periods, and the maneuvers are in opposite directions (e.g., right intersection turn followed by a lane change to the left), then the autonomous vehicle may fully complete the first maneuver before changing signals for the second maneuver.

X.(j) Completing a Turning Maneuver

The autonomous driving system of an autonomous vehicle may mark a turning maneuver as complete when autonomous vehicle is in the planned destination for that maneuver.

X.(k) Turning Beyond an Intersection

When autonomous vehicle plans to do a turning maneuver beyond an intersection, it may wait until its rear bumper has passed the middle of the intersection before turning on the turn signal. Turning on the signals too early in this situation may cause other drivers to pull into autonomous vehicle's path.

X.(l) Completing a Turning Maneuver—Intersection Turns With a Slip Lane

When turning right at an intersection with a slip lane, an autonomous vehicle may mark the maneuver as complete when the tractor and trailer have passed the apex of the slip lane.

X.(m) Pre-Mapped Turn Signal—Lane Change

When an autonomous vehicle is approaching a pre-mapped lane change, autonomous vehicle may engage the turn signals when it is a predetermined distance or time to collision (TTC) (e.g., 150 meters (˜500 feet) or 5 seconds when traveling at 75 mph) from the starting point of the lane change.

X.(n) Pre-Mapped Turn Signal—Intersection Turn

When an autonomous vehicle is approaching a pre-mapped intersection turn, the autonomous vehicle may engage the turn signals when it is predetermined distance (e.g., 60 meters (˜200 feet)) from the intersection's stop line.

X.(o) Completing a Turning Maneuver—Lane Change and Highway Merge

When turning for a lane change or highway merge, an autonomous vehicle may mark the maneuver as complete when the tractor and trailer are completely in the target lane.

X.(p) Pre-Mapped Turn Signal—Lane Split

When an autonomous vehicle is approaching a pre-mapped lane split and intends to enter the ramp on the lane adjacent to the lane split's gore point, the autonomous vehicle may engage the turn signals when it is a predetermined distance (e.g., 150 meters (˜500 feet)) from that gore point.

X.(q) Completing a Turning Maneuver—Intersection Turns Without a Slip Lane

When turning (1) left at an intersection or (2) right at an intersection without a slip lane, an autonomous vehicle may mark the maneuver as complete when the tractor and trailer are no longer in the intersection and are completely in the target lane.

X.(r) Completing a Turning Maneuver—Highway Exits, Local Exits, and Lane Splits

When turning for a highway exit, local exit, or a lane split, an autonomous vehicle may mark the maneuver as complete when the rear end of the trailer has passed the gore point for the exit or lane split.

X.(s) Pre-Mapped Turn Signal—Highway Exit

When an autonomous vehicle is approaching a pre-mapped exit off of the highway, the autonomous vehicle may engage the turn signals when it is a predetermined distance (e.g., 200 meters (˜650 feet or 6 seconds when traveling at 75 mph)) from the gore point.

X.(t) Pre-Mapped Turn Signal—Highway Merge

When an autonomous vehicle is approaching a pre-mapped merge onto a highway and is in the lane adjacent to the gore point, the autonomous vehicle may engage the turn signals when it is a predetermined distance (e.g., 300 meters (˜1000 feet or 10 seconds when traveling at 75 mph)) from the gore point.

When the merge ramp is smaller than a predetermined distance (e.g., 200 meters, 250 meters, 300 meters) and an autonomous vehicle is in the situation just described, the autonomous vehicle may engage the appropriate turn signal only when the tractor and trailer are fully on the ramp.

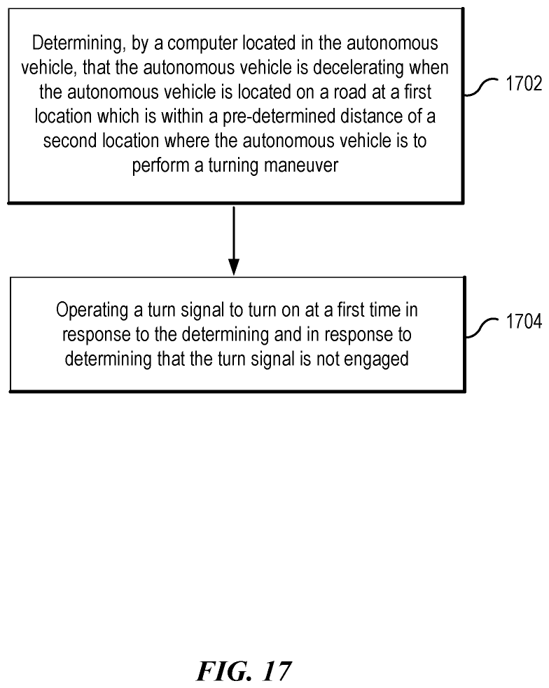

FIG. 17 shows an example flowchart of an autonomous driving operation performed by a vehicle to operate a turn signal. Operation 1702 determining, by a computer located in the autonomous vehicle, that the autonomous vehicle is decelerating when the autonomous vehicle is located on a road at a first location which is within a pre-determined distance of a second location where the autonomous vehicle is to perform a turning maneuver. Operation 1704 includes operating a turn signal to turn on at a first time in response to the determining and in response to determining that the turn signal is not engaged. In some embodiments, the operating the turn signal includes sending instruction to the turn signal to turn on.

In some embodiment, the method further comprises sending instructions that cause the autonomous vehicle to steer along a trajectory to a side of the road and to apply brakes in response to determining that the turn signal is not working or operating. In some embodiment, the turn signal is caused to turn on at the first time for a first length of time, and where the method further comprises: performing a first determination that first length of time overlaps with a second length of time associated with a second turning maneuver that comes after the turning maneuver; performing a second determination that the second turning maneuver is in a same direction as the turning maneuver; and operating, in response to the first determination and the second determination, the turn signal stay turned on during the first length of time and the second length of time. In some embodiment, the pre-determined distance is based on a law or regulation of an area or state in which the autonomous vehicle is operating.

In some embodiment, the method further comprises performing a determination that the second location where the autonomous vehicle is to perform the turning maneuver is adjacent to an intersection, within a certain distance of the intersection, or past the intersection; and where the turn signal is caused to turn on in response to the determining, in response to determining that the turn signal is not engaged, and in response to determining that a rear of the autonomous vehicle is past a middle of the intersection.

### XI. Stopped Vehicle

XI.(a) Key Terms

Stopped vehicle: A vehicle that may be stationary or unmoving for any duration of time. A compliance module on an autonomous vehicle can determine whether a vehicle is stationary or unmoving based on image processing performed on images obtained by a camera located on the autonomous vehicle.

Abnormal Stopped Vehicle: A stopped vehicle that can be stopped for reasons unrelated to traffic congestion or regulatory signs/signals. Alternatively, or additionally, a stopped vehicle that may be moving but is not and is stopped for reasons unrelated to traffic congestion or regulatory signs/signals. For example, a stopped vehicle at a traffic light that is on red is not an abnormal stopped vehicle, whereas an emergency vehicle stopped in the middle of the highway for an emergency is an abnormal stopped vehicle. A compliance module on an autonomous vehicle can determine whether a vehicle (e.g., an NPC vehicle) is an abnormal stopped vehicle by performing image processing on image(s) obtained by a camera and determining that there is no traffic congestion indicated in the image or that there is an absence of traffic signals or traffic signs in the image(s).

Protruding Abnormal Stopped Vehicle: An abnormal vehicle that intersects more than one lane, including shoulders; this type of stopped vehicle protrudes into at least one other lane. An abnormal stopped vehicle that intersects more than one lane (including shoulders). For example, this type of stopped vehicle protrudes into at least one other lane.

Abnormal Stopped Vehicle Bounding Region: The region that contains all abnormal stopped vehicles that are within close vicinity of each other. If there is only one abnormal stopped vehicle, then the bounding region is equivalent to the space taken up by that vehicle. Vehicle s may be within a pre-determined number of meters (e.g., 20 meters, 30 meters, 40 meters) longitudinally of each other and a certain distance (e.g., 7.0 meters, 7.3 meters, 7.5 meters) laterally to be considered within the same bounding region.

Traffic Jam: A line of road traffic at, or near, a standstill. A threshold speed for all lanes of traffic and/or a threshold maximum distance between each consecutive vehicle may be utilized to further define a traffic jam.

To be considered a traffic jam, the average speed of vehicles in all lanes within a pre-determined number of meters (e.g., 125 meters, 150 meters, 175 meters, 200 meters) of autonomous vehicle may be traveling less than a threshold speed (e.g., 8 mph, 10 mph, 12 mph).

To be considered a traffic jam, the lanes that are visible may contain a line of vehicles with an average bumper to bumper distance less than a pre-determined number of meters (e.g., 8 meters, 9 meters, 10 meters, 12 meters, 15 meters) between each consecutive vehicle.

XI.(b) Min Lateral Distance to Pass Stopped Vehicle (STV)

Autonomous vehicle may slow down and pass an abnormal stopped vehicle bounding region only if autonomous vehicle can maintain a lateral distance of at least pre-determined threshold value with the bounding region.

The pre-determined threshold value distance may be a tunable parameter with a nominal value of any of 1.0 meters, 1.2 meters, 1.3 meters, 1.4 meters, 1.5 meters.

XI.(c) Max Passing Speed—Stopped Vehicle—Local

The max local road passing speed when driving within the preferred lateral distance of an abnormal stopped vehicle bounding region may be a pre-determined threshold speed below the speed limit. The preferred lateral distance may be a pre-determined lateral distance.

The pre-determined threshold speed may be a tunable parameter with a nominal value of any of 8 MPH, 10 MPH, 12 MPH, 15 MPH, 18 MPH, and 20 MPH.

XI.(d) Stopped Vehicle Lane Change Reaction Distance

If a lane change is required for an abnormal stopped vehicle bounding region, autonomous vehicle may react no later than the distance required to successfully change lanes before reaching the bounding region or a pre-determined threshold minimum distance, whichever distance is greater.

The pre-determined threshold minimum distance may be a tunable parameter with a nominal value of any of 200 meters, 250 meters, 275 meters 300 meters, 325 meters, or 350 meters.

XI.(e) Preferred Lateral Distance to Stopped Vehicle

An autonomous vehicle may prefer to drive with a lateral distance of at least pre-determined threshold distance measured from the widest point of the autonomous vehicle combination to the widest point of the abnormal stopped vehicle bounding region. The pre-determined minimum lateral distance may be a tunable parameter with a nominal value of any of 8 feet, 10 fee, 12 feet, 14 feet, or 15 feet.

XI.(f) Slow Down and Pass Strategy for Stopped Vehicles

When unable to satisfy the preferred lateral distance to an abnormal stopped vehicle bounding region, the autonomous vehicle may slow down and pass the bounding region within the preferred lateral distance only if a collision can be avoided.

XI.(g) Lane Change Priority—Lanes Not Intersected by STV

The lane change priority when within a pre-determined threshold distance but not in lanes that are penetrated by an abnormal stopped vehicle bounding region may be non-critical safety. A pre-determined minimum lateral distance may be a tunable parameter with a nominal value of any of 8 feet, 10 fee, 12 feet, 14 feet, or 15 feet.

XI.(h) Lane Change Priority—Lanes Intersected by STV

The lane change priority when in lanes that are penetrated by an abnormal stopped vehicle bounding region may be critical safety.

XI.(i) Stopped Emergency Vehicle

If the abnormal stopped vehicle bounding region contains an emergency vehicle, autonomous vehicle may follow the requirements from the Emergency Vehicles decision section in this patent document.

XI.(j) Unable to Pass Stopped Vehicle

When unable to drive in a lane that is not penetrated by an abnormal stopped vehicle bounding region, an autonomous vehicle may come to a complete stop before reaching the bounding region and perform a MRC maneuver after a pre-determined number of seconds have elapsed. This type of behavior may be an option to changing lanes or passing a stopped vehicle.

If an autonomous vehicle is driving in a lane that is penetrated by an abnormal stopped vehicle and the autonomous vehicle is unable to change lanes, the autonomous vehicle may come to a complete stop before reaching the stopped vehicle and the operations team (e.g., chase vehicle operators), an oversight system, or a remote control operator may issue a command for the autonomous vehicle to perform a minimal risk condition maneuver (e.g., a MRC command).

XI.(k) Max Passing Speed—Stopped Vehicle—Highway

The max highway passing speed when driving within the preferred lateral distance of an abnormal stopped vehicle bounding region may be a tunable parameter with a pre-determined nominal value below the speed limit.

The max highway passing speed when driving within the preferred lateral distance of an abnormal stopped vehicle bounding region may be a pre-determined velocity below the speed limit. The pre-determined velocity may be a tunable parameter with a nominal value of any of 15 MPH, 18 MPH, 20 MPH, 22 MPH, or 25 MPH.

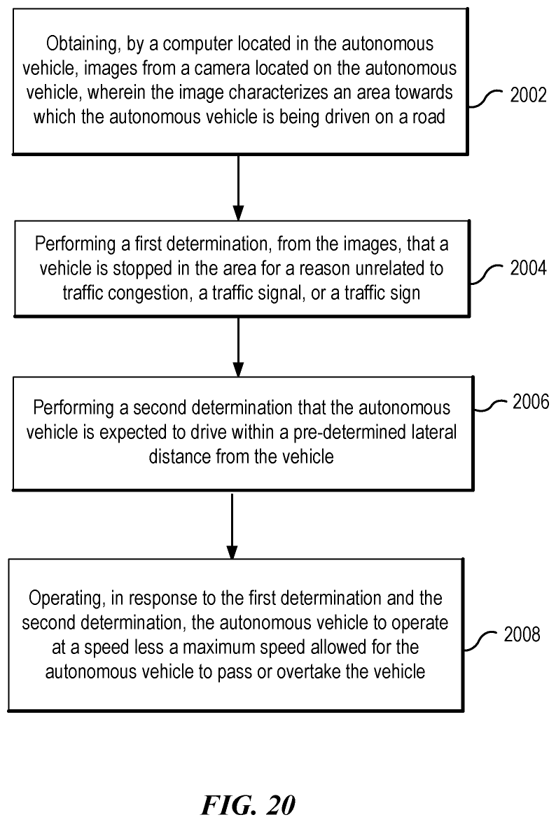

FIG. 20 shows an example flowchart of an autonomous driving operation performed by a vehicle to operate on a road with a stopped vehicle. Operation 2002 includes obtaining, by a computer located in the autonomous vehicle, images from a camera located on the autonomous vehicle, where the image characterizes an area towards which the autonomous vehicle is being driven on a road. Operation 2004 includes performing a first determination, from the images, that a vehicle is stopped in the area for a reason unrelated to traffic congestion, a traffic signal, or a traffic sign. Operation 2006 includes performing a second determination that the autonomous vehicle is expected to drive within a pre-determined lateral distance from the vehicle. Operation 2008 includes operating, in response to the first determination and the second determination, the autonomous vehicle to operate at a speed less a maximum speed allowed for the autonomous vehicle to pass or overtake the vehicle. In some embodiments, the operating the autonomous vehicle to operate at the speed less than the maximum speed allowed includes sending instructions to an actuator in the brake unit to apply brakes or sending instructions to engine to reduce speed.

In some embodiments, the method further comprises operating the autonomous vehicle to steer from a first lane to a second lane adjacent to the first lane at a distance from the vehicle that is greater than or equal to the pre-determined lateral distance from the vehicle. In some embodiments, the method further comprises performing a third determination that the vehicle is stopped in a lane that is same as that of the autonomous vehicle; performing a fourth determination that the autonomous vehicle is unable to change lanes; and operating, in response to the third determination and the fourth determination, the autonomous vehicle to apply brakes to stop the autonomous vehicle. In some embodiments, the maximum speed is based on whether the autonomous vehicle is operating on a local road or a highway.

### XII. Speed Control

XII.(a) Speed Control—Obey Speed Limits

At all times, an autonomous vehicle may drive at or below the posted speed limit.

XII.(b) Speed Control—Obey Speed Limits—Night Time Speed

When driving after the sun has set, an autonomous vehicle may obey any nighttime specific speed limits.

XII.(c) Speed Control—Obey Contract Speed Limit

At all times, an autonomous vehicle may drive at or below any contract speed limits that are in place.

A contract speed limit is a limit that is set on the autonomous vehicle system's maximum speed, typically dictated by the terms of a contract with a partner or agreed upon by a set of stakeholders.

XII.(d) Speed Adjustments for Control of autonomous vehicle

An autonomous vehicle may maintain the posted speed limit (or less) with a reduction from the current speed as needed for control. For example, when the autonomous driving system determines that the weather or road conditions do not permit the autonomous vehicle to operate at the posted speed limit because the autonomous vehicle would be in danger of losing control or not having a sufficient distance between it and a NPC vehicle ahead, then the current speed of the autonomous vehicle may be reduced from the posted speed limit.

XII.(e) Detect all Speed Limit Signs

An autonomous vehicle may be able to detect and classify all speed limit signs, including signs on local roads, highways, construction zones, and entry and exit ramps. This detection and classification may be done by the autonomous vehicle using data acquired by the suite of sensors aboard the autonomous vehicle, as well as computing modules on the autonomous vehicles configured to identify speed limit signs based on any of: sign color, overall sign shape, and the reading of icons or words on the sign. Alternatively, or additionally, a map or map database may have areas of changing speed limit identified, or areas of construction or other types of temporary speed limit changes identified, and the autonomous driving system may be more alert in those areas to evaluate signs for speed limit postings.

XII.(f) Increase in Speed Limit—Max Acceleration

When approaching an increase in the speed limit, an autonomous vehicle may proactively speed up to the targeted speed using an acceleration rate under a pre-determined threshold value. The pre-determined threshold value for an acceleration rate may optimize for best fuel efficiency, unless the autonomous vehicle is behind schedule and needs to prioritize route arrival performance.

XII.(g) Limit Acceleration and Deceleration as Needed for Control

Under all speed adjustments, an autonomous vehicle may set limits on the acceleration and deceleration to ensure the tractor and trailer do not destabilize and tip over, sway, or slip. The autonomous vehicle may determine orientation of itself using sensors including one or more inertial measurement unit (IMU), data obtained by cameras and other sensor, and the like to determine not only the current orientation of the autonomous vehicle, but also so predict possible changes to the orientation of the autonomous vehicle based on a possible loss of control due to changes in the speed of the autonomous vehicle.

XII.(h) Decrease in Speed Limit—Engine Braking Preferred

When approaching a decrease in the speed limit, an autonomous vehicle may proactively slow down to the targeted speed using engine braking only, unless additional deceleration is required for an evasive maneuver. Engine braking may be accomplished in an autonomous vehicle with an internal combustion engine by employing any of: J-brakes (i.e., Jakes brakes), cylinder deactivation, or down-shifting of gears in the transmission.

XII.(i) Uphill Grade—Power Adjustment under Load

When going uphill, an autonomous vehicle may provide additional power as necessary to maintain the targeted speed under different trailer loads.

XII.(j) Precautionary Slow Down—T Intersection

When traveling in the through lane directly perpendicular to the non-through lane of a T-intersection, an autonomous vehicle may have a precautionary slow down (engine braking only) of no more than a pre-determined number of mph under the speed limit, such as 5 mph under the speed limit, 10 mph under the speed limit, 15 mph under the speed limit, and including 20 mph under the speed limit, if there is a vehicle stopped or approaching in the non-through lane.

XII.(k) Curved Roads and Turns—Post-Apex Behavior

When on a curved road or intersection turn, an autonomous vehicle may speed up after passing the apex of the curve/turn with a ramp up value to ensure smooth acceleration and deceleration.

XII.(l) Precautionary Slow Down—Signalized Intersection

When approaching a signalized intersection, an autonomous vehicle may have a precautionary slow down starting a pre-determined distance before the intersection, such as 90 meters away from the intersection, 100 meters away from the intersection, 110 meters from the intersection, including 120 meters from the intersection.

An autonomous vehicle may have a max passing speed equal to the posted speed limit or up to 50 mph at the pre-determined distance away from the intersection.

XII.(m) Map—Update Speed Limits

The map used by the autonomous vehicle may update the speed limit information when new speed limit signs or speed limit signs with updated limits are encountered by the autonomous vehicle.

XII.(n) Map—Speed Limit Info

The map used by an autonomous vehicle may contain speed limit information for all mapped routes.

XII.(o) Engine Braking for Efficiency

An autonomous vehicle may prefer to use engine braking when seeking a gap to lane change into for efficiency lane change intentions or intentions of lower priority.

XII.(p) Downhill Grade—Engine Braking Preferred

When going downhill and deceleration is necessary, an autonomous vehicle may prefer to use engine braking.

XII.(q) Curved Roads and Turns—Pre-Apex Behavior

When approaching or on a curved road or intersection turn, autonomous vehicle may slow down, preferably using engine braking, before reaching the apex of the curve with a ramp up value that ensures smooth acceleration and deceleration.

XII.(r) Speed Control—Obey Speed Limits—Ramps

An autonomous vehicle may obey any speed limits that are posted on an on-ramp or off-ramp when merging on or off a highway.

XII.(s) Speed Limit Sign Road Association

An autonomous vehicle may associate speed limit signs to the correct road structure (e.g., ramp speed limits vs highway speed limits). For example, a speed limit sign that is on an off-ramp, but still visible from the highway, may be associated with the ramp and not the highway.

XII.(t) Oversight—Update Speed Limits

When new speed limit signs or speed limit signs with updated limits are encountered, an autonomous vehicle may communicate the information to an oversight system, including to a remote control operator associated with the oversight system, which may be responsible for communicating the updated speed limit information to the rest of the fleet.

XII.(u) Speed Control—Speed Limit Timing

An autonomous vehicle may be at or below the speed limit by the time the frontmost point of the autonomous vehicle combination reaches the speed limit sign.

XII.(v) Engine Braking for Following Distance

An autonomous vehicle may prefer to use engine braking when growing or maintaining a following distance gap to another vehicle.

XII.(w) Speed Control—Obey Speed Limits—Night-Time Speed

When driving after the sun has set, an autonomous vehicle may obey any nighttime specific speed limits

XII.(x) Map—Speed Limit Info

The map used by the autonomous vehicle may contain speed limit information for all mapped routes.

XII.(y) Engine Braking for Efficiency Lane Changes

An autonomous vehicle may prefer to use engine braking when seeking a gap to lane change into for efficiency lane change intentions or intentions of lower priority.

XII.(z) Downhill Grade—Engine Braking Preferred

When going downhill and deceleration is necessary, an autonomous vehicle may prefer to use engine braking.

XII.(aa) Increase in Speed Limit—Optimal Acceleration

After passing a speed limit sign with an increased limit, an autonomous vehicle may speed up to the targeted speed using an acceleration rate that optimizes for best fuel efficiency, unless autonomous vehicle is behind schedule and needs to prioritize route arrival performance.

In some implementations, an oversight system, including a remote control operator associated with an oversight system, may provide guidance when greater acceleration is needed.

XII.(ab) Speed Control When Approaching Signalized Intersections

When approaching a local signalized intersection, an autonomous vehicle may reduce its speed based a max speed equal to the posted speed limit or up to 50 mph. An autonomous vehicle may reach the target speed at least a pre-determined distance before the intersection, such as 90 meters away from the intersection, 100 meters away from the intersection, 110 meters from the intersection, including 120 meters prior to the stop line of the intersection, as measured from autonomous vehicle's front bumper to the stop line.

An autonomous vehicle may prefer to use engine braking or coasting to accomplish the required deceleration.

### XIII. Hills

XIII (a) Brake Control

An autonomous vehicle may prioritize the usage of engine brakes over foundation brakes (e.g., disk brakes, drum brakes at each axel or each wheel) to preserve the effectiveness of foundation brakes and to prevent over heating of the foundation brakes.

XIII (b) Hilly Road Detection

An autonomous vehicle may be able to detect when the autonomous vehicle is driving on hilly roads based on the gradient using onboard sensors. Alternatively, or additionally, information regarding the change of road gradient may be marked on a map utilized by the autonomous vehicle, and the location of the autonomous vehicle in conjunction with the mapping data may confirm the detection of changes of vehicle orientation corresponding to a road gradient.

XIII (c) Runaway Ramps

In the event of brake fade or failure, an autonomous vehicle may slow down and stop using a runaway ramp.

XIII (d) Hilly Road Sign Recognition

An autonomous vehicle may be able to recognize signs that indicate hilly roads.

XIII (e) Engine Brake Prohibition

If a “NO ENGINE BRAKE” sign is encountered, an autonomous vehicle may not engage engine brakes for a minimum of a pre-determined threshold distance.

XIII (f) Lane Change Avoidance

An autonomous vehicle may avoid all types of efficiency and lower priority lane changes when driving on hilly roads.

XIII (g) Speed Control

An autonomous vehicle may select an appropriate speed when driving on hilly roads to prevent the tipping, swaying or slipping of the trailer.

An autonomous vehicle may consider the steepness of the gradient, the curvature of the road, the road traction condition, the prevailing weather condition, visibility condition as well as the weight and center of gravity of autonomous vehicle and the trailer.

XIII (h) Contact operator

If autonomous vehicle is in the runaway ramp and has come to a stop, autonomous vehicle may remain stationary and contact an operator.

XIII (i) Occupied Runaway Ramps

When a runaway ramp is occupied by another vehicle, an autonomous vehicle may still use the runaway ramp but bias to avoid the vehicle that is already on the runaway ramp.

XIII (j) Mapping

An autonomous vehicle may have hilly roads and known runaway ramps mapped out for navigation use.

XIII (k) Rolling Backwards

An autonomous vehicle may avoid rolling backwards when stopped or starting from a stop on a hilly road.

XIII (l) Runaway Ramp Identification

An autonomous vehicle may be able to identify runaway ramps based on pre-mapped locations and road signs.

XIII (m) Right Lane Preference

An autonomous vehicle may drive on the right lane when on hilly roads unless for evasive maneuvers or avoiding ELVs (e.g., end-of-life vehicles or disabled vehicles).

XIII (n) Hilly Road Description

Hilly roads may be defined as roads with a gradient of more than a pre-determined amount (e.g., 2%, 3%, 5%, 6%, etc.).

XIII (o) Runaway Procedure

When an autonomous vehicle is unable to come to a stop due to brake fade or failure, the autonomous vehicle may engage maximum engine braking, turn the hazard lights on and use the horn to warn other road users. An autonomous vehicle may change lanes to the rightmost lane at the first opportunity possible to enable the usage of a runaway ramp when available.

XIII (p) Hazard Lights

Unless in a traffic jam, an autonomous vehicle may turn on hazard lights on hilly roads if autonomous vehicle is driving more than a pre-determined threshold amount (e.g., 10, mph, 15 mph, 20 mph, 25 mph. 30 mph, etc.) below the speed limit or if autonomous vehicle is driving at a speed of less than a pre-determined threshold level (e.g., 35 mph, 40 mph, 45 mph, 50 mph, etc.).

### XIV. Highway Exits

The compliance module of the in-vehicle control computer of an autonomous vehicle can perform image processing on traffic signs to identify information indicated by the traffic sign as further explained in this section.

XIV.(a) Backed up Highway Exit Merge-in

When a highway exit is backed up and an autonomous vehicle was not able to join the line at the end, the autonomous vehicle may slow down to no slower than a pre-determined threshold amount below the average highway traffic speed to seek for a gap to merge in. If autonomous vehicle is unable to merge in, autonomous vehicle may use the alternative route.

XIV.(b) Backed up Highway Exit

When a highway exit is backed up, an autonomous vehicle may be able to detect the line of NPCs in the exit lane and slow down to join at the end of the line.

XIV.(c) Stay in Exit Lane

An autonomous vehicle may keep in the exit lane for a minimum pre-determined distance before exit point. The minimum pre-determined distance before an exit point may be approximately 800 meters (0.5 miles), 1200 meters (0.75 miles), 1600 meters (1 mile), or 2000 meters (1.25 miles).

XIV.(d) Multi-Lane Exit

An autonomous vehicle in a multi-lane exit may choose to drive in a lane that is most appropriate for the next part of the journey after getting off of the off-ramp.

XIV.(e) Closed Exit

When an exit that an autonomous vehicle is intending to use is closed, the autonomous vehicle may rejoin the highway and use an alternative route.

XIV.(f) Exit Zone—Description

The exit area may be defined as the area that starts with where the offramp lane start to split away from the highway and ends with the separation of the offramp from the highway by the means of a solid line, gore area, hard or soft shoulders.

XIV.(g) Alternative Route

An autonomous vehicle may have alternative routes mapped as a backup for all highway exits to ensure that autonomous vehicle will eventually arrive at the destination.

XIV.(h) Dedicated Exit Lane

When a dedicated exit lane is available for the exit, an autonomous vehicle may change lanes to the exit lane at the first opportunity possible.

XIV.(i) Highway Exit in Traffic Jam

In a traffic jam, an autonomous vehicle may identify and enter the exit lane by creating gaps in order to merge into the exit lane.

XIV.(j) Mapping

An autonomous vehicle may have highway exits and alternative routes identified and mapped in the navigation maps.

XIV.(k) Exit Area

An autonomous vehicle may be able to identify the exit area of the highway in order to determine where to exit.

XIV.(l) Exit Sign Recognition

An autonomous vehicle may be able to recognize highway exits based on the signs.

XIV.(m) K-ramp exit

An autonomous vehicle may seek gaps when taking a K-ramp highway exit. If autonomous vehicle is unable to exit due to insufficient gap, autonomous vehicle may use alternative route.

XIV.(n) Off-ramp Speed Limit

An autonomous vehicle may drive at a speed that's below the off-ramp speed limit for the entirety of the off-ramp.

XIV.(o) Speed Reduction

An autonomous vehicle may slow down to a safe speed for the off ramp before taking the highway exit and avoid heavy deceleration of more than a pre-determined threshold value to prevent tipping and swaying of the trailer.

### XV. Going Straight

XV.(a) Lane Selection

An autonomous vehicle may identify and select the lane to cross straight through an intersection based on the lane that the autonomous vehicle initiated the crossing from.

XV.(b) Traffic Light Occlusion

If the traffic light is occluded, autonomous vehicle may stop before the intersection and then creep forward to get a better view of the traffic light. If the traffic light is still occluded, autonomous vehicle may treat this intersection as an unprotected TTC stop.

XV.(c) Cross-Traffic Condition

An autonomous vehicle may consider the cross-traffic condition and yield for non-compliant cross traffic vehicles that are not stopping.

XV.(d) Malfunctioning Traffic Light—Stop Sign

An autonomous vehicle may treat the intersection as a stop sign intersection if the traffic lights are off or flashing red.

XV.(e) Hard Deceleration Avoidance

An autonomous vehicle may avoid a hard deceleration of more than a pre-determined threshold value when braking for a yellow light. The pre-determined threshold deceleration value may be no more than 3.8 m/s\hat{ }2, no more than 3.4 m/s\hat{ }2, such as no more than 3.0 m/s\hat{ }3, including no more than 2.5 m/s\hat{ }2.

If at the time when the traffic light turns yellow and autonomous vehicle determines that autonomous vehicle will need a deceleration of more than a pre-determined threshold value in order to stop before the intersection, autonomous vehicle may accelerate enough to cross the intersection and ensure that part of autonomous vehicle is already in the intersection before the yellow light interval ends instead.

XV.(f) Lane Change Avoidance

An autonomous vehicle may avoid lane changes when autonomous vehicle is within in an intersection unless for an evasive maneuver.

XV.(g) Traffic Light Detection

An autonomous vehicle may be able to identify traffic lights and determine when the traffic light signal for autonomous vehicle's path of travel indicates that the autonomous vehicle is allowed to cross the intersection.

XV.(h) Malfunctioning Traffic Light—Yield

When an autonomous vehicle encounters a malfunctioning traffic light that is flashing amber, the autonomous vehicle may avoid stopping, but instead slow down and yield for NPCs already in the intersection, as appropriate according to local regulations.

XV.(i) Intersection Blockage

An autonomous vehicle may avoid entering the intersection if the portion of the intersection that autonomous vehicle is going to cross is still occupied by traffic.

XV.(j) Yellow Light Behavior

If the traffic light turned yellow in an intersection before an autonomous vehicle has arrived at the intersection, the autonomous vehicle may determine if the autonomous vehicle is able to cross the intersection based on the time taken to arrive and cross the intersection.

XV.(k) Intersection Clearance Room

An autonomous vehicle may avoid entering the intersection if there is not sufficient room beyond the intersection for autonomous vehicle to completely clear the intersection.

XV.(l) Mapping

An autonomous vehicle may have intersections identified and mapped for navigation purposes.

XV.(m) Yellow Light Duration

If the yellow light duration is unknown, an autonomous vehicle may assume that the yellow light has a duration of a pre-determined number of seconds.

XV.(n) Malfunctioning Traffic Light

If an autonomous vehicle detects that the lights at an intersection are not operating in a normal way, the autonomous vehicle may classify the traffic light as malfunctioning.

Types of malfunctioning traffic lights may include:
1. Flashing Red
2. Flashing Amber
3. Traffic light powered off

XV.(o) Blocking Intersection

Autonomous vehicle may not enter an intersection when the autonomous vehicle predicts that it will not completely exit the intersection by the end of the red clearance interval. The red clearance interval may be defined as the amount of time between signal lights at an intersection turning from green to red in a first direction and including the time before turning from red to green in a second direction which crosses the first direction.

### XVI. Object Perception and Attribute Analysis

XVI.(a) Object Perception

An autonomous vehicle may detect and analyze objects attributes within its field of view (FOV). The field of view may be defined for each camera or sensor on the autonomous vehicle, as well as for the autonomous vehicle as a whole.

An autonomous vehicle may associate an object to the lane or shoulder of the road where it is located. (OTLA: Object To Lane Association) For example, a vehicle stopped in an emergency lane or shoulder may be classified as an emergency lane vehicle (ELV), while a vehicle in an on-ramp or merging-in lane may be classified as a merging-in vehicle.

An autonomous vehicle may classify objects as either static or moving. The classification may be accomplished by a computing module of the autonomous driving system of an autonomous vehicle that analyzes sensor data from different time periods to compare the data and relative location of any object in the data, accounting for the change in location of the autonomous vehicle and the like.

An autonomous vehicle may have the capability to reclassify objects, as their behavior changes. For example, a NPC vehicle may change from a moving to static (i.e., a stopped vehicle) from one moment to the next, while debris in a lane may go from static to moving once being hit by a vehicle (e.g., NPC vehicle) travelling on the roadway.

XVI.(b) Static Objects

An autonomous vehicle may detect static objects and analyze its attributes within its FOV and road boundaries.

An autonomous vehicle may static objects with a pre-determined minimum height (e.g., 1 inch, 2 inches, 3 inches, 4 inches, 5 inches).

An autonomous vehicle may detect all static objects that impact its capabilities (E.g. perception, localization, behavior, and driving capabilities).

An autonomous vehicle may have the capability to detect and analyze attributes of static objects, including any one or more of: size (dimensions); status as either immovable or moveable (expected to move); and classification (stopped vehicle, traffic signs, traffic lights, guardrails, bridges, etc.).

Autonomous vehicle may detect static objects from a pre-determined minimum distance, depending upon, and relative to, the object's dimensions.

XVI.(c) Moving/Moveable Objects

An autonomous vehicle may detect moving objects and analyze its attributes within its FOV and road boundaries.

An autonomous vehicle may have the capability to detect and analyze attributes of static objects, including any one or more of: size (dimensions); an autonomous vehicle may detect width and height of a moving object from at least a first pre-determined number of meters away and length of it from at least a second pre-determined number of meters away; speed; heading; acceleration/deceleration; position (relative to autonomous vehicle); and associated lane (or shoulder of the road).

### XVII. Emergency Vehicle

XVII.(a) Description of Flashing Emergency Vehicle

With respect to detection by an autonomous vehicle, a flashing emergency vehicle may be characterized as a vehicle having at least one lighted lamp exhibiting a red or red and blue light. Vehicles with flashing lights including tow trucks, construction vehicles, fire trucks, ambulances and police vehicles may all be treated as flashing emergency vehicles.

XVII.(b) Flashing Emergency Vehicle (EV)—Detection

An autonomous vehicle may react to the following flashing emergency vehicles (EV) no later than a pre-determined number of meters (e.g., 125 meters, 150 meters, 152.4 meters, 175 meters, 200 meters) before reaching the EV, unless the flashing EV is initially occluded and undetectable. The types of flashing EV requiring a reaction from an autonomous vehicle include: a flashing EV that is in front of autonomous vehicle and is completely stopped; a flashing EV that is in front of autonomous vehicle and moving in the same direction of travel; a flashing EV that is behind autonomous vehicle and moving in the same direction of travel; and a flashing EV that is in front of autonomous vehicle and moving in the opposite direction of travel on the same carriageway.

A carriageway is defined as the width of road on which a vehicle is not restricted by any physical barriers or separation to move laterally.

XVII.(c) Flashing EV—Memory

An autonomous vehicle may retain in memory for a minimum of a pre-determined number of seconds (e.g., 10 seconds, 12 seconds, 15 seconds, 18 seconds) the presence of a flashing emergency vehicle that is later fully or partially occluded from view.

XVII.(d) Flashing EV—Lane Change Priority

Any lane change intentions or deniers induced by a flashing emergency vehicle may be prioritized as critical safety, which is the highest prioritization.

XVII.(e) Flashing EV—Stopped on Highway—Lane Change Strategy

For a flashing emergency vehicle that is stopped on the highway (shoulder or non-shoulder area), an autonomous vehicle may leave at least one full lane between itself and the emergency vehicle, unless a lane change is not possible or is denied.

Stopped on Highway—Lane Change Strategy—Max Passing Speed:

When autonomous vehicle has at least one full lane between itself and a flashing emergency vehicle that is stopped on the highway, autonomous vehicle may pass the EV with a maximum speed of a pre-determined number of MPH (e.g., 8 mph, 10 mph, 12 mph) under the speed limit.

Stopped on Highway—Lane Change Strategy—Max Passing Speed—Nearby Traffic:

When autonomous vehicle has at least one full lane between itself and a flashing emergency vehicle that is stopped on the highway, autonomous vehicle may pass the EV with a speed less than a pre-determined number of MPH (e.g., 5 mph, 8 mph, 10 mph) above the average speed of non-emergency non-stationary vehicles that are within a pre-determined distance (e.g., 125 meters, 150 meters, 175 meters, 200 meters) of an autonomous vehicle traveling in the same direction on the roadway.

Stopped on Highway—Lane Change Intention Timing:

Lane change intentions for an autonomous vehicle, in which the lane change intentions are associated with a flashing emergency vehicle (EV) that is stopped may preferably remain in effect from the point in time when the flashing EV is detected until the point in time when autonomous vehicle's front bumper passes the EV's rear bumper.

Stopped on Highway—Lane Change Denier Timing:

Lane change deniers associated with a flashing emergency vehicle (EV) that is stopped may preferably remain in effect from the point in time when the flashing EV is detected until the point in time when the rearmost point of the autonomous vehicle combination (including trailer) passes the EV's front bumper.

Stopped on Highway—Lane Change Strategy—Multiple EVs:

When there are multiple flashing emergency vehicles that are stopped on the highway, an autonomous vehicle may leave at least one full lane between itself and the emergency vehicle that is protruding furthest into the roadway, unless a lane change is not possible or is denied.

Stopped on Highway—Multiple EVs—Lane Change Denier Timing:

Lane change deniers associated with multiple flashing emergency vehicles (EVs) that are stopped may preferably remain in effect from the point in time when a flashing EV is detected until the point in time when the rearmost point of the autonomous vehicle combination (including trailer) passes the front bumper of the last EV.

XVII.(f) Flashing EV—Stopped on Highway—Slow Down Strategy

When unable to pass with one full lane between itself and a flashing emergency vehicle that is stopped on the highway (shoulder or non-shoulder area), an autonomous vehicle may preferably slow down according to the Pedestrian Slow Down Strategy, described herein above, unless otherwise directed by local regulations.

The lateral distance in the Pedestrian Slow Down Strategy may be measured from the widest point of autonomous vehicle to the widest point of the EV.

XVII.(g) Flashing EV—Moving on Shoulder—Lane Change Strategy

For a flashing emergency vehicle that is moving on the shoulder of a highway, an autonomous vehicle may preferably follow the behavior strategy described above, that is to say in the section titled “Flashing EV—Stopped on Highway—Lane Change Strategy.”

XVII.(h) Flashing EV—Moving on Shoulder—Alternative Strategy

When unable to pass with one full lane between itself and a flashing emergency vehicle that is moving on the shoulder of a highway, an autonomous vehicle may slow down according to the behavior described above in the section titled, “Flashing EV—Stopped on Highway—Slow Down Strategy.”

Flashing EV—Moving on Shoulder—Predict Cut In:

When unable to pass with one full lane between itself and a flashing emergency vehicle that is moving on the shoulder of a highway, an autonomous vehicle may predict whether the flashing EV will cut in front of the autonomous vehicle or not, as outlined as follows. When unable to pass with one full lane between itself and a flashing emergency vehicle that is stopped on the highway (shoulder or non-shoulder area), an autonomous vehicle may slow down and maneuver so that there may be at least 1 lane between the autonomous vehicle and a vulnerable pedestrian surrounding the flashing EV, when such a vulnerable pedestrian is detected, and if it is not possible to attain 1 lane, the autonomous vehicle may slow down and bias away from the vulnerable pedestrian with relaxed lane keeping, unless otherwise directed by local regulations.

Flashing EV—Moving on Shoulder—Accept Cut In:

An autonomous vehicle may behave as follows when determining whether to pass or allow the flashing emergency vehicle that is moving on the shoulder to cut in. The autonomous vehicle may reduce throttle, effecting a deceleration, when a cutting-in vehicle is detected to travel more quickly than the autonomous vehicle. When the autonomous vehicle detects that cutting-in or a merging in vehicle is slower than the autonomous vehicle, the autonomous vehicle may choose to change lanes to the left to accommodate the cutting or merging-in vehicle.

XVII.(i) Flashing EV—EV Approaching Autonomous Vehicle

When a flashing emergency vehicle is approaching an autonomous vehicle from behind at an equal or greater speed in the same direction of travel (highway or local), the autonomous vehicle may yield the right-of-way to the emergency vehicle.

Yielding for EV—Intersection Constraint:

Autonomous vehicle cannot stop in the middle of an intersection when slowing down and yielding for a flashing emergency vehicle.

EV Approaching Autonomous Vehicle—Both in Rightmost Lane:

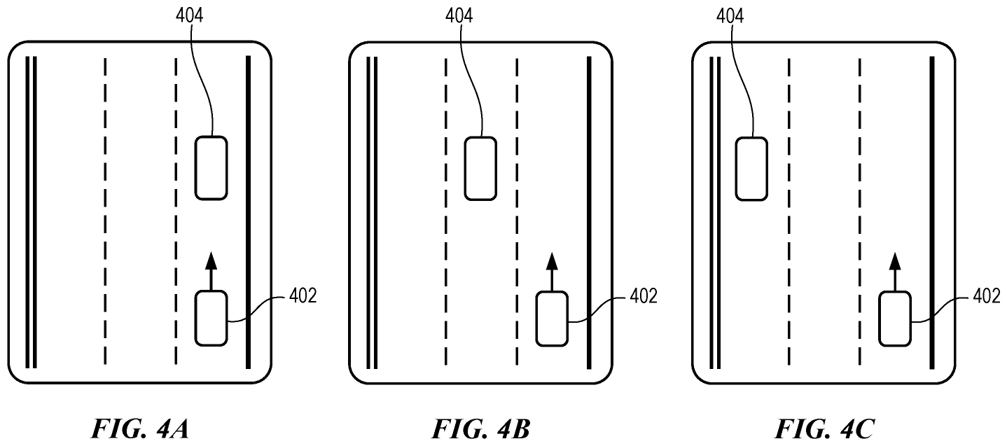

FIG. 4A shows an example scenario where an EV 402 approaches an autonomous vehicle 404 on a road. If autonomous vehicle is in the rightmost lane and a flashing emergency vehicle is approaching autonomous vehicle and is also in the rightmost lane, autonomous vehicle may use any available paved section of the shoulder to position itself to the right (out of the driving lanes if possible) and may gradually slow down until the EV has passed.

FIGS. 4B and 4C show example scenarios where the EV 402 approaches the autonomous vehicle to the right of autonomous vehicle 404. If a flashing emergency vehicle is approaching autonomous vehicle and the EV is positioned one or more lanes to the right of autonomous vehicle autonomous vehicle may remain in its current lane and gradually slow down until the EV has passed.

EV Approaching Autonomous Vehicle—Move to the Rightmost Lane:

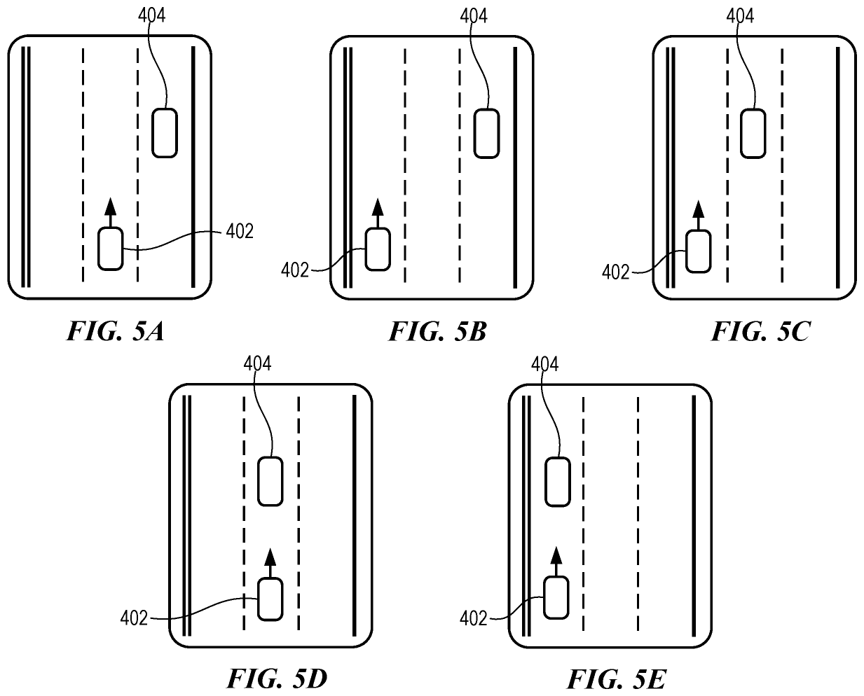

If a flashing emergency vehicle is approaching autonomous vehicle and is not in the situations described in FIGS. 4A to 4C (e.g., either where both the EV and the autonomous vehicle are in the right most lane or where the EV approaches the autonomous vehicle to the right of the autonomous vehicle), then the autonomous vehicle may position itself in the rightmost lane and may gradually slow down until the emergency vehicle has passed. For example, FIGS. 5A to 5C show example scenarios where an emergency vehicle 402 approaches from a left side of an autonomous vehicle 404 on a road, or where both the emergency vehicle and the autonomous vehicle are not the right-most lane on the road. FIGS. 5D to 5E show example scenarios where an emergency vehicle 402 approaches an autonomous vehicle 404 where both the emergency vehicle 402 and the autonomous vehicle 404 are not the right-most lane on the road.

EV Approaching autonomous vehicle—Lane Change Intention and Denier Timing:

The critical safety lane change intention(s) or denier(s) associated with a flashing EV

that is approaching autonomous vehicle may preferably remain in effect from the point in time when the flashing EV is detected until the point in time when the rear bumper of the EV passes the front bumper of autonomous vehicle.

XVII.(j) Flashing EV—Autonomous Vehicle Following EV in Same Direction of Travel

When autonomous vehicle is behind a moving flashing emergency vehicle traveling on the same carriageway in the same direction of travel, the autonomous vehicle cannot pass the emergency vehicle, unless the emergency vehicle is transitioning to a stopped EV (e.g., static vehicle).

Autonomous Vehicle Following EV—Maintain Longitudinal Distance:

When autonomous vehicle is behind a moving flashing emergency vehicle traveling on the same carriageway in the same direction of travel, autonomous vehicle may maintain a pre-determined longitudinal distance from the EV, unless it is transitioning to a stopped EV (e.g., static vehicle).

Autonomous Vehicle Following EV—Transitioning to Stopped EV:

If a moving flashing emergency vehicle meets any of the following criteria, an autonomous vehicle may assume the vehicle is transitioning to a stop (e.g., static object) and may follow the EV Stopped on Highway strategy in order to pass. The criteria may include any of: the flashing EV is in the leftmost lane, rightmost lane, shoulder, or gore area of a multilane carriageway and is traveling more than a pre-determined number of mph (e.g., 25 mph, 30 mph, 35 mph, 40 mph) under the speed limit, and is decelerating with a magnitude greater than a pre-determined rate (e.g., 0.5 m/s\hat{ }2, 1.0 m/s\hat{ }2, 1.5 m/s\hat{ }2); and the flashing EV is in the leftmost lane, rightmost lane, shoulder, or gore area of a multilane carriageway, is traveling less than a pre-determined absolute speed (e.g., 20 mph, 25 mph, 30 mph), and is not increasing its speed.

Autonomous Vehicle Following EV—Stopped EV in Middle Lane:

If a moving flashing emergency vehicle transitions to a static flashing emergency vehicle in any of the middle lanes of the carriageway, autonomous vehicle may stop, regardless of lane, and wait for the EV to move off the carriageway, transition to the left or rightmost lane of the carriageway, or continue down the carriageway.

Autonomous Vehicle Following EV—Multiple Stopped EVs in Outer Lane

When multiple moving flashing emergency vehicle transitions to static flashing emergency vehicles in both the left-most and right most lanes of the carriageway, an autonomous vehicle may stop, regardless of lane, and wait for the EVs to move off the carriageway or continue down the carriageway.

XVII.(k) Flashing EV—Opposite Direction of Travel

When a flashing emergency vehicle is approaching from the opposite direction of travel on the same carriageway, autonomous vehicle may gradually slow down until the emergency vehicle has passed and may preferably position itself parallel to and as close as possible to the right-hand edge or curb of the roadway clear of any intersections, unless autonomous vehicle is unable to change lanes. A carriageway is defined as the width of road on which a vehicle is not restricted by any physical barriers or separation to move laterally.

EV Opposite Direction of Travel—Lane Change Intention and Denier Priority:

The critical safety lane change intention(s) or denier(s) associated with a flashing EV that is approaching from the opposite direction may remain in effect from the point in time when the flashing EV is detected until the point in time when the rear bumper of the EV passes the rearmost point of the autonomous vehicle combination (e.g., including trailer).

XVII.(l) Emergency Vehicle Siren

Siren Detection:

In the absence of a visual identification of the Emergency Vehicle, autonomous vehicle may localize the Emergency Vehicle and determine if the Emergency Vehicle is approaching autonomous vehicle based on the direction and loudness of the siren. Localization of the emergency vehicle may include utilization of data from sensors that include a microphone or microphone array. The audio data may be analyzed to determine the type of emergency vehicle approaching as well as the direction from which the siren is coming.

Alert Mode:

When the loudness of the siren is above a threshold level of dB (e.g., 80 dB, 90 dB, 100 dB, 110 dB) and visual contact with the Emergency Vehicle is not yet established, an autonomous vehicle may go into alert mode where the autonomous vehicle will cease all forms of acceleration, slow down and prefer to use the outermost lane or bias right.

The rationale is to allow an autonomous vehicle to slow down so as to prepare autonomous vehicle for any form of pull over scenario, and biasing to check autonomous vehicle's blind spots.

Alert Mode—Highways:

When an autonomous vehicle goes into alert mode while driving on the highway, the autonomous vehicle may cease any form of acceleration, lane change to the outermost lane with regulatory lane change criticality. Once the autonomous vehicle is in the outermost lane, autonomous vehicle may preferably use hazard lights and drive at no more than a pre-determined speed.

Alert Mode—Local:

When an autonomous vehicle goes into alert mode while driving on local roads, the autonomous vehicle may cease any form of acceleration, lane change to the outermost lane with regulatory lane change criticality. Once the autonomous vehicle is in the outermost lane, the autonomous vehicle may use hazard lights, drive at no more than a pre-determined speed and bias to the right while staying within the current lane of travel without any portion of the autonomous vehicle passing over the lane lines, in some instances including mirrors and sensor arrays.

Alert Mode—End:

If autonomous vehicle did not establish visual contact with the Emergency Vehicle and the loudness of the siren has dropped below a predetermined volume (e.g., below 90 dB, below 80 dB, below 70 dB, below 60 dB) for more than a pre-determined number of seconds (e.g., 3 seconds, 4 seconds, 5 seconds, 6 seconds, 7 seconds) and is decreasing, autonomous vehicle may exit out of alert mode and resume normal operations.

### XVIII. Following Distance

In this document, many abbreviations and uncommon terms may be used. For instance, heavy traffic or a traffic jam is denoted “HTTJ”. Lane change may be abbreviated “LC”. “MRC” refers to minimal or minimum risk condition. “NCD” may refer to a non-compliant driver or multiple non-compliant drivers. “FOV” may indicate field of view. “STV” may refer to stopped vehicles.

XVIII.(a) Recommended Following Distance

Autonomous vehicle may maintain a Recommended Following Distance measured from autonomous vehicle's front bumper to the rear-most point of the leading NPC for safety and efficiency.

Recommended Following Distance Description:

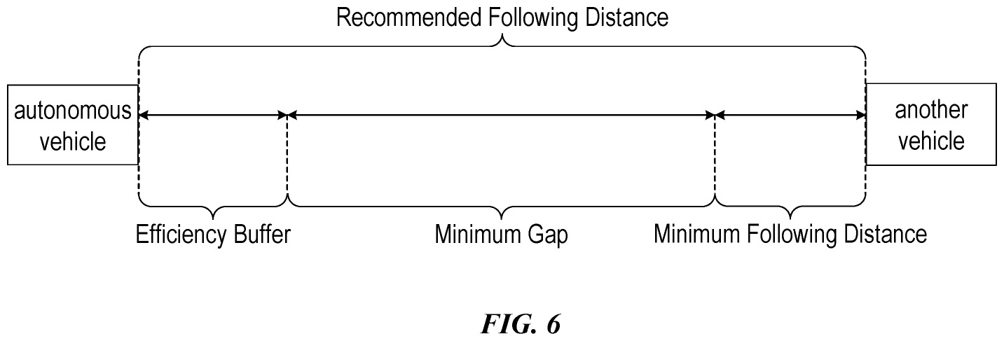

Recommended Following Distance may be the summation of the Efficiency Buffer, the Minimum Gap and the Minimum Following Distance as shown in FIG. 6.

XVIII.(b) Maintain a Minimum Gap

An autonomous vehicle may dynamically adjust and maintain a Minimum Gap to the leading NPC based on autonomous vehicle's speed of travel and system reaction time. The autonomous vehicle may increase following distance at higher speed and decrease following distance at lower speed. autonomous vehicle may account for the braking capability of the type of leading NPC.

Minimum Gap Description:

The Minimum Gap can be defined as the gap that ensures the critical stopped distance is maintained in the event that the vehicle in front of autonomous vehicle immediately brakes and comes to a complete stop. The minimum gap may assume the most conservative distance taking into account the autonomous system's reaction time, the brake system's reaction time, the system's maximum available deceleration, the maximum possible deceleration characteristics of the leading vehicle based on type (assume the worst case scenario for type of vehicle, load, etc.), and the speed of autonomous vehicle and the leading vehicle.

Restore the Minimum Gap:

If a vehicle cuts or merges into an autonomous vehicle's lane and is within the Minimum Gap, the autonomous vehicle may maintain a gap growth rate to the leading vehicle with a pre-determined velocity differential until the Minimum Gap is restored.

Autonomous Vehicle Safest Plan within Minimum Gap:

If autonomous vehicle must enter the Minimum Gap, autonomous vehicle may preferably maintain a gap growth rate to the leading vehicle with a pre-determined minimum velocity differential to the leading vehicle until the Minimum Gap is restored.

XVIII.(c) Minimum Following Distance

An autonomous vehicle may maintain a minimum following distance to any leading NPCs at any speed in order to allow autonomous vehicle enough space to leave the lane whether while in motion or stopped.

Minimum Following Distance for Traffic Jams:

When following a vehicle in heavy traffic under a predetermined steady state speed that may be tunable (e.g., with a nominal value of 11.28 m/s (25 mph)), an autonomous vehicle may keep a following distance with the leading vehicle, the following distance being a tunable parameter with a nominal of a predetermined distance (e.g., 6 meters, 7 meters, 8 meters, 9 meters) such that the autonomous vehicle would have sufficient room to turn and pass the vehicle in the case that it comes to a complete stop.

Minimum Following Distance for Vehicles:

An autonomous vehicle may keep a following distance with the leading vehicle such that autonomous vehicle would have sufficient room to change lanes and pass the vehicle in overtaking scenarios.

Minimum Following Distance for Pedestrians and Cyclists:

If an autonomous vehicle cannot pass a pedestrian or cyclist while travelling on local roads given the constraints in the Pedestrians and Cyclists section, the autonomous vehicle may maintain a following distance to the leading pedestrian or cyclist of at least a predetermined value (e.g., 5 meter, 6 meters, 7 meters) and match the speed of the pedestrian or cyclist. An autonomous vehicle may stop for pedestrians on the highway if unable to change lanes to avoid the pedestrian due to possible pedestrians being law enforcement officers.

Minimum Following Distance for Poor Weather:

Minimum Following Distance to front NPC may be increased to at least a predetermined distance (e.g., 15 meters, 18 meters, 20 meters, 25 meters) for poor weather to account for limitations in visibility and traction.

Minimum Following Distance for Nighttime:

Minimum Following Distance to front NPC may be increased to at least a predetermined distance (e.g., 10 meters, 12 meters, 15 meters, 18 meters, 20 meters) for night time to account for limitations in visibility.

Critical Following Distance:

Autonomous vehicle may maintain a predetermined critical minimal following distance (e.g., at least 3 meters, at least 4 meters, at least 5 meters) to any leading NPC under any condition to prevent collision and ensure leading NPC is within sensor field of view.

XVIII.(d) Efficiency Buffer

During steady state cruise, the system may continuously define an efficiency buffer that allows autonomous vehicle to minimize acceleration or deceleration while maintaining a constant speed to keep a following distance more than the minimum gap when reacting to changes in speed by the leading vehicle. In steady state cruise, the system may aim to prioritize engine braking over foundation braking.

Steady State Cruising Description:

Steady state cruising may be defined as when autonomous vehicle is driving with no safety critical events, and above the speed defined by a tunable value (e.g., with a nominal value of 11.28 m/s (25 mph)), and does not experience acceleration or deceleration with an absolute value greater than value defined by a tunable value (e.g., with a nominal value of 3 m/s\hat{ }2).

XVIII.(e) Stopped Distance

Autonomous vehicle may be able to bring itself to a stop as the leading NPC comes to a stop and maintain a stopped distance with the leading NPC.

Recommended Stopped Distance:

When both the leading vehicle and autonomous vehicle are coming to a stop, autonomous vehicle may keep a stopped distance of at least a predetermined distance (e.g., 5 meters, 6 meters, 7 meters) so that autonomous vehicle has enough space to change lanes from stationary and prevent other vehicles from cutting in.

Critical Stopped Distance:

In safety critical or evasive scenarios, the system may be able to stop with a predetermined minimum distance (e.g., at least 0.75 meters, 1.0 meters, 1.25 meters) to the leading NPC so that impact is avoided.

### XIX. Highway Exits

An autonomous vehicle may have particular considerations to account for to safely navigate and negotiate highway exits. The avoidance of collision with other exiting vehicles (e.g., NPC vehicles), as well as planning in advance so as not to miss an intended exit are other considerations addressed below. In these negotiations and traversal of highway exits, an autonomous vehicle may utilize various components or modules such as sensor arrays and the associated data, a stored map showing locations of exits, positional data of the autonomous vehicle, as well as data or instructions from an oversight system or command center sent via wireless communication. The data or instructions from an oversight system or command center may include data of temporary changes to traffic flow (e.g., temporary exit ramp closures, traffic jams) or instructions from a remote control operator associated with the oversight system or command center.

XIX.(a) Mapping

An autonomous vehicle may have highway exits and alternative routes identified and mapped in the navigation maps.

XIX.(b) Speed Reduction

An autonomous vehicle may slow down to a safe speed for the off ramp before taking the highway exit and avoid heavy deceleration of more than a pre-determined rate to prevent tipping and swaying of the trailer.

XIX.(c) Dedicated Exit Lane

If a dedicated exit lane is available for the exit, an autonomous vehicle may change lanes to the exit lane at the first opportunity possible.

XIX.(d) Stay in Exit Lane

An autonomous vehicle may preferably keep in the exit lane for a pre-determined minimum number of meters (e.g., 700 meters, 800 meters, 900 meters, 1200 meters) before exit point and avoid further lane changes unless for critical safety lane changes.

XIX.(e) Highway Exit in Traffic Jam

In a traffic jam, autonomous vehicle may identify and enter the exit lane by creating gaps in order to merge into the exit lane.

XIX.(f) Backed up Highway Exit current state and position.

If the highway exit is backed up, autonomous vehicle may be able to detect the line of NPCs in the exit lane and slow down to join at the end of the line.

XIX.(g) Backed Up Highway Exit Merge-In

If the highway exit is backed up and autonomous vehicle was not able to join the line at the end, autonomous vehicle may slow down to no slower than a pre-determined number of miles per hour (e.g., 15 mph, 20 mph, 25 mph) below the average highway traffic speed to seek for a gap to merge in. If autonomous vehicle is unable to merge in, autonomous vehicle may use an alternative route, with the alternative route possibly including local roads or surface streets.

XIX.(h) K-Ramp Exit

An autonomous vehicle may seek gaps when taking a K-ramp highway exit. If autonomous vehicle is unable to exit due to insufficient gap, autonomous vehicle may use alternative route.

XIX.(i) Multi-Lane Exit

An autonomous vehicle may choose to drive in a lane that is most appropriate for the next part of the journey in a multi-lane exit.

XIX.(j) Alternative Route

An autonomous vehicle may have alternative routes mapped as a backup for all highway exits to ensure that autonomous vehicle will eventually arrive at the destination. The alternative routes may include local roads or surface streets as well as alternate highway exits to take to arrive at the ultimate destination.

XIX.(k) Off-Ramp Speed Limit

An autonomous vehicle may drive at a speed below the posted limit and sufficiently slow to guarantee the stability of the load, vehicle, and trajectory.

XIX.(l) Closed Exit

If the exit that an autonomous vehicle is intending to use is closed, the autonomous vehicle may rejoin the highway and use an alternative route at the first instance of detecting that the exit is closed.

XIX.(m) Closed Exit Detection

An autonomous vehicle may be able to detect that the exit that autonomous vehicle is intending to use is closed from at least a pre-determined distance before reaching the exit and inform an Oversight system or remote control operator (RCO) of the closed exit. For example, autonomous vehicle may be able to detect signs that indicate that exit is closed based upon overall sign shape, icons on signs, wording on signs, and the like.

### XX. Hills

XX.(a) Hill Road Description

Hill roads can be defined as roads with a gradient of more than a pre-determined amount, such as 2.5%, 3%, 3.5%, or 4%.

XX.(b) Mapping

An autonomous vehicle may have hill roads and known runaway ramps mapped out for navigation use.

XX.(c) Lane Change Avoidance

An autonomous vehicle may avoid all types of efficiency and lower priority lane changes except for right lane preference lane changes when driving on a hill roads.

XX.(d) Right Lane Preference

An autonomous vehicle may drive on the right lane when on hill roads unless for evasive maneuvers or avoiding ELVs (e.g., vehicles in the emergency lane, or emergency lane vehicles).

XX.(e) Speed Control

An autonomous vehicle may select an appropriate speed when driving on hill roads to prevent the tipping, swaying or skidding of the trailer. autonomous vehicle may consider the steepness of the gradient, the curvature of the road, the road traction condition, the prevailing weather condition, visibility condition as well as the weight and center of gravity of autonomous vehicle and the trailer.

Brake Control:

An autonomous vehicle may prioritize the usage of engine brakes in combination with the appropriate drive gear for the speed that autonomous vehicle is traveling at over the usage of foundation brakes to preserve the effectiveness of foundation brakes and to prevent over heating of the foundation brakes.

XX.(f) Hazard Lights

Unless in a traffic jam, an autonomous vehicle may turn on hazard lights on hill roads if autonomous vehicle is driving more than a pre-determined number of mph below the speed limit or if autonomous vehicle is driving at a speed of less than a pre-determined threshold speed (mph).

XX.(g) Rolling Backwards

An autonomous vehicle may preferably avoid rolling backwards when stopped or starting from a stop on a hill road. This may be accomplished by the autonomous vehicle using both mapping information of where hilly roads are along a route as well as perception data obtained by sensors on-board the autonomous vehicle, the perception data coming from cameras, LIDAR systems, radar systems, and the like and/or IMU or gyroscope data that indicates an overall inclination of the autonomous vehicle. Upon detection or determination of the autonomous vehicle on a hilly roadway, the autonomous vehicle may activate brakes or engage the throttle to keep the autonomous vehicle in gear to prevent slipping of the autonomous vehicle while stopped along the hilly roadway.

XX.(h) Runaway Ramps

In the event of brake fade or failure, an autonomous vehicle may preferably attempt to slow down, and if maintaining a safe speed is no longer possible given the brake condition, may exit using a runaway ramp.

XX.(i) Contact Oversight

If an autonomous vehicle is experiencing brake fade or brake failure, the autonomous vehicle may contact an Oversight system/control center/remote control operator (RCO).

XX.(j) Runaway Ramp Identification

An autonomous vehicle may be able to identify runaway ramps based on pre-mapped locations.

XX.(k) Runaway Procedure

If an autonomous vehicle is unable to come to a stop due to brake fade or failure, the autonomous vehicle may engage maximum engine braking using the lowest possible drive gear, turn the hazard lights on and use the horn to warn other road users. The autonomous vehicle may lane change to the lane that is adjacent to the next runaway ramp at the first opportunity possible to enable the usage of a runaway ramp when available.

### XXI. Intersections, Going Straight

XXI.(a) Lane Change Avoidance

An autonomous vehicle may avoid lane changes when autonomous vehicle is within in an intersection unless for an evasive maneuver.

XXI.(b) Intersection Clearance

An autonomous vehicle may not enter an intersection if the autonomous vehicle predicts that it will not completely exit the intersection by the end of the red clearance interval. If the autonomous vehicle determines that autonomous vehicle (itself) will not be able to completely exit the intersection by the end of the red clearance interval due to the speed that autonomous vehicle is traveling or the general speed of the traffic that autonomous vehicle is in, or if autonomous vehicle determines that the other side of the intersection will not have enough space to fully accommodate autonomous vehicle due to backed up traffic, autonomous vehicle may avoid entering the intersection even if the intersection is clear.

XXI.(c) Lane Selection

An autonomous vehicle may identify and select the lane to cross based on the lane from which autonomous vehicle initiated the crossing.

XXI.(d) Traffic Light Detection

An autonomous vehicle may be able to identify traffic lights and determine if the traffic light signal for autonomous vehicle's path of travel is indicating that autonomous vehicle is allowed to cross the intersection or not.

XXI.(e) Yellow Light Behavior

If the traffic light turned yellow in an intersection before an autonomous vehicle has arrived at the intersection, the autonomous vehicle may determine if the autonomous vehicle is able to cross the intersection based on the time taken to arrive and cross the intersection.

Yellow Light Duration:

If the yellow light duration is unknown, an autonomous vehicle may assume that the yellow light has a duration of a pre-determined number of seconds.

Hard Deceleration Avoidance

An autonomous vehicle may avoid a hard deceleration of more than a pre-determined rate (e.g., 1 m/s\hat{ }2, 1.5 m/s\hat{ }2, 1.75 m/s\hat{ }2, 2 m/s\hat{ }2) when braking for a yellow light.

XXI.(f) Malfunctioning Traffic Light

If an autonomous vehicle detects that the lights at an intersection are not operating in a normal way, the autonomous vehicle may classify the traffic light as malfunctioning.

Types of malfunctioning traffic lights:
1. Flashing Red
2. Flashing Amber
3. Traffic light powered off

Malfunctioning Traffic Light—Stop Sign:

Autonomous vehicle may treat the intersection as a stop sign intersection when the traffic lights are off or flashing red.

Malfunctioning Traffic Light—Yield:

When an autonomous vehicle encounters a malfunctioning traffic light that is flashing amber, the autonomous vehicle may avoid stopping, but instead slow down and yield for NPCs already in the intersection.

XXI.(g) Traffic Light Occlusion

When a traffic light is occluded, an autonomous vehicle may stop before the intersection and then creep forward to get a better view of the traffic light. If, after creeping forward, the traffic light is still occluded, the autonomous vehicle may treat this intersection as an unprotected time-to-crash (TTC) stop, meaning that the bumper of the autonomous vehicle preferably remains outside of the intersection and that the autonomous vehicle stops for a predetermined duration (e.g., at least 0.5 seconds, 1 second, 1.5 seconds).

XXI.(h) Cross-Traffic Condition

Autonomous vehicle may consider the cross-traffic condition and yield for non-compliant cross traffic vehicles that are not stopping.

Cross-Traffic Description:

Cross traffic can be defined as traffic that is not parallel to an autonomous vehicle's path of travel when the autonomous vehicle is going straight in an intersection and will cross autonomous vehicle's path in an intersection.

XXI.(i) Intersection Blockage

An autonomous vehicle may avoid entering the intersection if the portion of the intersection that autonomous vehicle is going to cross is still occupied by traffic.

XXI.(j) Mapping

An autonomous vehicle may have intersections identified and mapped for navigation purposes.

### XXII. Intersections, Turning Right/Left

XXII.(a) Turning Trajectory

An autonomous vehicle may adopt a trajectory that ensures the autonomous vehicle does not collide with any nearby vehicles or objects, and the off-tracking area remains within the drivable area and does not intersect with any vehicles or objects. The autonomous vehicle may consider the length of the trailers, the off-track of the rear wheels, the speed of the vehicle, the location of the fifth wheels and the areas/arcs of the intersections and etc.

Off-Tracking Area Description:

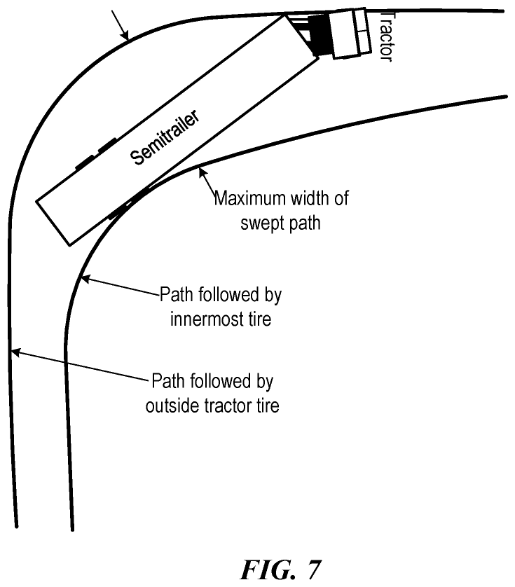

FIG. 7 shows an example scenario where a vehicle (e.g., an autonomous semi-trailer truck) is off-tracking in a 90 degree turn. The off-tracking area may be defined as the area bounded by the trajectory of autonomous vehicle's wheels as autonomous vehicle negotiates a turn. The off-tracking area is bounded by the 2 lines denoted by the path following by innermost tire and the path followed by the outside tractor tire in the diagram below.

XXII.(b) Turning Speed at Intersections

When turning at an intersection, an autonomous vehicle may adopt a turning speed proportionate to the curvature of the turn and superelevation of the road to ensure that autonomous vehicle does not skid, sway or tip to the side. The autonomous vehicle's speed may resemble the speed at which a driver would make the turn. The autonomous vehicle may consider the amount of load, radius of the turn, superelevation of the road, weather condition and TTC of oncoming cross path vehicles.

Unprotected Turning TTC:

When performing an unprotected turn at a signalized intersection or turning at a non-signalized intersection where an autonomous vehicle must yield the right of way, the autonomous vehicle may leave enough time for the turn to be completed before oncoming vehicles arrive assuming that oncoming vehicles will not decelerate.

The time calculation may take the trailer length into consideration. The arrival time of oncoming vehicles may consider the vehicles' arriving distance and the speed. autonomous vehicle may not block the oncoming vehicles with the right-of-way.

XXII.(c) Turning Lane Selection

Autonomous vehicle may choose to turn from a lane that is the most appropriate for the next part of the journey. Autonomous vehicle may select the target lane to turn to based on the lane that autonomous vehicle initiated the turn from. autonomous vehicle may prefer a turning lane with the smallest off track area and prefer a target lane.

XXII.(d) Intersection Clearance

Autonomous vehicle may not enter an intersection for a turn if autonomous vehicle predicts that it will not completely exit the intersection by the end of the red clearance interval. If autonomous vehicle determines that autonomous vehicle (itself) will not be able to completely exit the intersection by the end of the red clearance interval due to the speed that autonomous vehicle is traveling or the general speed of the traffic that autonomous vehicle is in, or if autonomous vehicle determines that the other side of the intersection will not have enough space to fully accommodate autonomous vehicle due to backed up traffic, autonomous vehicle may not enter the intersection even if the intersection is clear.

XXII.(e) Turning Behavior

Autonomous vehicle may obey the applicable signs or lights at intersections, and ensure that the turning path is clear and devoid of other NPCs before initiating the turn.

Left Turn—Lane Preference:

When autonomous vehicle is encountering multiple turning lanes for left turns, autonomous vehicle may prefer taking the right-most lane that allows for a left turn to initiate the left turn.

Left Turn—Trajectory:

Autonomous vehicle may avoid invading into the opposing traffic's left turning radius when making a left turn at a signalized intersection.

Unprotected Left Turn:

If autonomous vehicle is making an unprotected left turn at an intersection, autonomous vehicle may yield to NPCs that are approaching from the opposite direction.

Unprotected Left Turn—Green Light:

When doing an unprotected left turn under green light, if autonomous vehicle is the first vehicle on the intersection, autonomous vehicle may creep forward to enter the intersection without impeding the traffic.

If autonomous vehicle unable to complete the left turn under green light, an autonomous vehicle may leave the intersection under yellow/red light as soon as possible to minimize blockage of intersection.

Right Turn—Lane Preference:

When an autonomous vehicle is encountering multiple turning lanes for right turns, the autonomous vehicle may prefer taking the left-most right turning lane to start the turn.

Right Turn—Trajectory:

When turning right at an intersection and a wide turn is necessary, an autonomous vehicle may prefer to pull wide near the end of the turn as opposed to the beginning of the turn.

Unprotected Right Turn:

If an autonomous vehicle is making an unprotected right turn at an intersection, the autonomous vehicle may yield to NPCs that are approaching from the left in the through lane and non-stationary NPCs already in the intersection turning left from the opposite lane.

Unprotected Right Turn—Red Light:

An autonomous vehicle may avoid making unprotected right turns under red light.

XXII.(f) Yielding Behavior When Turning

When turning at an intersection, an autonomous vehicle may yield the right-of-way to traffic in all lanes that are intersected by the autonomous vehicle's planned trajectory and are not required to stop.

This includes traffic that has passed the tractor but has not yet passed the trailer, on the inside or outside of the turn.

An autonomous vehicle may yield to vehicles doing u-turns onto the autonomous vehicle's planned target lane.

An autonomous vehicle may yield to adjacent lanes that are crossed due to the autonomous vehicle's extra wide turning radius.

In this case, to yield means that an autonomous vehicle may be able to finish its maneuver without causing vehicles with the right-of-way to have to slow down

XXII.(g) Occluded turn

When the turn is occluded, an autonomous vehicle may creep forward to adjust the position to get the necessary perception view, then make the turning decision based on unprotected turning TTC. The autonomous vehicle may ensure that the front bumper of the autonomous vehicle does not cross into the cross-traffic lane when creeping forward.

### XXIII. Minimal/Minimum Risk Condition (MRC) and Minimal Risk Maneuvers

XXIII.(a) Degraded Mode/Minimal Risk Conditions

When an autonomous vehicle is in a degraded state or the planned route is not traversable, the autonomous vehicle may be forced to perform a maneuver to allow the autonomous vehicle to be in a minimal risk condition (MRC). The system may be capable of achieving the following Minimal Risk Conditions (MRC):

MRC_DEGRADED_OPERATIONS: autonomous vehicle is operating at a reduced speed with an increased following distance and degraded operations.

MRC_SAFE_PARK: autonomous vehicle is stopped in a safe location and secured; a remote operator (e.g., a remote control operator associated with an oversight system or control center) is informed and decides on the course of further actions.

MRC_STOPPED_IN_LANE: autonomous vehicle is stopped in-lane.

XXIII.(b) Minimal Risk Maneuvers to achieve the Minimal Risk Conditions

The system may be able to execute the following Minimal Risk Maneuvers (MRM) to achieve the Minimal Risk Conditions (MRC):
MRM_1.1: Transition to the rightmost lane of the highway/freeway. Reduce speed to DEGRADED_OPERATIONS_HIGHWAY_SPEED, keep lane, and increase following distance.
MRM_1.2: Transition to the rightmost lane of the local road. Reduce speed to DEGRADED_OPERATIONS_LOCAL_SPEED, keep lane, and increase following distance.
MRM_2.1: Maneuver off of the roadway onto the next safe area. Inform the operator about the current state and position.
MRM_3.1: Gentle stop in the current lane. Keep lane and avoid in-lane collisions by braking.
MRM_3.2: Immediate stop in the current lane.

MRM—General—Maintain Stability:

During the operation of all Minimal Risk Maneuvers (MRM), the system may maintain stability of the truck such that it does not roll over or jackknife.

MRM—General—Lane Keep:

During the operation of all Minimal Risk Maneuvers (MRM), the outermost points of the autonomous vehicle combination, including trailer, may remain within the boundaries of the lane, unless required for obstacle avoidance, changing lanes, or the severity of the system failure inhibits lane keeping.

MRM—General—Turn On Hazard Lights:

For all Minimal Risk Maneuvers (MRM), autonomous vehicle may immediately turn on the hazard lights.

MRM—General—Hazard Lights—Changing Lanes:

For all Minimal Risk Maneuvers (MRM), autonomous vehicle may temporarily turn off the hazard lights when changing lanes and resume the hazard light usage on completion of the lane change.

MRM—General—Collision Avoidance:

During the operation of all Minimal Risk Maneuvers (MRM), autonomous vehicle may avoid collision with nearby objects, vehicles, and pedestrians.

MRM—General—Remain Static:

For all Minimal Risk Maneuvers (MRM), autonomous vehicle may remain static indefinitely after coming to a complete stop until taken over by an operations team member.

XXIII.(c) MRM 1.1—Description

MRM 1.1 may be defined as a Minimal Risk Maneuver that achieves the minimal risk condition (MRC) state on the highway. For this maneuver, autonomous vehicle may transition to the rightmost lane of the highway/freeway, reduce its speed to a pre-determined reduced speed suited to the degraded state of the system and the target MRC, and increase its following distance to nearby vehicles.

MRM 1.1—Rightmost Lane—Description:

When transitioning to the rightmost lane for MRM 1.1, autonomous vehicle may only transition to lanes that do not have an upcoming lane closure or lead to an exit from the highway, unless the intention is to exit.

MRM 1.1—Rightmost Lane—Priority:

For MRM 1.1, autonomous vehicle may transition and remain in the rightmost lane with non-critical safety priority.

MRM 1.1—Speed Reduction—Timing:

When reducing its speed to a pre-determined reduced speed for MRM 1.1, autonomous vehicle may only do so after it is in the rightmost lane of the highway, unless the underlying fault requires an immediate reduction in speed. If we are able to do so, we may prefer to slow down when we are in the rightmost lane since this is generally considered the “slow” lane. However, we may want to slow down immediately for faults that require it, such as when we have low compute resources.

MRM 1.1—Speed Reduction—Deceleration Rate:

When reducing its speed to a pre-determined reduced speed for MRM 1.1, autonomous vehicle may decelerate at a magnitude that is less than a pre-determined deceleration rate, unless further deceleration is required for collision avoidance.

MRM 1.1—Following Distance:

When adjusting the following distance to nearby vehicles for MRM 1.1, autonomous vehicle may increase the minimum following distance by a pre-determined multiplicative factor.

XXIII.(d) MRM 1.2— Description

MRM 1.2 may be defined as a Minimal Risk Maneuver that achieves the MRC_DEGRADED_OPERATIONS state on a local road. For this maneuver, autonomous vehicle may transition to the rightmost lane of the local road, reduce its speed to DEGRADED_OPERATIONS_LOCAL_SPEED, and increase its following distance to nearby vehicles.

MRM 1.2—Rightmost Lane—Description:

When transitioning to the rightmost lane for MRM 1.2, autonomous vehicle may only transition to lanes that do not have an upcoming lane closure or lead to an exit from the local road, unless the intention is to exit.

MRM 1.2—Rightmost Lane—Priority:

For MRM 1.2, autonomous vehicle may transition and remain in the rightmost lane with non-critical safety priority.

MRM 1.2—Speed Reduction—Timing:

When reducing its speed to a pre-determined reduced speed for MRM 1.2, autonomous vehicle may only do so after it is in the rightmost lane of the local road, unless the underlying fault requires an immediate reduction in speed. If we are able to do so, we may prefer to slow down when we are in the rightmost lane since this is generally considered the “slow” lane. However, we may want to slow down immediately for faults that require it, such as when we have low compute resources.

MRM 1.2—Speed Reduction—Deceleration Rate:

When reducing its speed to a pre-determined reduced speed for MRM 1.2, autonomous vehicle may decelerate at a magnitude that is less than a pre-determined maximum deceleration rate (e.g., 0.5 m/s\hat{ }2, 1.0 m/s\hat{ }2, 1.5 m/s\hat{ }2, 2.0 m/s\hat{ }2), unless further deceleration is required for collision avoidance.

MRM 1.2—Following Distance:

When adjusting the following distance to nearby vehicles for MRM 1.2, autonomous vehicle may increase the minimum following distance by a pre-determined multiplicative factor (e.g., 1.1 times, 1.25 times, 1.5 times, 2 times, 2.5 times).

XXIII.(e) MRM 2.1— Description

MRM 2.1 may be defined as a Minimal Risk Maneuver that achieves the MRC_SAFE_PARK state on the highway or a local road. For this maneuver, autonomous vehicle may maneuver off of the roadway onto the next safe area and inform the operations team (e.g., remote operator or remote control operator at a control center or associated with an oversight system) about the current state and position.

MRM 2.1—Safe Area—Description:

For MRM 2.1, a safe area may be defined as an area that can accommodate the entire autonomous vehicle combination, including trailer, in a manner such that the outermost points of the autonomous vehicle combination remain off of the driveable lanes of the roadway (highway or local).

MRM 2.1—Safe Area—Width:

For MRM 2.1, a safe area may be wide enough such that the outermost point of the autonomous vehicle combination, including trailer, would not penetrate a driving lane after accounting for errors in localization and control.

MRM 2.1—Safe Area—Length:

For MRM 2.1, a safe area may be long enough such that autonomous vehicle would be able to decelerate and come to a complete stop within the area.

MRM 2.1—Safe Area—Mapping:

For MRM 2.1, all areas on a mapped route that meet the criteria for a safe area can be labeled as such on the HD map.

MRM 2.1—Safe Area—Mapping—Forced Off Highway or Missed Exit:

The map may contain at least one safe area that can be navigated to by autonomous vehicle at all locations where autonomous vehicle may miss an exit or be forced off of the highway.

MRM 2.1—Safe Area—Obstacle Avoidance:

For MRM 2.1, autonomous vehicle may only maneuver onto a safe area that would not result in a collision with an object, vehicle, or pedestrian that is already on or near the safe area.

MRM 2.1—Safe Area—Obstacle Avoidance—Parked Vehicle—Front Stopped Distance:

For MRM 2.1, when parking behind an existing parked vehicle in a safe area, the frontmost point of the autonomous vehicle combination may remain at least 20 meters from the rearmost point of the parked vehicle.

MRM 2.1—Safe Area—Obstacle Avoidance—Parked Vehicle—Rear Gap Check:

For MRM 2.1, when parking in front of an existing parked vehicle in a safe area, an autonomous vehicle's tires may cross the lane boundary onto the safe area only once the rearmost point of the autonomous vehicle combination, including trailer, is at least a pre-determined number of meters (e.g., 1 meter, 2 meters, 3 meters, 4 meters, 5 meters, 6 meters) from the frontmost point of the parked vehicle.

MRM 2.1—Speed Reduction—Highway:

For MRM 2.1, when an autonomous vehicle is on the highway in the lane adjacent to the safe area it intends to maneuver onto, the autonomous vehicle may reduce its speed to a pre-determined level.

MRM 2.1—Speed Reduction—Local:

For MRM 2.1, when an autonomous vehicle is on a local road in the lane adjacent to the safe area it intends to maneuver onto, autonomous vehicle may reduce its speed to a pre-determined speed. The pre-determined speed may be governed by the speed limit of the area.

MRM 2.1—Speed Reduction—Deceleration Rate:

When reducing its speed on highway or local for MRM 2.1, autonomous vehicle may decelerate at a magnitude that is less than a pre-determined deceleration value (e.g., 0.5 m/\hat{ }2, 0.75 s/m\hat{ }2, 1.0 m/s\hat{ }2, 1.25 m/s\hat{ }2, 1.5 m/s\hat{ }2), unless further deceleration is required for collision avoidance.

MRM 2.1—Regulatory Constraints—Fire Hydrant:

When coming to a complete stop for MRM 2.1, all parts of the autonomous vehicle combination, including trailer, may remain further than a pre-determined distance (e.g., 1 meter, 2 meters, 3 meters, 4 meters, 5 meters, 6 meters, 7 meters) from a fire hydrant when autonomous vehicle is fully stopped.

MRM 2.1—Regulatory Constraints—Safety Zone:

When coming to a complete stop for MRM 2.1, all parts of the autonomous vehicle combination, including trailer, may remain further than a pre-determined distance (e.g., 1 meter, 2 meters, 3 meters, 4 meters, 5 meters, 6 meters, 7 meters) from a safety zone when autonomous vehicle is fully stopped.

A safety zone may be defined as follows:

“Safety zone” means the area or space that is both: officially set apart within a roadway for the exclusive use of pedestrians; and protected or either marked or indicated by adequate signs as to be plainly visible at all times while set apart as a safety zone.

MRM 2.1—Regulatory Constraints—Railroads:

When coming to a complete stop for MRM 2.1, all parts of an autonomous vehicle combination, including trailer, may remain further than a pre-determined distance from a railroad crossing (e.g., 5 meter, 6 meters, 7 meters, 10 meters, 11 meters, 12 meters, 15 meters, 16 meters) when autonomous vehicle is fully stopped.

MRM 2.1—Regulatory Constraints—Bridges:

When coming to a complete stop for MRM 2.1, all parts of an autonomous vehicle combination, including trailer, may remain off of any bridges or other elevated structures, unless on a controlled access highway. A bridge is defined as a structure carrying a road or path across a river, ravine, road, railroad, or other obstacle. For example, an overpass is a type of bridge.

MRM 2.1—Regulatory Constraints—Tunnels:

When coming to a complete stop for MRM 2.1, all parts of an autonomous vehicle combination, including trailer, may remain further than a pre-determined distance from a tunnel when autonomous vehicle is fully stopped.

MRM 2.1—Regulatory Constraints—Road Signs:

When coming to a complete stop for MRM 2.1, all parts of the autonomous vehicle combination, including trailer, may remain outside of areas with signs prohibiting standing or stopping.

XXIII.(f) MRM 3.1—Description

MRM 3.1 may be defined as a Minimal Risk Maneuver that achieves the MRC_STOPPED_IN_LANE state on the highway or a local road. For this maneuver, autonomous vehicle may perform a gentle stop in the current lane, avoid in-lane collisions by braking, and inform the operations team about the current state and position.

MRM 3.1—Deceleration Rate:

For MRM 3.1, the magnitude of the deceleration rate may remain under MRM_3.1_MAX_DECELERATION, unless further deceleration is required for collision avoidance.

MRM 3.1—Location Constraint—Intersections:

For MRM 3.1, all parts of the autonomous vehicle combination, including trailer, may remain outside of intersections when autonomous vehicle is fully stopped.

MRM 3.1—Location Constraint—K-Ramp Merge Area:

For MRM 3.1, all parts of the autonomous vehicle combination, including trailer, may remain outside of the merge area of a k-ramp when autonomous vehicle is fully stopped. FIG. 9 shows a merge area of a k-ramp.

XXIII.(g) MRM 3.2— Description

MRM 3.2 may be defined as a Minimal Risk Maneuver that achieves the MRC_STOPPED_IN_LANE state on the highway or a local road. For this maneuver, autonomous vehicle may perform an immediate stop in the current lane.

MRM 3.2—Deceleration Rate:

For MRM 3.2, the magnitude of the deceleration rate may remain under MRM_3.2_MAX_DECELERATION.

XXIII.(h) MRC SAFE PARK—Time Constraint

After autonomous vehicle has unsuccessfully attempted to reach the MRC_SAFE_PARK state for TIME_DURATION_BEFORE_MRC_SAFE_PARK_ESCALATION, autonomous vehicle may execute MRM 3.1 to reach the MRC_STOPPED_IN_LANE state.

XXIII.(i) Operational Constraints—Access to Minimal Risk Maneuvers

At any given point in time during a mission, the remote operations team may be able to trigger the following Minimal Risk Maneuvers (MRM):
MRM 1.1 (only on highway)
MRM 1.2 (only on local)
MRM 2.1
MRM 3.1

XXIII.(j) Regulatory Constraints—Emergency Vehicles

While performing an MRM 1.1, MRM 1.2, or MRM 2.1 maneuver, the system may yield to an approaching emergency vehicle that has its siren and emergency lights on.

XXIII.(k) MRC Triggers—System Failure

Each hardware/software module may define the potential failures and the corresponding degradation mode or Minimal Risk Maneuver (MRM) that may be executed on failure of the module.

XXIII.(l) MRC Triggers—Approaching Map Boundary

When an autonomous vehicle's only available trajectory will result in reaching the map's boundary in a pre-determined distance or less (e.g., in 3 miles or less, in 2 miles or less, in 1 mile or less) and a Minimal Risk Maneuver (MRM) is not already in progress, autonomous vehicle may execute an MRM 2.1 command.

An autonomous vehicle may avoid executing the MRM 2.1 command if it is on a trajectory that is not expected to cross the map's boundary, even if the autonomous vehicle is within 1 mile of the boundary.

After receiving, and in turn executing, any MRM command, an autonomous vehicle may notify an oversight system or control center of the status of the autonomous vehicle. In some embodiments, the oversight system or control center may issue a minimal risk maneuver command to one or more autonomous vehicles in communication with the oversight system or control center.

MRC Triggers—Approaching Map Boundary—Fallback Strategy:

If an autonomous vehicle is unable to complete the MRM 2.1 maneuver as defined in MRC Triggers—Approaching Map Boundary, autonomous vehicle may complete an MRM 3.1 maneuver by the time it has reached the map's boundary.

XXIII.(m) MRC Triggers—Out of Map

If at any point an autonomous vehicle finds itself out of the map, the autonomous vehicle may immediately issue an MRM 3.2 command.

XXIII.(n) MRC Triggers—Missing Exit

If an autonomous vehicle misses its intended exit, it may execute the safest appropriate Minimal Risk Maneuver per further requirements in this section.

Missing Exit—Reachable Safety Area:

If an autonomous vehicle misses its intended exit and there is a reachable MRC 1 pre-mapped safety area, the autonomous vehicle may issue an MRC 1 command. Safety areas that require taking the next exit can be considered reachable. A reachable area may be defined as an area to which autonomous vehicle can plan a trajectory.

Missing Exit—Reachable Safety Area—MRC 3 Backup:

If an autonomous vehicle is unable to MRC 1 in the safety area (as outlined in Missing Exit—Reachable Safety Area), it may execute MRC 3.

Missing Exit—No Reachable Safety Area:

If an autonomous vehicle misses its intended exit and there is no reachable MRC 1 pre-mapped safety area, the autonomous vehicle may issue an MRC 3 command. A reachable area may be defined as an area to which the autonomous vehicle can plan a trajectory.

Missing Multiple Exits:

If an autonomous vehicle misses its intended exit and the next exit and is not already in the process of executing another MRC maneuver, an autonomous vehicle may MRC 3 on the highway.

XXIII.(o) MRC Triggers—Forced Off Route

When an autonomous vehicle is forced off of its intended route, it may execute the safest appropriate MRC maneuver per further requirements in this section.

Forced Off Route—Reachable Safety Area:

When autonomous vehicle is forced off of its intended route and there is a reachable MRC 1 pre-mapped safety area, the autonomous vehicle may issue an MRC 1 command.

A reachable area can be defined as an area to which an autonomous vehicle can plan a trajectory.

Forced Off Route—Reachable Safety Area—MRC 3 Backup:

When an autonomous vehicle is unable to MRC 1 in the safety area (as outlined in Forced Off Route—Reachable Safety Area), it may execute MRC 3.

Forced Off Route—No Reachable Safety Areas:

When an autonomous vehicle is forced off of its intended route and there is no reachable MRC 1 pre-mapped safety area, the autonomous vehicle may issue an MRC 3 command. A reachable area can be defined as an area to which an autonomous vehicle can plan a trajectory.

XXIII.(p) MRM Triggers—Lost Connection with Remote Operations Center

An autonomous vehicle may take action to reach the MRC_REDUCED_SPEED condition when it has lost connection with the remote operations center for more than a predetermined time period (e.g., longer than 2 consecutive minutes, longer than 3 consecutive minutes, longer than 4 consecutive minutes, longer than 5 consecutive minutes), unless traveling in a tunnel.

XXIII.(q) MRC Test Mode

The system may provide MRC testing functionality, which allows a test operations user to test MRC modes 1, 2, and 3.

XXIII.(r) MRC Test Mode Safeguards

The system may provide safeguards to limit unintended activation of MRC Test Mode, including a default setting on startup that MRC Test Modes are completely disabled and a user interface that does not allow false activation of MRC test modes.

### XXIV. Non-Compliant Drivers

XXIV.(a) Swerving Non-Compliant Driver Description

An autonomous vehicle may detect and classify the following vehicle scenarios, explained in greater detail below, as swerving non-compliant:
Non-Compliant Driver—Lane Crossing Vehicle Non-Compliant Driver—Oscillating Vehicle
Non-Compliant Driver—Too Close for Comfort

Non-Compliant Driver—Lane Crossing Vehicle:

An autonomous vehicle may detect and classify as non-compliant when a vehicle that is within a pre-determined distance (e.g., 100 meters, 150 meters, 200 meters, 250 meters) does any of the following: driving in front of autonomous vehicle in the same lane and any part of the vehicle (including mirrors) crosses a lane boundary without changing lanes; driving in a lane adjacent to autonomous vehicle's driving lane and any part of the vehicle (including mirrors) crosses a lane boundary without changing lanes; and driving in a lane two lanes over from autonomous vehicle's driving lane (e.g., the lane adjacent to autonomous vehicle's adjacent lane) and crosses the lane boundary into the lane adjacent to autonomous vehicle without changing lanes.

Non-Compliant Driver—Oscillating Vehicle:

When driving on lanes of standard width (3.66 meters), an autonomous vehicle may detect and classify as non-compliant when a vehicle that is within a pre-determined distance (e.g., 100 meters, 150 meters, 200 meters, 250 meters) and up to two lanes away comes within a pre-determined distance laterally (e.g., 10 cm, 15 cm, 20 cm, 30 cm) of a lane boundary more than three times in a pre-determined number of seconds (e.g., 5 seconds, 10 seconds, 15 seconds) without changing lanes.

Non-Compliant Driver—Too Close for Comfort:

When an autonomous vehicle is within the lesser of a pre-determined distance (e.g., 8 meters, 10 meters, 12 meters, 15 meters) or a pre-determined number of seconds (e.g., 2 s, 4 s, 5 s) of being parallel to an adjacent lane vehicle on a standard width lane (3.66 meters), autonomous vehicle may detect when the vehicle's widest point comes within (e.g., 10 cm, 15 cm, 20 cm, 30 cm) of the lane boundary intersecting the autonomous vehicle and the vehicle.

XXIV.(b) Swerving Non-Compliant Driver—Memory

Once a vehicle has been identified as swerving non-compliant, an autonomous vehicle may retain in memory that the vehicle is non-compliant until a pre-determined number of seconds (e.g., 5 s, 10 s, 15 s) have elapsed since the last non-compliant defining event or until the autonomous vehicle is no longer parallel (if applicable), whichever time is greater.

XXIV.(c) Non-Compliant Swerving Vehicle—General Behavior

An autonomous vehicle may minimize the amount of expected time spent driving parallel to a non-compliant swerving vehicle.

XXIV.(d) Already Parallel—Lane Crossing NCD

If any part of the autonomous vehicle combination (including trailer) is parallel to an NPC at the moment that it becomes lane crossing non-compliant, the autonomous vehicle may take action to minimize the time spent parallel with critical safety priority and a deceleration with magnitude less than or equal to a pre-determined vale (e.g., 1.5 m/s\hat{ }2, 2 m/s\hat{ }2, 3 m/s\hat{ }2).

Already Parallel—Lane Crossing NCD—Preferred Reaction:

When parallel to a lane crossing non-compliant NPC, an autonomous vehicle may prefer to critical safety bias, decelerate, and change lanes if possible. If autonomous vehicle can overtake the adjacent lane vehicle in less than a pre-determined distance (e.g., 100 meters, 150 meters, 175 meters, 200 meters) and the time to overtake is expected to be less than the time to decelerate out of being parallel, autonomous vehicle need not decelerate. To overtake means to be able to pass a vehicle to the extent that there is no overlap between the rearmost point of the autonomous vehicle combination (including trailer) and the frontmost point of the adjacent lane vehicle.

XXIV.(e) Already Parallel—Too Close for Comfort NCD

When an autonomous vehicle is parallel to a vehicle at the moment that it becomes “too close for comfort” non-compliant, the autonomous vehicle may take action to minimize the time spent parallel with non-critical safety priority and a pre-determined deceleration (e.g., a deceleration with a magnitude less than or equal to 1 m/s\hat{ }2, 1.5 m/s\hat{ }2, 2 m/s\hat{ }2, 2.5 m/s\hat{ }2).

Already Parallel—Too Close for Comfort NCD—Preferred Reaction:

When parallel to a “too close for comfort” non-compliant NPC, an autonomous vehicle may prefer to non-critical safety bias and decelerate. If the autonomous vehicle can overtake the adjacent lane vehicle in less than a pre-determined distance (e.g., 100 m, 150 m, 175 m, 200 m) and the time to overtake is expected to be less than the time to decelerate out of being parallel, the autonomous vehicle need not decelerate. To overtake means to be able to pass a vehicle to the extent that there is no overlap between the rearmost point of the autonomous vehicle combination (including trailer) and the frontmost point of the adjacent lane vehicle.

XXIV.(f) Autonomous Vehicle Behind Adjacent Lane Non-Compliant Driver (NCD)—Minimum Following Distance

When an autonomous vehicle is behind a swerving non-compliant driver in the adjacent lane, autonomous vehicle may aim to maintain a curve corrected longitudinal gap of at least a pre-determined distance (e.g., 15 meters, 20 meters, 25 meters, 30 meters measured from the frontmost point of the autonomous vehicle to the rearmost point of the NPC) or an adjacent lane following distance of at least a pre-determined number of seconds (e.g., 1 s, 2 s, 3 s, 5 s, 8 s, 10 s), whichever is greater, unless the adjacent lane vehicle is traveling 10 mph or more under the environmental speed.

This behavior may persist until the vehicle is no longer classified as swerving non-compliant.

Autonomous vehicle Behind Adjacent Lane NCD—Gap Growth:

As it relates to an autonomous vehicle Behind Adjacent Lane NCD—Minimum Following Distance, if autonomous vehicle is within a pre-determined distance longitudinally (e.g., 20 m, 25 m, 30 m, 35 m) or a pre-determined adjacent lane following distance in seconds (e.g., 1 s, 2 s, 3 s, 4 s) to the adjacent lane swerving non-compliant driver, autonomous vehicle may prefer to increase the longitudinal gap by at least a pre-determined velocity (e.g., 1 m/s, 1.5 m/s, 2 m/s, 3 m/s) until outside of this range.

An autonomous vehicle Behind Adjacent Lane NCD—Slow Vehicle—Preferred Strategy:

If an autonomous vehicle is behind a swerving non-compliant driver in the adjacent lane and the vehicle is traveling under the environmental speed by at least a pre-determined amount (e.g., 5 MPH, 8 MPH, 10 MPH, 12 MPH), the autonomous vehicle may prefer to change lanes away from the NPC when autonomous vehicle is at least a pre-determined distance (e.g., 100 m, 125 m, 150 m, 200 m) from the NPC.

Autonomous vehicle Behind Adjacent Lane NCD—Slow Vehicle—Alternative Strategy:

If autonomous vehicle is unable to change lanes by the time it has reached the adjacent lane swerving non-compliant driver that is traveling under the environmental speed by at least a pre-determined amount (e.g., 5 mph or more, such as 8 mph under the environmental speed, and including 10 mph under the environmental speed), autonomous vehicle may critical safety bias away from the NPC and overtake the vehicle only if autonomous vehicle can maintain a pre-determined minimum lateral distance (e.g., 0.5 meters, 0.7 meters, 1.0 meter measured from the widest point of the autonomous vehicle combination to the widest point of the NPC). Otherwise autonomous vehicle may avoid driving parallel.

An autonomous vehicle Behind Adjacent Lane NCD—Slow Vehicle—Passing Speed:

When overtaking an adjacent lane, swerving non-compliant, slow-moving vehicle as described in autonomous vehicle Behind Adjacent Lane NCD—Slow Vehicle—Alternative Strategy, the autonomous vehicle may maintain a max speed differential of an increase of a pre-determined amount relative to the NPC (e.g., +10 mph, +15 mph, +20 mph, +25 mph relative to the NPC), unless this upper bound is more than a pre-determined number of mph under the speed limit (e.g., 15 mph, 20 mph, 25 mph, 30 mph under the speed limit) or governing speed, in which case the autonomous vehicle may travel that pre-determined number of mph (e.g., 15 mph, 20 mph, 25 mph, 30 mph under the speed limit) under the speed limit or governing speed.

XXIV.(g) Autonomous Vehicle in Front of Adjacent Lane NCD—General Strategy

When an autonomous vehicle is in front of (but not parallel to) an adjacent lane swerving non-compliant driver that is traveling at a speed greater than autonomous vehicle's and is within a pre-determined number of seconds of being parallel (e.g., 2 seconds from being parallel, 3 seconds from being parallel, 4 seconds from being parallel, 5 seconds from being parallel), autonomous vehicle may prefer to non-critical safety bias and decelerate/accelerate to minimize the time spent parallel with a deceleration with a pre-determined magnitude (e.g., less than or equal to 1.5 m/s\hat{ }2, 2 m/s\hat{ }2, or 2.5 m/s\hat{ }2), unless autonomous vehicle cannot maintain a pre-determined minimum lateral distance (e.g., 0.5 meters, 0.7 meters, 1.0 meter measured from the widest point of the autonomous vehicle combination to the widest point of the NPC), in which case autonomous vehicle may change lanes (preferred) or critical safety bias and decelerate/accelerate with a deceleration with a pre-determined magnitude (e.g., less than or equal to 1.5 m/s\hat{ }2, 2 m/s\hat{ }2, or 2.5 m/s\hat{ }2) to minimize the time spent parallel.

XXIV.(h) Non-Compliant Vehicle—Two Lanes Over

When there is a swerving non-compliant driver two lanes over from autonomous vehicle's current lane (the lane adjacent to autonomous vehicle's adjacent lane), with critical safety priority, the system may deny autonomous vehicle changing lanes into the lane adjacent to the non-compliant vehicle if the longitudinal distance on completion of the lane change would be less than a pre-determined number of meters (e.g., 15 m, 20 m, 25 m, 30 m).

### XXV. Over-Sized Vehicles

XXV.(a) Description of over-sized vehicle

An autonomous driving system may recognize the oversized vehicles and odd vehicles with protrusions whether marked oversized or not. A NPC may be defined as an over-sized vehicle if any of its dimensions exceed a length of more than a first pre-determined dimension (e.g., 18 m (59 ft), 19 m (62 ft), 20 m (66 ft), 21 m (69 ft), 22 m (72 ft), 23 m (75 ft), 24 m (78.7 ft), 25 m (82 ft)), a width of more than a second pre-determined dimension (e.g., 2.28 m (7.5 ft), 2.43 m (8 ft), 2.59 m (8.5 ft), 2.74 m (9 ft)), or a height of more than a third pre-determined dimension (e.g., 3.66 m (12 ft), 3.96 m (13 ft), 4.27 m (14 ft), 4.57 m (15 ft)).

XXV.(b) Over-sized vehicle detection

An autonomous vehicle may be able to detect the over-sized vehicle no later than a pre-determined distance (e.g., 91.4 meters (300 feet), 121.9 meters (400 feet), 152.4 meters (500 feet), 182.9 meters (600 feet)) before reaching the over-sized vehicle.

XXV.(c) Passing Over-sized Vehicle Convoy

If conditions allow, an autonomous vehicle may change lanes as soon as it detects the over-sized vehicle or its convoy and start to react no later than a pre-determined distance (e.g., 91.4 meters (300 feet), 121.9 meters (400 feet), 152.4 meters (500 feet), 182.9 meters (600 feet)) before reaching the over-sized vehicle or its convoy.

Lane Change Priority:

An autonomous vehicle may prioritize lane change to pass the over-sized vehicle or the over-sized vehicle convoy if the oversize vehicle or the over-sized vehicle convoy is more than a pre-determined number of MPH slower (e.g., 8 MPH slower, 10 MPH slower, 12 MPH slower, 15 MPH slower) than autonomous vehicle as per efficiency lane change.

Lane Change Preference:

One empty lane between an autonomous vehicle and over-sized vehicle to minimize interaction while driving parallel to over-sized vehicles.

Lane Change and Biasing:

When an autonomous vehicle is unable to keep an empty lane between itself and the over-sized vehicle, and the over-sized vehicle does not penetrate the adjacent lane, the autonomous vehicle may change lane to a lane adjacent to the over-sized vehicle and engage non-critical safety bias to pass.

XXV.(d) Following the over-sized vehicle

When it is unable to change lane to pass, an autonomous vehicle may follow behind the last vehicle of the oversize vehicle convoy while maintaining an appropriate following distance with the last vehicle of the oversize vehicle convoy.

Following Condition—Efficiency:

autonomous vehicle may follow the over-sized vehicle or its convoy if the over-sized vehicle or its convoy is not a slow-moving vehicle.

Following Condition—Lane Penetration:

Autonomous vehicle may follow the over-sized vehicle or its convoy if the autonomous vehicle is unable to pass due to over-sized vehicle penetrating the passing lane.

XXV.(e) Over-sized Vehicle Convoy

An autonomous vehicle may treat the over-size vehicle and its escorts as a convoy.

Convoy Description:

A convoy can be defined as vehicles travelling in a group that is within a constant distance and speed of each other indicated by appropriate signs or markers to reflect the bounds of the group.

Examples of a convoy may include: over-sized vehicles and escorts; military vehicles; VIP motorcades; and funeral motorcades.

Escort Recognition:

An autonomous vehicle may be able to recognize over-sized vehicle's escort vehicles in the convoy. Escort vehicles will typically display a yellow sign that reads ‘oversize load’ and may have optional yellow or red flags on both sides of the vehicle.

No Cut-In Over-sized Vehicle Convoy:

An autonomous vehicle may avoid cutting in between any vehicles within the over-sized vehicle convoy.

XXV.(f) Over-Sized Vehicle Memory

An autonomous vehicle may retain in memory for a minimum of a pre-determined number of seconds (e.g., 10 seconds, 15 seconds, 20 seconds) the presence of an over-size vehicle that is later fully or partially occluded from view.

### XXVI. Motorcycles

XXVI.(a) Motorcycle Description

An autonomous vehicle may define motorcycle as a motor vehicle with motive power having a seat or saddle for the use of the rider and designed to travel on not more than three wheels with the wheel rim diameter of at least 10 inches in contact with ground.

Motorcycles, as a class or vehicle type, may include motor scooters, mopeds, motor-powered bicycles, and three-wheel motorcycles.

An autonomous vehicle may categorize motorcycles in different groups as 2-wheel motorcycles & 3-wheel motorcycles, since this affects the maneuver capabilities.

XXVI.(b) Group of Motorcycles Description

An autonomous vehicle may define a group of motorcycles as at least a pre-determined number of motorcycles (e.g., 2 or more, 3 or more, 4 or more) driving in the same lane; if they are within a pre-determined threshold distance (e.g., at most 40 m apart, at most 50 m away from each other, at most 60 m apart) and there are no other type of vehicles in between.

XXVI.(c) Motorcycle Lane Straddling Description

An autonomous vehicle may define lane straddling as a motorcycle driving within a pre-determined distance (e.g., 2 feet, 3 feet, 4 feet) of a marked line (center of motorcycle to center of lane marker) as opposed to driving in between two marked lines.

XXVI.(d) Motorcycle Detection

An autonomous vehicle may detect the motorcycle(s) and associated lane(s) from a pre-determined minimum threshold distance (e.g., at least 125 m away, at least 150 m away, at least 200 m away).

An autonomous vehicle may detect the motorcycles in its current lane and adjacent lanes.

An autonomous vehicle may detect motorcycles in all other lanes from a pre-determined minimum threshold distance away (e.g., at least 75 m away, at least 100 m away, at least 125 m away).

An autonomous vehicle may detect different categories of motorcycles; e.g., 2 wheel motorcycles, 3 wheel motorcycles, motorcycles with sidecar, since this affects the maneuvering capabilities.

An autonomous vehicle may detect (and predict) maneuvers and sudden movements of motorcycles in all lanes from a minimum threshold distance away (e.g., at least 40 m away, at least 50 m away, at least 60 m away).

An autonomous vehicle may be able to handle the micro-doppler effect of wheels to avoid wrong detection of motorcycle speed. (This is regarding radar detection for speed estimation).

XXVI.(e) Group of Motorcycles Detection

An autonomous vehicle may detect a group of motorcycles and the associated lane from a minimum threshold distance (e.g., at least 125 m away, at least 150 m away, at least 175 m away).

XXVI.(f) Motorcycle Lane Straddling Detection

An autonomous vehicle may detect motorcycles that do lane straddling from a pre-determined threshold distance (e.g., at least 125 m away, at least 150 m away, at least 175 m away) in autonomous vehicle's current lane and adjacent lanes.

Straddling in a lane includes straddling on both lane markings sides of the lane.

XXVI.(g) Motorcycle Planning

An autonomous vehicle may maintain a pre-determined minimum safe distance (e.g., at least 125 m, at least 150 m, at least 175 m away) from a motorcycle while following it as the target vehicle.

An autonomous vehicle may avoid merging into the lane of a motorcycle within a pre-determined distance (e.g., 125 m, 150 m, 175 m) of autonomous vehicle.

An autonomous vehicle may avoid sharing a lane with motorcycles.

A safe distance from a motorcycle may be twice the distance of a standard vehicle. Alternatively or additionally, a safe distance between a motorcycle and an autonomous vehicle may be twice the distance needed between a standard vehicle and an autonomous vehicle.

Motorcycles typically can stop faster and accelerate faster than regular vehicles.

Currently, California is the only state in the United States where motorcycles can share a lane with other vehicles. Some other states are considering lane sharing laws as well.

XXVI.(h) Passing a Motorcycle

An autonomous vehicle may pass a motorcycle only when it is safe to do so.

An autonomous vehicle may avoid passing a motorcycle in the curves of more than a pre-determine number of degrees (e.g., 10 degrees, 15 degrees, 20 degrees, 25 degrees, 30 degrees) on arbitrary roads.

An autonomous vehicle may only pass a lane splitting motorcycle from at least a lane over.

XXVI.(i) Group of Motorcycles Classification

An autonomous vehicle may consider each motorcycle in a group of motorcycles as an individual motorcycle and follow the same requirements.

Autonomous vehicle may avoid merging between the group of motorcycles and into their lanes.

XXVI.(j) Motorcycle Lane Straddling Behavior

An autonomous vehicle may interact with lane straddling motorcycle(s) autonomously and safely.

An autonomous vehicle may avoid blocking a lane straddling motorcycle(s) from passing it, if it is possible and safe to do so.

An autonomous vehicle may avoid passing a motorcycle that is straddling a lane.

An autonomous vehicle may move to the left (right) of their lane to give motorcyclists ample room to pass when the autonomous vehicle is in the far left (right) lane.

At the time of filing, California is the only state in the United States where motorcycle lane straddling is legal. Some other states are considering lane straddling laws for motorcycles as well.

### XXVII. Road Debris and Unknown Objects

XXVII.(a) Detection of Tire Treads

An autonomous vehicle may be able to detect and classify tire treads on the roadway that are taller than a first pre-determined dimension (e.g., 10 cm (3.94 in), 15 cm (5.91 in.), 20 cm (8 in)) or longer than a second pre-determined dimension (e.g., 15 cm (5.91 in), 30 cm (11.8 in.), 45 cm (17.7 in)) from at least a pre-determined distance (e.g., from at least 90 meters, 100 meters, 110 meters, 120 meters) on the autonomous vehicle's projected path of travel and on any lane or shoulder adjacent to autonomous vehicle's path.

XXVII.(b) Detection of Unknown Objects—Small Objects

An autonomous vehicle may be able to detect objects with height between two pre-determined lengths (e.g., between 10 cm (3.94 in.) and 15 cm (5.91 in.), between 15 cm (5.91 in.), 20 cm (8 in)) from at least a pre-determined distance on autonomous vehicle's projected path of travel (e.g., from at least 70 m, 80 m, 90 m, 100 m, 110 m, 120 m) and on any lane or shoulder adjacent to autonomous vehicle's path.

XXVII.(c) Detection of Unknown Objects—Medium Objects

An autonomous vehicle may be able to detect objects with height between two pre-determined lengths (e.g., between 15 cm (5.91 in.) and 25 cm (9.81 in.), 20 cm (8 in) and 30 cm (11.8 in)) from at least a pre-determined distance on autonomous vehicle's projected path of travel (e.g., from at least 70 m, 80 m, 90 m, 100 m, 110 m, 120 m) and on any lane or shoulder adjacent to autonomous vehicle's path.

XXVII.(d) Detection of Unknown Objects—Large Objects

An autonomous vehicle may be able to detect objects with height between two pre-determined lengths (e.g., between 25 cm (9.81 in.) and 40 cm (15.75 in.), between 30 cm (11.8 in) and 50 cm (19.62 in)) from at least a pre-determined distance on autonomous vehicle's projected path of travel (e.g., from at least 100 m, 110 m, 120 m, 130 m, 140 m) and on any lane or shoulder adjacent to the autonomous vehicle's path.

XXVII.(e) Detection of Unknown Objects—Extra-Large Objects

An autonomous vehicle may be able to detect objects with height greater than a pre-determined length (e.g., greater than 40 cm (15.75 in.), greater than 50 cm (19.62 in)) from a distance that is far enough to allow autonomous vehicle to come to a complete stop or a pre-determined distance (e.g., 125 meters, 150 meters, 175 meters) whichever distance is greater.

XXVII.(f) Pedestrian-Sized Unknown Object—Driving Lane—Complete Stop

When a static or moving unknown object with a height greater than a pre-determined value equivalent to a small pedestrian (e.g., 0.5 meters, 0.75 meters, 1 meter, 1.25 meters, 1.5 meters) is in a driving lane of the carriageway, autonomous vehicle may come to a complete stop before reaching the object, regardless of autonomous vehicle's current driving lane, unless the object is in an outermost lane (rightmost driving lane on a multilane road) and there is a stopped vehicle in the same lane within a pre-determined distance (e.g., 1.5 meters, 2 meters, 2.5 meters, 3 meters).

XXVII.(g) Pedestrian-Sized Unknown Object—Driving Lane—Complete Stop—MRC

When an autonomous vehicle comes to a complete stop for a pedestrian-sized unknown object, the operations team (e.g., chase vehicle operators, remote control operator (RCO)) may issue an MRC 3 command.

XXVII.(h) Pedestrian-Sized Unknown Object—Outermost Lane—Nearby Stopped Vehicle

When a static or moving unknown object with a height greater than a pre-determined height (e.g., 0.5 meters, 0.75 meters, 1 meters) is in an outermost lane (rightmost driving lane) of the carriageway and there is a stopped vehicle in the same lane within a pre-determined distance (e.g., 0.5 meters, 1 meter, 1.5 meters, 2 meters), autonomous vehicle may be able to pass the object and treat it as if it were a pedestrian.

XXVII.(i) Pedestrian-Sized Unknown Object—On Shoulder or Gore Area

When a static or moving unknown object with a height greater than a pre-determined height (e.g., 0.5 meters, 0.75 meters, 1 meter, 1.25 meters, 1.5 meters) is on the shoulder or gore area, autonomous vehicle may be able to pass the object and treat it as if it were a pedestrian.

XXVII.(j) Moving Unknown Objects—Avoid Contact

An autonomous vehicle may preferably avoid coming into contact with any moving unknown objects, excluding flying debris.

XXVII.(k) Static Objects—Obstacle Avoidance Strategy

On detection of a tire tread or static unknown object, an autonomous vehicle may reduce its speed and bias, straddle, or change lanes in order to avoid contact.

Straddling Restrictions:

An autonomous vehicle may allow straddling of static objects only if the objects are shorter than the ground clearance of autonomous vehicle's front bumper and narrower than the minimum wheel inside spacing across all of autonomous vehicle's axles.

Extended Lane Bias for Obstacle Avoidance:

An autonomous vehicle may extend the lane bias past a lane boundary for obstacle avoidance only when (1) doing so would not result in a collision and (2) biasing within the lane, straddling within the lane, and fully changing lanes are not feasible options.

Multiple Static Obstacles and Swerving:

An autonomous vehicle may avoid swerving back and forth when avoiding multiple static obstacles in its path of travel. If the presence of multiple static obstacles in autonomous vehicle's path of travel would require autonomous vehicle to swerve back and forth, autonomous vehicle may change lanes.

Obstacle Avoidance—Priority of Maneuvers:

In some embodiments, an autonomous vehicle may prefer changing lanes over biasing over straddling when reacting to static objects.

Lane Change and Bias Priority:

An autonomous vehicle may change lanes, deny changing lanes, and bias with critical safety intent when reacting to static objects.

Obstacle Avoidance—When to Come to Complete Stop:

If an autonomous vehicle is unable to lane change, bias, or straddle to avoid contact with a static object taller than a pre-determined height (e.g., 10 cm (3.94 in.), 15 cm (5.91 in)), the autonomous vehicle may come to a complete stop before reaching the static object.

Obstacle Avoidance—Run Over Static Object:

If an autonomous vehicle is unable to lane change, bias, or straddle to avoid contact with a static object shorter than a pre-determined length (e.g., 8 cm, 10 cm, 15 cm), the autonomous vehicle may slow down and run over the static object.

Max Passing Speed when Contact Cannot Be Avoided:

When contact with a static object that is shorter than a pre-determined length (e.g., 8 cm, 10 cm, 15 cm) cannot be avoided, an autonomous vehicle may maintain a max passing speed of the speed less a pre-determined velocity (e.g., 10 mph below the speed limit, 15 mph below the speed limit, 20 mph below the speed limit, 25 mph below the speed limit) and maintain truck stability as contact is made with the obstacle.

Obstacle Avoidance—Max Passing Speed When Biasing:

XXVII.(l) Damage Detection

An autonomous vehicle may be able to detect when there is significant damage due to an unknown object, including a loss of tire pressure, loss of fuel pressure, loss of oil pressure, and any other mechanical or electrical deviation from normal operating conditions.

XXVII.(m) Damage to autonomous vehicle

If an autonomous vehicle is damaged by an obstacle, autonomous vehicle may MRC according to the fault mapping by Functional Safety.

XXVII.(n) Notify Oversight

An autonomous vehicle may notify the Oversight system whenever it takes action as a direct result of road debris or unknown objects.

XXVII.(o) Map Update for Road Debris

On detection of road debris or an unknown object, the map may be updated in real-time to reflect the location of the object.

### XXVIII. Stop Sign Intersections

XXVIII.(a) Stopping Behavior at Stop Signs

At an intersection controlled by a stop sign, an autonomous vehicle may make a complete stop for the sign as indicated below:
Stopping Location—Stop Lines
   For intersections with stop lines, an autonomous vehicle may stop before the autonomous vehicle's front bumper crosses the stop line and no further than a pre-determined distance (e.g., 0.5 meters, 1 meter, 1.5 meters, 2 meters, 2.5 meters, 3 meters) from the stop line.
Stopping Location—Crosswalk Lines
   For intersections without stop lines but with crosswalk lines, an autonomous vehicle may stop before the autonomous vehicle's front bumper crosses the nearest crosswalk line and no further than a pre-determined distance (e.g., 0.5 meters, 1 meter, 1.5 meters, 2 meters, 2.5 meters, 3 meters) from the crosswalk line.
Stopping Location—Stop Signs
   For intersections without stop lines or crosswalk lines, an autonomous vehicle may stop before the autonomous vehicle's front bumper reaches the stop sign and no further than a pre-determined distance (e.g., 0.5 meters, 1 meter, 1.5 meters, 2 meters, 2.5 meters, 3 meters) from the stop sign

Stopping Duration:

When stopping for a stop sign intersection, an autonomous vehicle may remain stopped for at least a pre-determined number of seconds (e.g., at least 0.5 seconds, at least 1 second, at least 1.5 seconds, at least 2 seconds).

XXVIII.(b) Stop Sign Intersections—Yield to Through Traffic

At an intersection controlled by a stop sign, an autonomous vehicle may yield the right of way to any vehicles that are traveling in lanes that are not required to stop and whose paths are intersected by the autonomous vehicle's planned path. The autonomous vehicle may recognize lanes that do not require the vehicles travelling therein to stop by use of any of the following: the on-board map, and the detection of signs, the lack thereof, which indicates which lanes need to stop.

Through Traffic Yielding Description:

At an intersection controlled by a stop sign, an autonomous vehicle may proceed through the intersection only if any through traffic NPC would be expected to decelerate less than a pre-determined rate in order to allow the autonomous vehicle to transition to its target lane. An NPC's expected average deceleration may take into account its speed, distance from autonomous vehicle for the duration of autonomous vehicle's turn, and the average human reaction time.

XXVIII.(c) Stop Sign Intersections—Yield to Vehicles That Stopped First

When an autonomous vehicle is required to stop at an intersection where more than one direction of travel is controlled by a stop sign, the autonomous vehicle may yield the right of way to vehicles required to stop in the any of the following scenarios: vehicles that stopped prior to autonomous vehicle stopping at its stop sign; vehicles that stopped at the same time as autonomous vehicle and are to the right of autonomous vehicle; and vehicles that stopped at the same time as autonomous vehicle are directly across from autonomous vehicle and intend to turn right while autonomous vehicle intends to turn left.

Stopped Vehicles Yielding Description:

When yielding to an NPC that was previously stopped at a stop sign intersection, an autonomous vehicle may proceed through the intersection only if the NPC has cleared the intersection.

Stopped Vehicles Yielding—Time Consideration:

An autonomous vehicle may wait at least a pre-determined number of seconds when yielding for an NPC at a stop sign that is not yielding to other vehicles with the right of way. If the NPC has not attempted to proceed through the intersection within that time, the autonomous vehicle may proceed through the intersection after yielding to other vehicles with the right of way.

Negotiate and Yield to Vehicles that Assume the Right of Way:

Even if an autonomous vehicle has the right of way at an intersection controlled by multiple stop signs, the autonomous vehicle may negotiate and yield to vehicles that assume the right of way.

XXVIII.(d) Stop Sign Intersections—TTC (Time-to-Collision) Stop

After an autonomous vehicle has made a complete stop for a stop sign at an intersection, the autonomous vehicle may be able to creep forward to a second stop as needed for better perception of cross traffic. This second stop may be known as a TTC stop.

Description of Creeping Forward:

Creeping can be defined as the action of moving forward at a rate less than a pre-determined speed (e.g., 0.5 mph, 1 mph, 2 mph, 3 mph, 4 mph, 5 mph).

TTC Stop—Remain Outside of Driving Lanes of Intersection:

When creeping forward for a TTC stop, an autonomous vehicle's front bumper may remain outside of any driving lanes in the intersection.

TTC Stop—Stopping Duration:

An autonomous vehicle may remain stopped for at least a pre-determined number of seconds at a TTC stop.

TTC Stop—Wait Until No Longer Yielding:

If an autonomous vehicle is actively yielding to an NPC, the autonomous vehicle may wait until it is no longer yielding before creeping forward to the TTC stop.

XXVIII.(e) T-Intersections—Non-Through Lane

When an autonomous vehicle is in a non-through lane at a T-intersection, the autonomous vehicle may treat the intersection as a stop sign intersection, even in the absence of a physical stop sign.

XXVIII.(f) Flashing Red Intersections

When an autonomous vehicle encounters a traffic light at a signalized intersection that is flashing red, the autonomous vehicle may treat the intersection as a stop sign intersection.

XXVIII.(g) Proceed With Unobstructed View Only

When at a stop sign intersection or when turning at a signalized intersection, an autonomous vehicle may only enter and proceed through the intersection if the autonomous vehicle has an unobstructed view of the lane(s) it is about to cross up to the distance required to safely yield to through vehicles which may be present, unless the obstructing object would not negatively affect the yielding procedure.

### XXIX. Accepting Cutting-In

XXIX.(a) Cut-In Description

An autonomous vehicle can define a cut-in vehicle as a vehicle that changes partially or completely into autonomous vehicle's lane of travel within the Minimum Gap Description.

XXIX.(b) Critical Distance Cut-In

When a vehicle cuts in within the Critical Following Distance, an autonomous vehicle may decelerate at a rate that ensures a gap growth rate (e.g., relative velocity) of pre-determined speed, or change in gap size per unit time, such as 0.5 m/s, 1 m/s, 2 m/s, or 3 m/s, between the front bumper of autonomous vehicle and the rear bumper of the cut-in vehicle. autonomous vehicle may ramp up deceleration by a pre-determined rate in non-critical scenarios.

XXIX.(c) Inside the Minimum Gap Cut-In

If a vehicle cuts-in beyond the Critical Following Distance but within the minimum gap, an autonomous vehicle may follow the behavior outlined in Restore The Minimum Gap.

XXIX.(d) Turn Signal Indicator Description

Autonomous vehicle may define a Turn Signal Indicator as amber colored flashing lights on the rear, side, or front of an NPC that is flashing on only one side of the vehicle, indicating that the NPC would like to change lanes to the side that the turn signal is flashing.

XXIX.(e) Predicting a Cut-In Vehicle

Autonomous vehicle may predict when an NPC is attempting to cut in.

Autonomous vehicle may consider NPC as attempting to cut in if any of the following conditions are met: a non-player character vehicle (NPC) switched on signal lights in the direction facing autonomous vehicle's current lane; an NPC is biasing toward the autonomous vehicle's current lane by more than a pre-determined distance; an NPC is moving laterally towards autonomous vehicle's lane by more than a pre-determined rate; and an NPC is traveling with average velocity more than a speed equal to autonomous vehicle's current velocity less a pre-determined value.

Predicting a Critical Distance Cut-In:

When Predicting a Cut-In Vehicle inside the Critical Following Distance, an autonomous vehicle may begin Critical Distance Cut-in behavior.

Predicting a Inside the Minimum Gap Cut-In:

When predicting a Cut-In Vehicle outside of the Critical Following Distance but inside the Minimum Gap, autonomous vehicle may begin Inside the Minimum Gap Cut-in behavior.

### XXX. Accepting Merge-Ins

XXX.(a) Accept Merge-In Description

An autonomous vehicle may define accept merge-in as any NPC merging into the autonomous vehicle's lane at a merge area where autonomous vehicle has the right of way.

An autonomous vehicle has the right of way when autonomous vehicle is on a lane that is not ending or leaving the highway, such as standard on-ramps, k-ramps, and lane ending merges.

XXX.(b) Monitor Road Users In Merge Locations

An autonomous vehicle may constantly monitor the velocity, location, and blinker status of each road user merging or potentially merging into the autonomous vehicle's lane of travel.

Earliest Merge Location:

An autonomous vehicle may predefine in the map the earliest compliant merge location for each merge.

For on-ramp merge scenarios, the earliest merge location is defined as the end of a gore area which is followed by no lines or dashed white lines. If a solid white line continues past the gore area, the end transition point of solid white line to dotted white line is the earliest merge location. For lane ending merge scenarios, the earliest merge location is defined as the point where the first signage occurs that indicates a lane ending.

Predict Merge Location:

An autonomous vehicle may predict the merge point of each merging or potentially merging vehicle.

An autonomous vehicle may define the merge point for each merging vehicle as the point at which their tires cross into the autonomous vehicle's lane. In cases where there is not a lane line on one side, the autonomous vehicle may use the standard lane width as an assumption for measurement of the merge point.

Perception on Ramps:

An autonomous vehicle may monitor the speed and velocity of all vehicles on ramps that may arrive at the earliest merge point within a pre-determined number of seconds or a pre-determined amount of curvature corrected longitudinal distance (e.g., 100 m, 125 m, 150 m, 175 m) of autonomous vehicle's front bumper passing the earliest merge point.

XXX.(c) Accept Merge Nominal Behaviors and Interactions

Autonomous vehicle may define a set of nominal behaviors to accept merging vehicles, including lane change, accelerating, maintaining speed, and yielding to one or more vehicles.

Lane Change:

An autonomous vehicle may have a non-critical safety lane change intention to change out of the adjacent lane to the merge point when any of the following conditions are met: there are multiple vehicles merging in; there is a large vehicle merging in; there is a vehicle that is predicted to remain slow merging in (and would be in front of autonomous vehicle); and the predicted bumper-to-bumper distance to any NPC at their expected merge time is less than autonomous vehicle's preferred front gap distance.

If an autonomous vehicle is not in the adjacent lane to the merge point, the autonomous vehicle may have a non-critical safety lane change denier. When an NPC is projected to be behind autonomous vehicle at the NPC's expected merge time and there is no other NPC that is expected to be in front of or parallel to autonomous vehicle autonomous vehicle preferably may not have an intention (or denier) to change lanes.

One Vehicle Merge—Maintain Speed Preference:

An autonomous vehicle may prioritize maintaining its current speed and heading when approaching a merge with only one vehicle in the monitoring area on the ramp.

One Vehicle Merge—Yield:

An autonomous vehicle may yield via the minimum deceleration necessary to comply with autonomous vehicle Safest Plan within Preferred Following Distance when the vehicle merging is predicted to intersect with any part of autonomous vehicle at the merge location.

Multi-Vehicle Merge—Maintain Speed:

If an autonomous vehicle is approaching a merge interaction in its current lane and autonomous vehicle predicts that the rear bumper of the trailer will be in front of any merging road user at their individual merge points, the autonomous vehicle may continue with no modification to its planned trajectory.

Multi-Vehicle Merge—Gap Negotiation:

When an autonomous vehicle predicts that one or more vehicles will be parallel or in front of autonomous vehicle at the merge point, the autonomous vehicle may seek a gap between or behind the merging vehicles. An autonomous vehicle may seek the gap that minimizes total expected reduction in velocity in m/s (autonomous vehicle deceleration+Target back deceleration).

Target back deceleration is defined as the expected reduction in velocity of the vehicle that is predicted to be behind autonomous vehicle at the completion of the merge as measured from its current predicted speed.

XXX.(d) K-Ramp Accept Merge-In

An autonomous vehicle may navigate K-ramp accept merge-in scenarios using a model to predict whether the vehicle on the K-ramp will merge into autonomous vehicle's lane.

An autonomous vehicle may consider a vehicle as attempting to merge in off of a k-ramp if the following conditions are met: the NPC has engaged its turn signals in the direction of the autonomous vehicle's lane; the NPC is moving laterally towards the autonomous vehicle's lane by more than a pre-determined rate (m/s); the NPC has biased toward the autonomous vehicle's lane by more than a pre-determined distance; and the NPC has a velocity greater than a value that is equal to the autonomous vehicle's current velocity less a pre-determined threshold amount (in MPH or m/s).

K-ramp Lane Change:

An autonomous vehicle may have a non-critical safety lane change intention to change out of the adjacent lane to the merge point when there are any NPCs on the K-ramp for a K-ramp shorter than a pre-determined distance/length when measured from the start to the end of the merge area. If the autonomous vehicle is not in the adjacent lane to the merge point, autonomous vehicle may have a non-critical safety lane change denier.

### XXXI. Heavy Traffic or Traffic Jam

XXXI.(a) Traffic Description—Take Into Account Surrounding Vehicles

When identifying heavy traffic, traffic jams, and lines of traffic, an autonomous vehicle may take into account the number of vehicles, the spacing between the vehicles, and the speed at which the vehicles are traveling.

XXXI.(b) Heavy Traffic Description

Autonomous vehicle may identify heavy traffic on the highway when all of the following conditions are met: there are vehicles in every lane, excluding lanes that lead to an exit from the roadway or are blocked off due to construction; the average speed of vehicles in these lanes is more than a pre-determined number of mph (e.g., 20 mph, 30 mph, 40 mph) under the speed limit or is less than an absolute pre-determined speed (e.g., 20 mph, 25 mph, 30 mph, 35 mph, 40 mph); and the average bumper-to-bumper longitudinal distance between consecutive vehicles in each of these lanes is less than a pre-determined distance (e.g., 15 meters, 20 meters, 25 meters, 30 meters, 35 meters).

XXXI.(c) Traffic Jam Description

Autonomous vehicle may identify a traffic jam on the highway when all of the following conditions are met: there are vehicles in every lane, excluding lanes that lead to an exit from the roadway or are blocked off due to construction; the average speed of vehicles in these lanes is more than a pre-determined number of mph (e.g., 30 mph, 40 mph, 50 mph, 60 mph) under the speed limit or is less than a pre-determined absolute speed (e.g., 8 mph, 10 mph, 12 mph, 15 mph); and the average bumper-to-bumper longitudinal distance between consecutive vehicles in each of these lanes is less than a pre-determined distance (e.g., 8 meters, 10 meters, 12 meters, 14 meters).

XXXI.(d) Line of Traffic Description

Autonomous vehicle may identify a line of traffic on the highway when all of the following conditions are met: there are multiple vehicles in any one specific lane, including lanes that lead to an exit from the roadway; the average speed of vehicles in the lane is more than a pre-determined number of mph (e.g., 30 mph, 40 mph, 50 mph, 60 mph) under the speed limit or is less than a pre-determined absolute speed (e.g., 8 mph, 10 mph, 12 mph, 15 mph); and the average bumper-to-bumper longitudinal distance between consecutive vehicles in the lane is less than a pre-determined distance (e.g., 8 meters, 10 meters, 12 meters, 14 meters).

XXXI.(e) Heavy Traffic—Detection Distance

An autonomous vehicle may be able to perceive heavy traffic, traffic jams, and lines of traffic from a distance of at least a pre-determined number of meters (e.g., 200 meters, 250 meters, 300 meters) or the distance required to come to a complete stop under a pre-determined constant deceleration (e.g., −1.25 m/s\hat{ }2, −1.5 m/s\hat{ }2, −1.75 m/s\hat{ }2, −2.0 m/s\hat{ }2), whichever distance is greater, unless occluded by a curved road or hill.

XXXI.(f) Heavy Traffic—Slow Down Strategy

On detection of a traffic jam, heavy traffic, or a line of traffic in the current driving lane, autonomous vehicle may begin to slow down and match the speed of the upcoming vehicles. On detection of a line of traffic in an adjacent lane, the autonomous vehicle may slow down such that the Max Passing Speed requirement is met.

XXXI.(g) Heavy Traffic—Max Passing Speed

When an autonomous vehicle is driving in heavy traffic, a traffic jam, or a lane adjacent to a line of traffic, the autonomous vehicle may maintain a relative velocity with nearby vehicles that is less than a pre-determined velocity (e.g., 15 mph, 20 mph, 25 mph, 30 mph).

XXXI.(h) Heavy Traffic—Hazard Lights

When slowing down for heavy traffic, a traffic jam, or a line of traffic on the highway and an autonomous vehicle's speed is more than a pre-determined number of mph (e.g., 15 mph, 18 mph, 20 mph, 22 mph, 25 mph) below the speed limit or is below a pre-determined threshold velocity (e.g., 30 mph, 35 mph, 40 mph, 45 mph, 50 mph) the autonomous vehicle may turn on the hazard lights to warn other drivers.

Heavy Traffic—Hazard Lights—When to Turn Off—Vehicles Behind autonomous vehicle

An autonomous vehicle may turn off the hazard lights when it is within a pre-determined number of meters (e.g., 40 meters, 45 meters, 50 meters, 55 meters, 60 meters) of the vehicles in autonomous vehicle's lane and there are vehicles behind autonomous vehicle.

Heavy Traffic—Hazard Lights—Lane Change Exception

An autonomous vehicle may temporarily turn off the hazard lights when changing lanes and resume the hazard light usage on completion of the lane change.

XXXI.(i) Heavy Traffic—Minimum Following Distance

When following vehicles in heavy traffic, traffic jams, or lines of traffic, autonomous vehicle may maintain a minimum following distance as defined in Minimum Following Distance for Traffic Jams.

XXXI.(j) Heavy Traffic—Stopped Distance

When both the leading vehicle and an autonomous vehicle come to a stop due to heavy traffic, traffic jams, and lines of traffic, the autonomous vehicle may maintain a recommended stopped distance (e.g., 1 meter, 2 meters, 3 meters, 4 meters, 5 meters, 6 meters).

XXXI.(k) Heavy Traffic—Pre-Emptive Lane Change for Upcoming Exit

When an autonomous vehicle is approaching heavy traffic or a traffic jam and autonomous vehicle's exit is within a pre-determined number of miles (e.g., 3 miles, 4 miles, 5 miles, 8 miles), autonomous vehicle may prefer to drive in the rightmost lane for the upcoming exit.

XXXI.(l) Re-Route when Unable to Change Lanes in Heavy Traffic

When driving in heavy traffic or a traffic jam, if an autonomous vehicle is approaching its exit and is unable to change lanes to the rightmost lane in time for the exit, the autonomous vehicle may re-route its trajectory such that autonomous vehicle can still arrive at the final destination.

XXXI.(m) Heavy Traffic—Relax the Gap Requirements

When changing lanes in heavy traffic or a traffic jam, an autonomous vehicle may relax the target front and target back gap requirements such that the autonomous vehicle can complete a lane change as long as the gap in the target lane is larger than the entire length of the autonomous vehicle combination, including trailer, plus an additional buffer in each of the forward and rear directions to account for sensor and localization uncertainty.

XXXI.(n) Planned Exit with Line of Traffic

If an autonomous vehicle is approaching its intended exit and there is a line of traffic that extends onto the shoulder, the autonomous vehicle may pull over to the shoulder and wait in line behind the last vehicle so as to avoid blocking the non-exit driving lanes of the highway.

The autonomous truck may be able to perform any one or more of following functions. The autonomous truck may be able to identify, classify, and properly interact with pedestrians and cyclists. The autonomous truck may be able to properly use turn signals, change lanes, and turning autonomously. The autonomous truck may be able to behave appropriately when approaching, being approached, or driving in parallel to a large vehicle. The autonomous truck may be able to bias its location within the lane properly. The autonomous vehicle may perform limited risk maneuvers on its own, perform minimal risk condition (MRC) maneuvers. The autonomous vehicle may be able to detect and respond to unknown objects by causing autonomous vehicle and other vehicles the least harm. The autonomous vehicle may maintain safe following distance from other vehicles. The autonomous vehicle may identify and autonomously respond to non-compliant drivers. The autonomous vehicle may autonomously merge into lanes of traffic. The autonomous vehicle may autonomously accept other road users' cut-in and merge-in maneuvers. The autonomous vehicle may be able to navigate straightaways at intersections, navigate up and down hills, navigate curved roads whose superelevation falls within the ODD (operational design domain), and exit highways autonomously. Further, the autonomous vehicle may autonomously detect and respond to emergency and law enforcement vehicles.

In order to perform the above features, an autonomous vehicle may utilize any of the sensors, particularly the data obtained from the sensors, in conjunction with the computing facilities on-board the autonomous vehicle, such as those associated with or in communication with the VCU. Alternatively, or additionally, the above features may be executed by an autonomous vehicle with aid from an oversight system, or control center, and optionally with aid from a human remote control operator. The oversight system, and in some cases the remote control operator, may communicate environmental data, map updates, instructions, or other information to an autonomous vehicle. An on-board map, such as a high-definition map, may be used by an autonomous vehicle to accomplish some of the features described herein, particularly when knowledge of location and local regulations (e.g., speed limits, obligations under the law, traffic conventions, intersection types) is needed to complete a task described in the feature.

While this document refers to an autonomous truck, it should be understood that any autonomous ground vehicle may have such features. Autonomous vehicles which traverse over the ground may include: semis, tractor-trailers, 18 wheelers, lorries, class 8 vehicles, passenger vehicles, transport vans, cargo vans, recreational vehicles, golf carts, transport carts, and the like.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

Implementations of the subject matter and the functional operations described in this patent document can be implemented in various systems, semiconductor devices, ultrasonic devices, digital electronic circuitry, or in computer software, firmware, or hardware, including the structures disclosed in this specification and their structural equivalents, or in combinations of one or more of them. Implementations of aspects of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of characteristics that may be specific to particular embodiments or sections of particular inventions. Certain characteristics that are described in this patent document in the context of separate embodiments or sections can also be implemented in combination in a single embodiment or a single section. Conversely, various characteristics that are described in the context of a single embodiment or single section can also be implemented in multiple embodiments or multiple sections separately or in any suitable sub combination. A feature or operation described in one embodiment or one section can be combined with another feature or another operation from another embodiment or another section in any reasonable manner. Moreover, although characteristics may be described above as acting in certain combinations and even initially claimed as such, one or more characteristics from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of operating an autonomous vehicle, comprising:
determining, by a computer located in the autonomous vehicle, that an emergency vehicle is located within a pre-determined distance of a first location of the autonomous vehicle that is operating on a lane on a road; and
operating, in response to the determining, the autonomous vehicle to steer from a center of the lane towards a first side of the lane away from the center of the lane and away from a second location of the emergency vehicle,
wherein the autonomous vehicle is caused to steer towards the first side until a lateral distance between the emergency vehicle and the autonomous vehicle is greater than or equal to the pre-determined distance.

2. The method of claim 1, wherein the autonomous vehicle is caused to steer towards the first side of the lane and onto a second lane immediately adjacent to the lane in response to determining that a line that separates the lane and the second lane includes dotted white lines, dotted yellow lines, or solid white lines.

3. The method of claim 1, further comprising:
in response to determining that the emergency vehicle is located within the pre-determined distance of the first location of the autonomous vehicle and in response to determining that a lane change operation by the autonomous vehicle is not possible:
sending instructions that causes the autonomous vehicle to apply brakes or slow down the autonomous vehicle to a speed that is less than a threshold speed value.

4. The method of claim 3, wherein the threshold speed value is based on a rule of an area or a state or a region in which the autonomous vehicle is located.

5. The method of claim 3, wherein the threshold value is based on a speed limit of the first location where the autonomous vehicle is operating and the lateral distance between the emergency vehicle and the autonomous vehicle.

6. The method of claim 1, wherein the autonomous vehicle operates to steer from the center of the lane towards the first side of the lane, and the autonomous vehicle is caused to apply brakes or slow down the autonomous vehicle to a speed that is less than a threshold speed value in response to:
determining that the emergency vehicle is operating on another lane that is immediately adjacent to the lane on which the autonomous vehicle is operating; and
determining that a lane change operation by the autonomous vehicle is not possible.

7. The method of claim 1, further comprising:
operating the autonomous vehicle to accelerate only for changing lanes or for performing an evasive maneuver in response to determining that the emergency vehicle is approaching the autonomous vehicle and that the emergency vehicle is operating on another lane that is immediately adjacent to the lane on which the autonomous vehicle is operating.

8. A system for operating an autonomous vehicle, comprising a computer that includes a processor configured to perform a method comprising:
determining, by a computer located in the autonomous vehicle, that an emergency vehicle is located within a pre-determined distance of a first location of the autonomous vehicle that is operating on a lane on a road; and
operating, in response to the determining, the autonomous vehicle to steer from a center of the lane towards a first side of the lane away from the center of the lane and away from a second location of the emergency vehicle,
wherein the autonomous vehicle is caused to steer towards the first side until a lateral distance between the emergency vehicle and the autonomous vehicle is greater than or equal to the pre-determined distance.

9. The system of claim 8, wherein the autonomous vehicle is caused to steer towards the first side of the lane and onto a second lane immediately adjacent to the lane in response to determining that a line that separates the lane and the second lane includes dotted white lines, dotted yellow lines, or solid white lines.

10. The system of claim 8, wherein the processor is configured to perform the method that further comprises:
in response to determining that the emergency vehicle is located within the pre-determined distance of the first location of the autonomous vehicle and in response to determining that a lane change operation by the autonomous vehicle is not possible:
sending instructions that causes the autonomous vehicle to apply brakes or slow down the autonomous vehicle to a speed that is less than a threshold speed value.

11. The system of claim 10, wherein the threshold speed value is based on a speed limit of the first location where the autonomous vehicle is operating and the lateral distance between the emergency vehicle and the autonomous vehicle.

12. The system of claim 8, further comprising sensor subsystems comprising cameras, a temperature sensor, an inertial sensor (IMU), a global positioning system, a light sensor, a LIDAR system, a radar system, and wireless communications, and wherein the computer located in the autonomous vehicle is configured to utilize data from any of the sensor subsystems to perform the determining and the operating.

13. The system of claim 8, further comprising a vehicle control subsystem in operable communication with the computer located in the autonomous vehicle, wherein the processor is configured to communicate with the vehicle control subsystem to perform the method that causes the autonomous vehicle to steer from the center of the lane towards the first side of the lane, and that causes the autonomous vehicle to apply brakes or slow down the autonomous vehicle to a speed that is less than a threshold speed value in response to:
determining that the emergency vehicle is operating on another lane that is immediately adjacent to the lane on which the autonomous vehicle is operating; and
determining that a lane change operation by the autonomous vehicle is not possible.

14. The system of claim 8, further comprising a vehicle control subsystem operably connected to the computer located in the autonomous vehicle, wherein the processor is configured to perform the method that further comprises:
operating the autonomous vehicle via the vehicle control system to accelerate only for changing lanes or for performing an evasive maneuver in response to determining that the emergency vehicle is approaching the autonomous vehicle and that the emergency vehicle is operating on another lane that is immediately adjacent to the lane on which the autonomous vehicle is operating.

15. A non-transitory computer readable program storage medium having code stored thereon, the code, when executed by a processor, causing the processor to perform a method, comprising:
determining, by a computer located in the autonomous vehicle, that an emergency vehicle is located within a pre-determined distance of a first location of the autonomous vehicle that is operating on a lane on a road; and
operating, in response to the determining, the autonomous vehicle to steer from a center of the lane towards a first side of the lane away from the center of the lane and away from a second location of the emergency vehicle,
wherein the autonomous vehicle is caused to steer towards the first side until a lateral distance between the emergency vehicle and the autonomous vehicle is greater than or equal to the pre-determined distance.

16. The non-transitory computer readable program storage medium of claim 15, wherein the autonomous vehicle is caused to steer towards the first side of the lane and onto a second lane immediately adjacent to the lane in response to determining that a line that separates the lane and the second lane includes dotted white lines, dotted yellow lines, or solid white lines.

17. The non-transitory computer readable program storage medium of claim 15, wherein the method further comprises:
in response to determining that the emergency vehicle is located within the pre-determined distance of the first location of the autonomous vehicle and in response to determining that a lane change operation by the autonomous vehicle is not possible:
sending instructions that causes the autonomous vehicle to apply brakes or slow down the autonomous vehicle to a speed that is less than a threshold speed value.

18. The non-transitory computer readable program storage medium of claim 17, wherein the threshold speed value is based on:
a rule of an area or a state or a region in which the autonomous vehicle is located; and
on a speed limit of the first location where the autonomous vehicle is operating and the lateral distance between the emergency vehicle and the autonomous vehicle.

19. The non-transitory computer readable program storage medium of claim 15, wherein the method further comprises:
for an emergency vehicle that is transitioning into an emergency lane vehicle, the autonomous vehicle changes lanes away from a lane adjacent to the emergency lane; and
slowing and matching, by the autonomous vehicle, the speed of an emergency vehicle that is transitioning into an emergency lane vehicle until the emergency vehicle pulls out of a current lane of travel of the autonomous vehicle.

20. The non-transitory computer readable program storage medium of claim 19, wherein the autonomous vehicle identifies an emergency vehicle as transitioning to an emergency lane vehicle using on-board sensors to detect any of:
use of a turn signal by an emergency vehicle indicating a direction toward a shoulder; a change in bias or trajectory of the emergency vehicle;
activation of flashing lights indicative of an emergency vehicle, a rescue vehicle, or a law enforcement vehicle;
a change in velocity of the emergency vehicle; and
a direct communication from the emergency vehicle to the autonomous vehicle indicating an intent of the emergency vehicle to move to the emergency lane or shoulder.
